(19) United States
(12) Patent Application Publication
(10) Pub. No.: US 2026/0089656 A1
(43) Pub. Date: Mar. 26, 2026

(54) NETWORK ENERGY SAVINGS FOR REDUCED CAPABILITY AND ENHANCED REDUCED CAPABILITY UES

(71) Applicant: QUALCOMM Incorporated, San Diego, CA (US)

(72) Inventors: Nazmul ISLAM, Littleton, MA (US); Arnab PAL, Hyderabad (IN); Hung Dinh LY, San Diego, CA (US); Ahmed Attia ABOTABL, San Diego, CA (US)

(21) Appl. No.: 18/895,103

(22) Filed: Sep. 24, 2024

(51) Int. Cl. H04W 56/00; H04W 24/10; H04W 72/231; H04W 76/19

(52) U.S. Cl. CPC H04W 56/0015; H04W 24/10; H04W 72/231; H04W 76/19

(57) ABSTRACT

Network energy savings for reduced capability and enhanced reduced capability UEs is described. An apparatus is configured to receive, from a network node, a set of NCD SSBs. The set of NCD SSBs is a subset of CD SSBs outside an active UE BWP of the. The apparatus is configured to obtain measurement information associated with the set of NCD SSBs. Another apparatus is configured to configure a UE with a NCD SSB configuration indicative of indications for a periodicity associated with first NCD SSBs in a set of NCD SSBs and for a set of periodicities associated with second NCD SSBs in an additional set of NCD SSBs. The apparatus is configured to transmit, for the UE in accordance with the NCD SSB configuration, the set of NCD SSBs that is a subset of CD SSBs that is outside an active UE BWP.

### TECHNICAL FIELD

The present disclosure relates generally to communication systems, and more particularly, to wireless communications utilizing reduced capability user equipments (UEs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE). The apparatus is configured to receive, from a network node, a set of non-cell-defining (NCD) synchronization signal blocks (SSBs), where the set of NCD SSBs is a subset of a set of cell-defining (CD) SSBs outside an active bandwidth part (BWP) of the UE. The apparatus is configured to obtain measurement information associated with the set of NCD SSBs.

In the aspect, the method includes receiving, from a network node, a set of NCD SSBs, where the set of NCD SSBs is a subset of a set of CD SSBs outside an active BWP of the UE. The method includes obtaining measurement information associated with the set of NCD SSBs.

In another aspect of the disclosure, a method, a computer-readable medium, and an apparatus are provided. The apparatus is configured to configure a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. The apparatus is configured to transmit, for the UE and in accordance with the NCD SSB configuration, the set of NCD SSBs, where the set of NCD SSBs is a subset of a set of CD SSBs that is outside an active BWP of the UE.

In the aspect, the method includes configuring a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. The method includes transmitting, for the UE and in accordance with the NCD SSB configuration, the set of NCD SSBs, where the set of NCD SSBs is a subset of a set of CD SSBs that is outside an active BWP of the UE.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a CD SSB transmissions of a base station and UE BW.

FIG. 5 is a call flow diagram for wireless communications, in accordance with various aspects of the present disclosure.

FIG. 6 is a diagram illustrating an example of NCD SSB configurations, in accordance with various aspects of the present disclosure.

FIG. 7 is a diagram illustrating an example of UE operations for NCD SSB transmissions, in accordance with various aspects of the present disclosure.

FIG. 8 is a diagram illustrating an example of UE operations for NCD SSB transmissions, in accordance with various aspects of the present disclosure.

FIG. 9 is a diagram illustrating an example of UE operations for NCD SSB transmissions, in accordance with various aspects of the present disclosure.

FIG. 10 is a diagram illustrating an example of UE operations for NCD SSB transmissions and measurement gaps for CD SSBs, in accordance with various aspects of the present disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks may be designed to support communications between network nodes (e.g., base stations, gNBs, etc.)/network entities (e.g., in a core network) and UEs. A UE may be a reduced capability UE or an enhanced reduced capability UE (reduced capability UEs, generally), and such UEs may operate according to reduced power consumption configurations and may have maximum bandwidth support that is less than other types of UEs (e.g., 20 MHz). The network may configure NCD SSBs and CD SSBs in different time domain occasions for considerations for maximum transmit power during SSB transmissions, and the network transmits CD SSBs as part of the initial BWP for a reduced capability UE. In some cases, reduced capability UEs may operate in a narrow and specific non-initial BWP as indicated by the network after connection establishment. To avoid load balancing-related issues, the network may not configure an initial BWP as the default BWP, and the default, non-initial BWP may contain NCD SSBs. Thus, NCD SSBs may be transmitted as part of an active BWP, and CD SSBs may be transmitted outside of the active BWP. As the default non-initial BWP may be the active BWP for some reduced capability UEs in a cell, if a reduced capability UE in connected mode has a NCD SSB in an active BWP, then UE may use the NCD SSB for following: radio link monitoring (RLM), beam failure detection (BFD), beam failure recovery (BFR), serving cell measurements, a quasi-co-location (QCL) source, and random access channel (RACH) occasion (RO) selection.

However, current SSB configurations for reduced capability UEs lack configurations for scenarios in which a serving SSB Tx beam of a UE will be part of a NCD SSB set being transmitted from network, and in which CD SSBs are not part of the active UE BWP. The NCD SSB of an active BWP may be used for beam management purposes, and issues may arise in the context of NES for reduced capability UEs/cell with respect to BFD/BFR and layer 3 (L3) measurement gaps. For instance, in the context of a reduced capability primary cell (PCell) network, the network may consume unnecessary power to transmit NCD SSBs in the same set of directions as CD SSBs. This additional power consumption may become significant when NCD SSB is based on time division multiplexing (TDM) in association with CD SSBs, and NCD SSB periodicity may also be an issue for maintaining RLM/BFD/layer 1 (L1) reference signal received power (RSRP) (L1-RSRP) quality. Current solutions include transmission of NCD SSB in unnecessary/unutilized directions (e.g., where no UE of an active BWP is located) and may prohibit the network from entering a deeper sleep mode. Thus, network energy savings (NES) is impacted in reduced capability networks. For instance, activation of a sleep mode for the network may depend on the allowed time to sleep because deeper sleep mode has a longer transition time, when the network monitors RACH occasions several subframes after a NCD SSB burst set, the transmission of unnecessary/unutilized NCD SSBs at the end of a NCD SSB burst set may force the network to go to micro sleep, instead of light sleep, in the region between the NCD SSB transmission and RACH occasion reception, which impacts NES.

Various aspects relate generally to wireless communications utilizing reduced capability UEs. Some aspects more specifically relate to network energy savings (NES) for reduced capability and enhanced reduced capability UEs. In some examples, a reduced capability UE may receive NCD SSBs having different indices at different periodicities. In some examples, a reduced capability UE may utilize BFD/BFR for NES in reduced capability cells to indicate SSB beams having improved/sufficient signal quality. In some aspects, a reduced capability UE may be configured by a network for L1 measurements outside of an active BW using a measurement gap. A reduced capability UE may receive, from a network node, a set of NCD SSBs, where the set of NCD SSBs is a subset of a set of CD SSBs outside an active BWP of the UE, and obtain measurement information associated with the set of NCD SSBs. A network node may configure a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs, and transmit, for the UE and in accordance with the NCD SSB configuration, the set of NCD SSBs, where the set of NCD SSBs is a subset of a set of CD SSBs that is outside an active BWP of the UE. That is, communications of serving SSBs from a network node to active, reduced capability UEs are provided in a non-initial BWP (e.g., an active BWP) for NES.

Particular aspects of the subject matter described in this disclosure can be implemented to realize one or more of the following potential advantages. In some examples, by utilizing different periodicities for different sets of SSBs or not transmitting certain sets of SSBs to a reduced capability UE, the described techniques can be used to increase NES. In some examples, by utilizing BFD/BFR at a reduced capability UE in association with signal quality of SSBs with less frequent periodicity, the described techniques can be used to switch a serving SSB to another SSB beam while maintaining NES. In some examples, by configuring a measurement gap in a non-initial BWP for serving SSBs at a reduced capability UE, the described techniques can be used to measure and obtain the quality of SSBs in terms of RSRP from CD SSBs.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

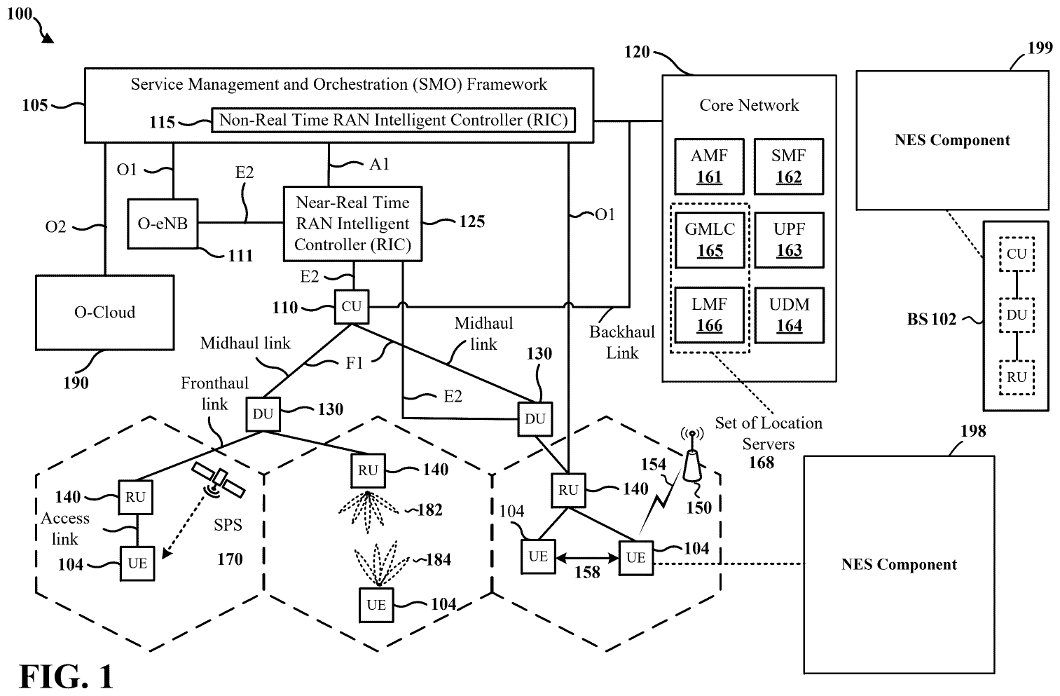

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a NES component 198 (“component 198”) that may be configured to receive, from a network node, a set of NCD SSBs, where the set of NCD SSBs is a subset of a set of CD SSBs outside an active BWP of the UE. The component 198 may be configured to obtain measurement information associated with the set of NCD SSBs. The component 198 may be configured to determine, based on the measurement information, that each NCD SSB of the set of NCD SSBs is associated with a signal quality that fails to meet a signal quality threshold. The component 198 may be configured to obtain additional measurement information associated with an NCD SSB of the additional set of NCD SSBs. The component 198 may be configured to receive, from the network node and subsequent to (i) a determination that the NCD SSB of the additional set of NCD SSBs meets the signal quality threshold and (ii) a beam failure recovery, the NCD SSB of the additional set of NCD SSBs as a serving SSB. The component 198 may be configured to determine, based on the measurement information, that a first NCD SSB of the set of NCD SSBs, as a serving SSB of the UE, is associated with a signal quality that fails to meet a signal quality threshold and that a second NCD SSB of the set of NCD SSBs meets the signal quality threshold. The component 198 may be configured to receive, from the network node and subsequent to a beam failure recovery, the second NCD SSB as the serving SSB. The component 198 may be configured to switch to an initial BWP of the UE based on a determination associated with the measurement information that at least one NCD SSB in the set of NCD SSBs is associated with a respective signal quality that fails to meet a signal quality threshold. The component 198 may be configured to obtain additional measurement information associated with a CD SSB of the set of CD SSBs. The component 198 may be configured to transmit a beam failure recovery signal to the network based on the additional measurement information associated with CD-SSB. The component 198 may be configured to receive, from the network node and subsequent to a beam failure recovery, the CD SSB as a serving SSB and as part of the set of NCD SSBs based on an associated signal quality meeting the signal quality threshold. The component 198 may be configured to receive, from the network node, an NCD SSB configuration indicative of at least one of (i) a first indication of a periodicity associated with first NCD SSBs in the set of NCD SSBs or (ii) a second indication of a set of periodicities associated with second NCD SSBs in an additional set of NCD SSBs. The component 198 may be configured to transmit, for at least one network node, the measurement information associated with the set of NCD SSBs. In certain aspects, the base station 102 may have a NES component 199 (“component 199”) that may be configured to configure a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. The component 199 may be configured to transmit, for the UE and in accordance with the NCD SSB configuration, the set of NCD SSBs, where the set of NCD SSBs is a subset of a set of CD SSBs that is outside an active BWP of the UE. The component 199 may be configured, where the NCD SSB configuration is associated with measurement information for the set of NCD SSBs, to receive, from the UE, the measurement information for the set of NCD SSBs in accordance with the NCD SSB configuration, where the measurement information for the set of NCD SSBs is indicative of (i) first measurement information for a determination that each NCD SSB of the set of NCD SSBs is associated with a signal quality that fails to meet a signal quality threshold and (ii) additional measurement information associated with an NCD SSB of the additional set of NCD SSBs. The component 199 may be configured, where the NCD SSB configuration is associated with measurement information for the set of NCD SSBs, to transmit, for the UE and subsequent to a beam failure recovery associated with the UE, the NCD SSB of the additional set of NCD SSBs as a serving SSB. The component 199 may be configured to receive, from the UE, measurement information for the set of NCD SSBs in accordance with the NCD SSB configuration, where the measurement information for the set of NCD SSBs is indicative of (i) a switch to an initial BWP of the UE based on a determination associated with the measurement information that at least one NCD SSB in the set of NCD SSBs is associated with a respective signal quality that fails to meet a signal quality threshold and (ii) additional measurement information associated with a CD SSB of the set of CD SSBs. The component 199 may be configured to transmit, for the UE and subsequent to a beam failure recovery associated with the UE, the CD SSB as a serving SSB and as part of the set of NCD SSBs based on an associated signal quality meeting the signal quality threshold. The component 199 may be configured to receive, from the UE, measurement information for a first NCD SSB of the set of NCD SSBs, where the measurement information is indicative of a determination that the first NCD SSB of the set of NCD SSBs, as a serving SSB of the UE, is associated with a signal quality that fails to meet a signal quality threshold and that a second NCD SSB of the set of NCD SSBs meets the signal quality threshold. The component 199 may be configured to transmit, for the UE and subsequent to a beam failure recovery, the second NCD SSB as the serving SSB, where the set of NCD SSBs includes the second NCD SSB. The component 199 may be configured to receive, from the UE, measurement information associated with the set of NCD SSBs. According to aspects, a reduced capability UE may receive NCD SSBs having different indices at different periodicities, may utilize BFD/BFR for NES in reduced capability cells to indicate SSB beams having improved/sufficient signal quality, and may be configured by a network for L1 measurements outside of an active BW using a measurement gap. Aspects provide for a UE to increase NES by utilizing different periodicities for different sets of SSBs or not transmitting certain sets of SSBs to a reduced capability UE, enable switching of a serving SSB to another SSB beam while maintaining NES by utilizing BFD/BFR at a reduced capability UE in association with signal quality of SSBs with less frequent periodicity, and enable measurement and obtainment of the quality of SSBs in terms of RSRP, by way of example, from CD SSBs by configuring a measurement gap in a non-initial BWP for serving SSBs at a reduced capability UE.

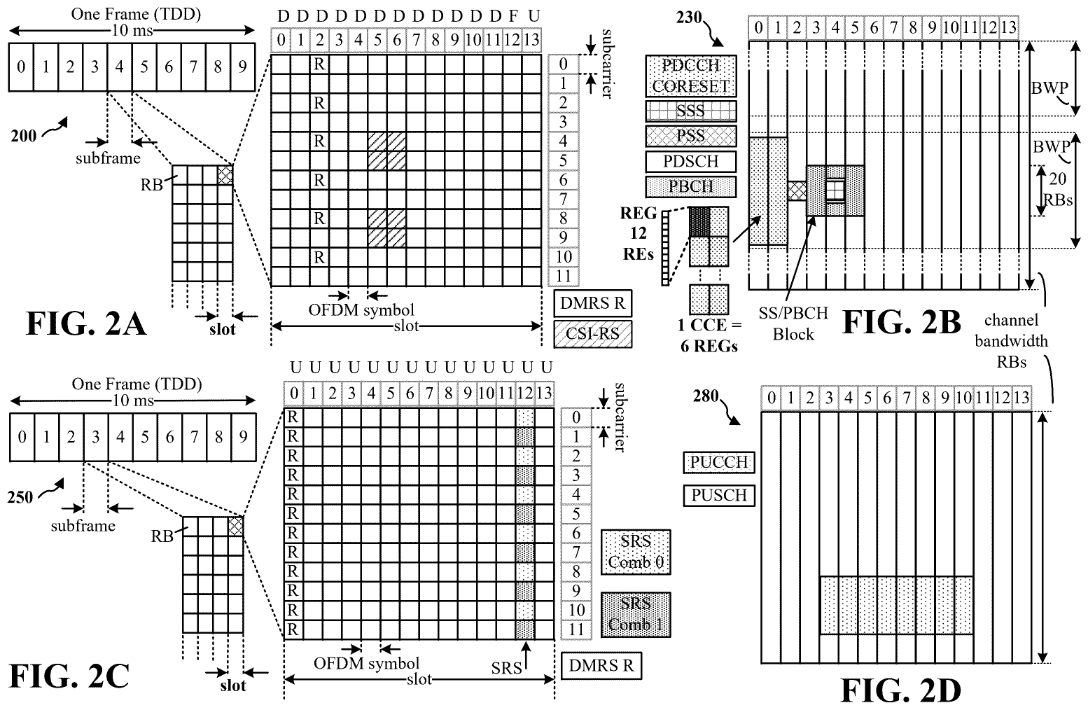

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

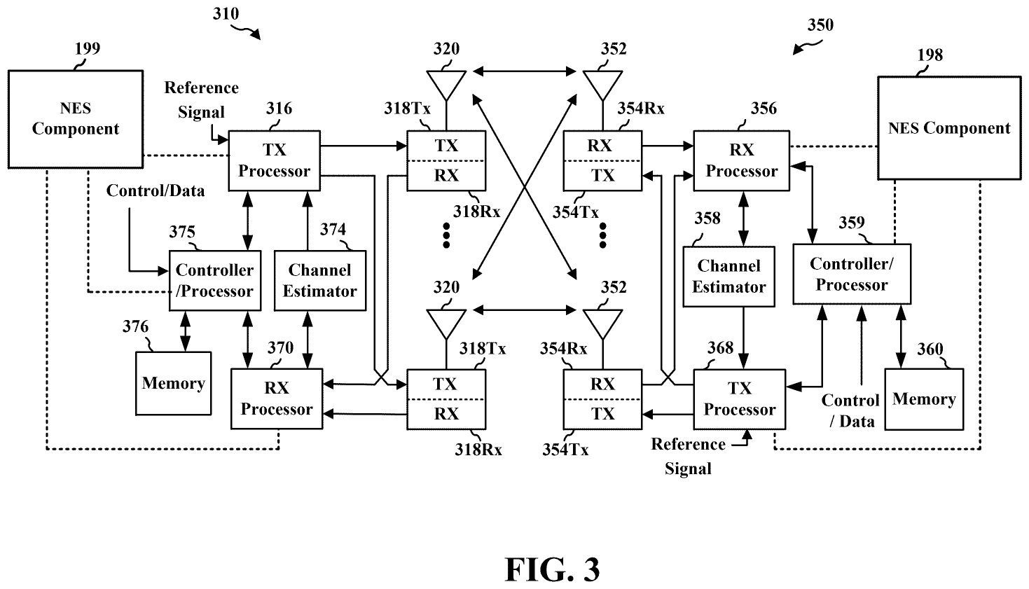

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

A UE may be a reduced capability UE or an enhanced reduced capability UE (reduced capability UEs, generally), and such UEs may operate according to reduced power consumption configurations and may have maximum bandwidth support that is less than other types of UEs (e.g., 20 MHz). the network may configure NCD SSBs and CD SSBs) in different time domain occasions for considerations for maximum transmit power during SSB transmissions, and the network transmits CD SSBs as part of the initial BWP for a reduced capability UE. In some cases, reduced capability UEs may operate in a narrow and specific non-initial BWP as indicated by the network after connection establishment. To avoid load balancing-related issues, the network may not configure an initial BWP as the default BWP, and the default, non-initial BWP may contain NCD SSBs. Thus, NCD SSBs may be transmitted as part of an active BWP, and CD SSBs may be transmitted outside of the active BWP. As the default non-initial BWP may be the active BWP for some reduced capability UEs in a cell, if a reduced capability UE in connected mode has a NCD SSB in an active BWP, then UE may use the NCD SSB for following: RLM, BFD, BFR, serving cell measurements, a QCL source, and RO selection.

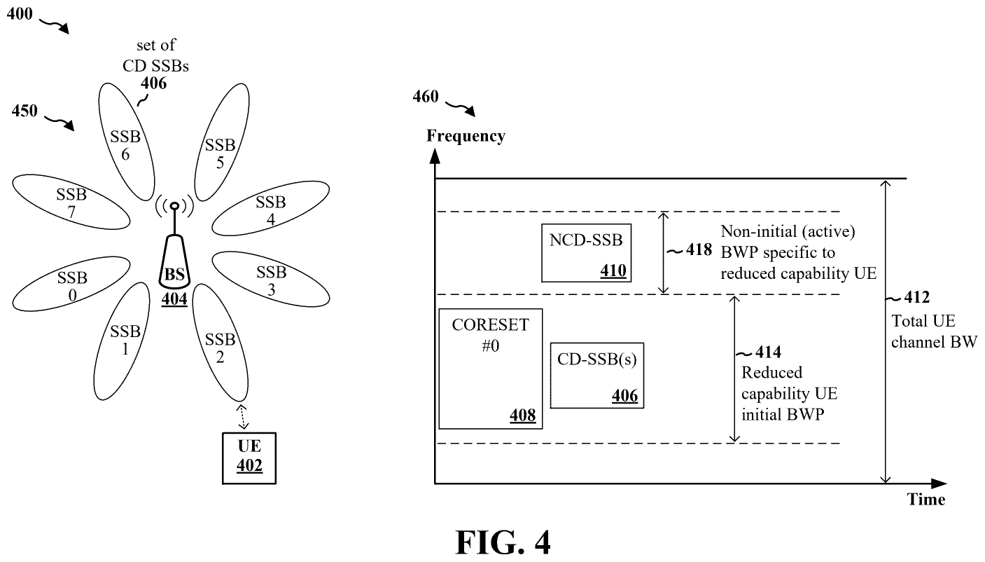

FIG. 4 is a diagram 400 illustrating an example of a CD SSB transmissions of a base station and UE BW. Diagram 400 is shown in the context of a UE 402 and a network node (e.g., a base station 404, a gNB, a portion thereof, and/or the like). A configuration 450 includes transmission of SSBs by the base station 404 in the coverage area of the UE 402, and a configuration 460 includes a diagram of frequency versus time for BW of the UE 402.

In the configuration 450, the base station 404 is configured to transmit a set of CD SSBs 406 (e.g., eight SSBs with respective indices 0-7, as shown). In some cases, the SSB 2 of the set of CD SSBs 406 may be the serving SSB of the UE 402. However, each SSB of the set of CD SSBs 406 may be transmitted by the base station 404; that is, while SSB 2 may be serving the UE 402, SSB 0, SSB 1, SSB 3, SSB 4, SSB 5, SSB 6, and SSB 7 may be transmitted without serving, which impacts NES.

As shown in the configuration 460, the UE 402 may include a total UE channel BW 412 (e.g., 20 MHz for a reduced capability UE). A set of CD SSBs 406 may be transmitted in an initial BWP 414 of the UE 402 along with a CORESET 408. A NCD SSB 410 (or set thereof) may be transmitted as part of active BWP (e.g., a non-initial BWP 418) for load balancing considerations as noted above, while the set of CD SSBs 406 may be transmitted outside of the active BWP (e.g., outside of the non-initial BWP 418).

However, current SSB configurations for reduced capability UEs lack configurations for scenarios in which a serving SSB Tx beam of a UE will be part of a NCD SSB set being transmitted from network, and in which CD SSBs are not part of the active UE BWP. The NCD SSB of an active BWP may be used for beam management purposes, and issues may arise in the context of NES for reduced capability UEs/cell with respect to BFD/BFR and L3 measurement gaps. A reduced capability UE may be configured to measure CD SSBs as part of network-configured gap to obtain L3 cell level measurement, and in existing solutions for reduced capability UEs, the number/set of actually transmitted of NCD SSBs is same as the set of transmitted CD SSBs.

Additionally, existing frameworks lack NES-related solutions for reduced capability UEs. When a current network supports reduced capability UEs as well as NES, the NES is impacted by having all NCD SSBs being transmitted frequently. Further, a serving SSB of a reduced capability UE, if transmitted as part of a set of NCD SSB in an active BWP, is used for serving cell measurement/beam management purposes, but not for other purposes. In such scenarios, the serving SSB of a UE may refer to the SSB that is quasi-co-located with the reference signals that act as active TCI states for the UE. The network may still configure the UE to monitor CD SSBs which are outside the active BWP for radio resource management (RRM) measurements/L3 cell level measurements. Yet, as noted herein, the network transmits unutilized SSBs in the active BWP for current solutions, as well as transmitting all CD SSBs in the initial BWP of the UE.

In the context of a reduced capability PCell network, the network may consume unnecessary power to transmit NCD SSBs in the same set of directions as CD SSBs. This additional power consumption may become significant when NCD SSB is based on TDM in association with CD SSBs, and NCD SSB periodicity may also be an issue for maintaining RLM/BFD/L1-RSRP quality. Current solutions include transmission of NCD SSB in unnecessary/unutilized directions (e.g., where no UE of an active BWP is located) and may prohibit the network from entering a deeper sleep mode. Thus, NES is impacted in reduced capability networks. For instance, activation of a sleep mode for the network may depend on the allowed time to sleep because deeper sleep mode has a longer transition time, when the network monitors RACH occasions several subframes after a NCD SSB burst set, the transmission of unnecessary/unutilized NCD SSBs at the end of a NCD SSB burst set may force the network to go to micro sleep, instead of light sleep, in the region between the NCD SSB transmission and RACH occasion reception, which impacts NES.

Aspects herein provide for transmission of different indices of NCD SSBs with different periodicity, for BFD/BFR for NES in reduced capability UEs, and for L1-measurements via network configured gaps, in the context of reduced capability UE procedures and configurations received from the network. Aspects herein for NES for reduced capability and enhanced reduced capability UEs improve NES operations at such UEs and serving networks. Aspects UE increase NES by utilizing different periodicities for different sets of SSBs or not transmitting certain sets of SSBs to a reduced capability UE. Aspects enable switching of a serving SSB to another SSB beam while maintaining NES by utilizing BFD/BFR at a reduced capability UE in association with signal quality (e.g., RSRP, reference signal received quality (RSRQ), signal-to-noise ratio (SNR), signal to interference plus noise ratio (SINR), etc.) of SSBs with less frequent periodicity. Aspects enable measurement and obtainment of the quality of SSBs in terms of RSRP, RSRQ, SNR, SINR, etc., from CD SSBs by configuring a measurement gap in a non-initial BWP for serving SSBs at a reduced capability UE.

Aspects herein allow NES in a reduced capability PCell by optimizing the transmit occasions of NCD SSBs for reduced capability UEs. For instance, if a network may be configured to selectively send a minimum number of NCD SSBs without unneeded NCD SSBs, then the network will save energy. This may be significant in a FDD reduced capability network scenario where CD SSBs and NCD SSBs may not be transmitted simultaneously to ensure maximum power during SSB transmission. In aspects, to save network energy, a network node (e.g., a base station, gNB, etc.) may transmit those NCD SSBs which are serving SSBs of reduced capability UEs in the active BWP (e.g., using a non-CellDefiningSSB information element (IE)), but may not transmit any unnecessary SSBs as part of a set of NCD SSBs. Additionally, NES for reduced capability cells may include BFD/BFR for determinations of SSBs that lack and/or have sufficient signal quality, as well as L3 measurement gaps. Aspects may also enable an NCD SSB periodicity to be smaller than, or relatively small compared to, CD SSB periods and/or non-serving NCD SSB periods in order to maintain RLM/BFD/L1-RSRP quality.

As described herein, aspects may refer to a reduced capability UE or an enhanced reduced capability UE as a UE, generally. Aspects described in the context of a reduced capability UE, an enhanced reduced capability UE, or a UE, generally, are applicable to others of these UE types. Additionally, the term reduced capability may be used synonymously with the term reduced capacity. Aspects herein may be applicable to 5G NR, 6G, and/or the like, such as for TDM between NCD SSBs and CD SSBs.

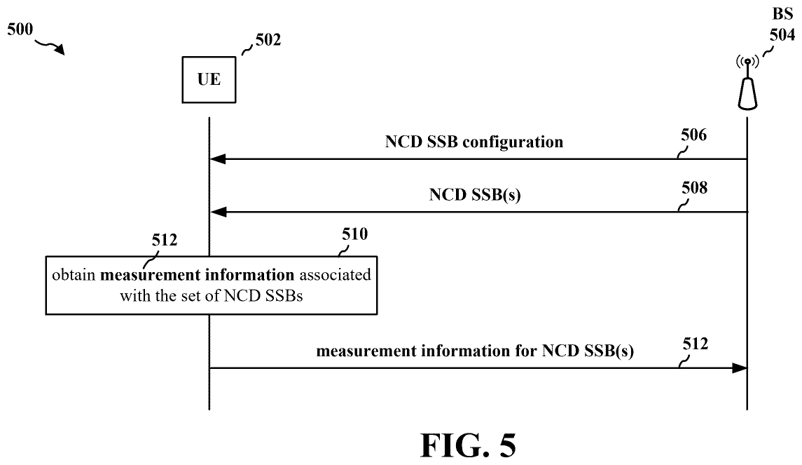

FIG. 5 is a call flow diagram 500 for wireless communications, in various aspects. Call flow diagram 500 illustrates NES for reduced capability and enhanced reduced capability UEs for a UE (e.g., a UE 502 as a reduced capability UE or an enhanced reduced capability UE), by way of example, that communicates with a network node (e.g., a base station 504, a gNB, etc., as shown and described herein), by way of example. While call flow diagram 500 is illustrated and described with respect to a base station, aspects include that the base station 504 may be two or more base stations. Aspects described for base stations, and for network nodes/entities herein, generally, may be performed in aggregated form and/or by one or more components in disaggregated form, and a network node herein may be configured as a reduced capability PCell. Additionally, or alternatively, the aspects may be performed by a UE autonomously, in addition to, and/or in lieu of, operations of a network node/base station.

In the illustrated aspect, the UE 502 may be configured to receive, and the base station 504 may be configured to transmit/provide/configure, an NCD SSB configuration 506. In aspects, the NCD SSB configuration 506 may be indicative of at least one of (i) a first indication of a periodicity associated with first NCD SSBs (e.g., one or more) in a set of NCD SSBs 508 or (ii) a second indication of a set of periodicities associated with second NCD SSBs (e.g., one or more) in an additional set of NCD SSBs.

In aspects, the UE 502 may be configured to receive, and the base station 504 may be configured to transmit/provide, the set of NCD SSBs 508. In aspects, the set of NCD SSBs 508 may be a subset of a set of CD SSBs outside an active BWP of the UE 502 (e.g., as shown for the set of CD SSBs 406 in FIG. 4). As described herein, a set of CD SSBs may be actually transmitted by a network node (e.g., the base station 504) and may be received by a UE (e.g., the UE 502). To transmit the set of NCD SSBs, the UE 502 may be configured to receive, and the base station 504 may be configured to transmit/provide, the set of CD SSBs outside the active BWP of the UE 502. In aspects, to receive the set of NCD SSBs 508, the UE 502 may be configured to receive, and the base station 504 may be configured to transmit/provide, an additional set of NCD SSBs in accordance with an additional periodicity that is longer than a periodicity of the set of NCD SSBs 508. The additional set of NCD SSBs may be exclusive of the set of NCD SSBs 508, as described herein. In some aspects, a number of first NCD SSBs in the set of NCD SSBs 508 may be less than an additional number of second NCD SSBs in the additional set of NCD SSBs. In some aspects, the number of first NCD SSBs in the set of NCD SSBs 508 and the additional number of second NCD SSBs in the additional set of NCD SSBs may equal a total number of CD SSBs in the set CD SSBs.

In aspects, the UE 502 may be configured to obtain (at 510) measurement information 512 associated with the set of NCD SSBs 508. In aspects, the UE 502 may be configured to measure signal quality indicators (e.g., RSRP, RSRQ, SNR, SINR, and/or another reference signal characteristic, RRM measurements, L3 cell level measurements, or other measurements described herein) of one or more SSBs of the set of NCD SSBs 508 to obtain (at 510) measurement information 512. The UE 502 may be configured to determine, e.g., based on the measurement information 512 obtained (at 510), that each NCD SSB of the set of NCD SSBs 508 may be associated with a signal quality that meets (or not) a signal quality threshold (e.g., below 10% block error rate (BLER), or the like).

In some aspects, the UE 502 may be configured to determine, e.g., based on the measurement information 512 obtained (at 510), that each NCD SSB of the set of NCD SSBs 508 may be associated with a signal quality that fails to meet a signal quality threshold (e.g., below 10% BLER of a hypothetical PDCCH, or the like). The UE 502 may be configured to obtain additional measurement information associated with an NCD SSB of the additional set of NCD SSBs, e.g., based on the determined signal quality threshold failure. The UE 502 may be configured to determine that the NCD SSB of the additional set of NCD SSBs meets the signal quality threshold, and to subsequently initiate a BFD for the NCD SSB(s) that fail to meet the signal quality threshold and a BFR for the NCD SSB of the additional set of NCD SSBs. The UE 502 may be configured to transmit/provide, and the base station 504 may be configured to receive, the measurement information 512 for the set of NCD SSBs 508 in accordance with the NCD SSB configuration 506. The measurement information 512 for the set of NCD SSBs 508 may be indicative of (i) first measurement information for a determination that each NCD SSB of the set of NCD SSBs 508 is associated with a signal quality that fails to meet a signal quality threshold and (ii) additional measurement information associated with an NCD SSB of the additional set of NCD SSBs. The UE 502 may be configured to transmit/provide, and the base station 504 may be configured to receive, a beam failure recovery signal to the network based on the additional measurement information associated with a CD SSB. The UE 502 may be configured to receive, and the base station 504 may be configured to transmit/provide, subsequent to a beam failure recovery, the CD SSB as a serving SSB and as part of the set of NCD SSBs based on an associated signal quality meeting the signal quality threshold. Thus, the UE 502 may be configured to receive, and the base station 504 may be configured to transmit/provide, subsequent to (i) a determination that the NCD SSB of the additional set of NCD SSBs meets the signal quality threshold and (ii) a BFR, the NCD SSB of the additional set of NCD SSBs as a serving SSB, e.g., now as part of the set of NCD SSBs 508 after being adjusted therefor.

In some aspects, the UE 502 may be configured to switch to an initial BWP (e.g., non-default/non-active BWP for the CD SSBs) of the UE 502 based on a determination associated with the measurement information 512 that at least one NCD SSB in the set of NCD SSBs 508 is associated with a respective signal quality that fails to meet the signal quality threshold. For instance, the UE 502 may be configured to determine, based on the measurement information 512, that an NCD SSB(s) of the set of NCD SSBs 508 fails to meet the signal quality threshold. Accordingly, the UE 502 may be configured to switch to the initial BWP. The UE 502 may be configured to obtain additional measurement information associated with a CD SSB of the set of CD SSBs, e.g., based on the switch to the initial BWP associated with the set of CD SSBs. A transmission of a given CD SSB and/or of the set of CD SSBs may occur outside the active BWP of the UE 502. The UE 502 may be configured to subsequently initiate a BFD for the NCD SSB(s) that fail to meet the signal quality threshold and a BFR for the CD SSB of the set of CD SSBs based on an associated signal quality meeting the signal quality threshold. The UE 502 may be configured to transmit/provide, and the base station 504 may be configured to receive, measurement information 512 for the set of NCD SSBs 508 in accordance with the NCD SSB configuration 506. The measurement information 512 for the set of NCD SSBs 508 may be indicative of (i) a switch to an initial BWP of the UE 502 based on a determination associated with the measurement information 512 that at least one NCD SSB in the set of NCD SSBs 508 is associated with a respective signal quality that fails to meet a signal quality threshold and (ii) additional measurement information associated with a CD SSB of the set of CD SSBs. In aspects, a first time taken for the beam failure recovery may be associated with a second time taken for the switch to the initial BWP. In some scenarios, the BFR timeline (e.g., the first time taken for the BFR) may be impacted by the switch to the initial BWP. Thus, the UE 502 may be configured to receive, and the base station 504 may be configured to transmit/provide, subsequent to a BFR, the CD SSB as a serving SSB and as part of the set of NCD SSBs 508 after being adjusted therefor.

In some aspects, the UE 502 may be configured to determine, based on the measurement information 512, that a first NCD SSB of the set of NCD SSBs 508, as a serving SSB of the UE 502, is associated with a signal quality that fails to meet the signal quality threshold (e.g., below 10% BLER, or the like) and that a second NCD SSB of the set of NCD SSBs 508 meets the signal quality threshold. In aspects, such a determination may be performed in association with the non-initial/active BWP of the UE 502. The UE 502 may be configured to transmit/provide, and the base station 504 may be configured to receive, measurement information 512 for a first NCD SSB of the set of NCD SSBs 508. The measurement information 512 for the set of NCD SSBs 508 may be indicative of a determination that the first NCD SSB of the set of NCD SSBs 508, as a serving SSB of the UE 502, is associated with a signal quality that fails to meet a signal quality threshold and that a second NCD SSB of the set of NCD SSBs 508 meets the signal quality threshold. The UE 502 may be configured to subsequently initiate a BFR for the second NCD SSB of the set of NCD SSBs 508, and thus be configured to receive, and the base station 504 may be configured to transmit/provide, subsequent to the BFR, the second NCD SSB of the set of NCD SSBs 508 as the serving SSB. In such aspects, the set of NCD SSBs may include the second NCD SSB. In some aspects, the set of NCD SSBs may comprise an NCD SSB burst set in which given NCD SSBs are ordered/positioned. The NCD SSB configuration 506 may include at least one burst position IE indicative of the first NCD SSBs in the set of NCD SSBs 508 for such an NCD SSB burst set. In some aspects, the at least one burst position IE may include a burst position IE for each of the first NCD SSBs in the set of NCD SSBs 508 and/or for each of the second NCD SSBs in the set of NCD SSBs 508. In such aspects, to receive the NCD SSB configuration 506, the UE 502 may be configured to receive the NCD SSB configuration 506 via RRC signaling.

In some aspects, to receive the NCD SSB configuration 506, the UE 502 may be configured to receive, and the base station 504 may be configured to transmit/provide/configure, an adjustment associated with the NCD SSB configuration 506. The adjustment may comprise/include at least one of a MAC-CE or DCI. The adjustment via MAC-CE/DCI may include a set of bits indicative of at least one of (i) an additional NCD SSB for addition to the set of NCD SSBs 508 or (ii) a current NCD SSB for removal from the set of NCD SSBs 508. As one example, and as noted above, the UE 502 may be configured to initiate BFDs for NCD SSBs that fail to meet a signal quality threshold, and such NCD SSBs may be removed from the set of NCD SSBs 508 via the adjustment associated with the NCD SSB configuration 506. Likewise, the UE 502 may be configured to initiate BFRs for NCD SSBs and/or CD SSBs that meet a signal quality threshold, and such NCD SSBs/CD SSBs may be added to the set of NCD SSBs 508 via the adjustment associated with the NCD SSB configuration 506. For instance, to receive the adjustment associated with the NCD SSB configuration 506, the UE 502 may be configured to transmit/provide, and the base station 504 may be configured to receive, an indication of SSBs in at least one of the set of NCD SSBs 508 or the set of CD SSBs that meets the signal quality threshold. In such aspects, the adjustment may thus be based on the indication.

In some aspects, the NCD SSB configuration 506 may include a third indication of an L1 measurement gap associated with SSB measurements of the set of NCD SSBs 508. In such aspects, to receive the NCD SSB configuration 506, the UE 502 may be configured to receive, and the base station 504 may be configured to transmit/provide/configure in accordance with the set of NCD SSBs 508 having fewer SSBs than the set of CD SSBs, a dynamic activation for the L1 measurement gap. The dynamic activation for the L1 measurement gap may comprise include at least one of a MAC-CE or DCI that includes a fourth indication of a gap periodicity associated with an obtainment of additional measurement information associated with the set of CD SSBs. In aspects, the gap periodicity may be longer than the periodicity of the set of NCD SSBs (e.g., the NCD SSB periodicity to be smaller than, or relatively small compared to, CD SSB periods and/or non-serving NCD SSB periods for measurement gaps, such for maintenance of RLM/BFD/L1-RSRP quality. The UE 502, to obtain (at 510) the measurement information 512 associated with the set of NCD SSBs, may be configured to obtain (e.g., at 510) the additional measurement information associated with the set of CD SSBs during the L1 measurement gap in accordance with the gap periodicity. In aspects, to receive the NCD SSB configuration 506, the UE 502 may be configured to receive, and the base station 504 may be configured to transmit/provide/configure subsequent to the dynamic activation for the L1 measurement gap, a dynamic deactivation for the L1 measurement gap in accordance with the set of NCD SSBs 508 having a same number of SSBs as the set of CD SSBs (e.g., or more SSBs). The dynamic deactivation for the L1 measurement gap may comprise/include at least one of the MAC-CE or the DCI, in aspects. In some aspects, the UE 502 may be configured to autonomously and dynamically deactivate the L1 measurement gap via a dynamic deactivation in accordance with the set of NCD SSBs having a same number (or greater number) of SSBs as the set of CD SSBs.

The UE 502 may be configured to transmit/provide, and at least one network node (e.g., the base station 504) may be configured to receive, the measurement information 512 associated with the set of NCD SSBs 508. In some aspects, the base station 504 may be configured to utilize the measurement information 512 associated with the set of NCD SSBs 508 to adjust the set of NCD SSBs 508 and/or to perform other UE/cell management functions, as described herein.

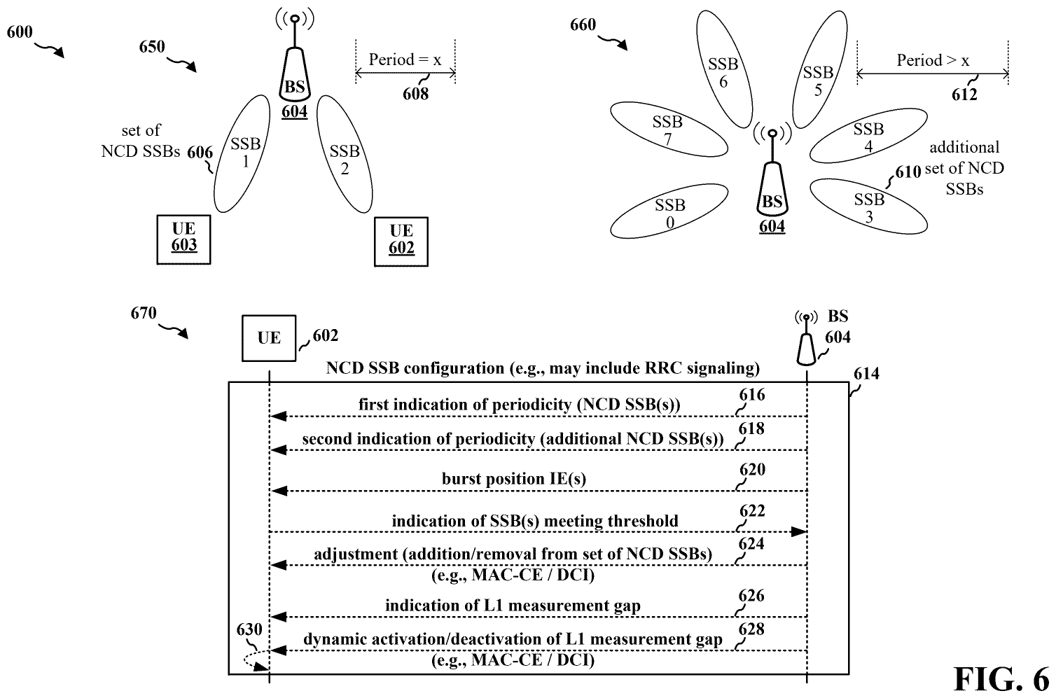

FIG. 6 is a diagram 600 illustrating an example of NCD SSB configurations, in various aspects. Diagram 600 may be an aspect of call flow diagram 500 in FIG. 5. Diagram 600 shows a UE 602, a UE 603, and a network node (e.g., a base station 604) for a configuration 650, a configuration 660, and a configuration 670 in the context of transmissions for different indices of NCD SSBs with different periodicities for NES for reduced capability and enhanced reduced capability UEs. The UE 602 and/or the UE 603 may be reduced capability UEs or enhanced reduced capability UEs.

In prior solutions, the network transmits serving SSB of all UEs that are currently active in a reduced capability, non-initial BWP as part of the reduced capability non-initial BWP (e.g., as shown for the set of CD SSBs 406 in FIG. 4). Aspects herein, however, for NES for reduced capability specific, non-initial BWP, enable the network, e.g., the base station 604, to transmit those NCD SSBs (e.g., a minimum/minimal number) which are to be utilized (e.g., those NCD SSBs which are already serving SSB of all UEs), while allowing the network to not transmit other non-serving SSBs, as shown for the configuration 650. If the base station 604 is already transmitting an actually utilized set of CD SSBs (of which the UE 602 may be informed via a ssb-Position-In-Burst IE, the base station 604 may be configured to transmit/provide a subset of NCD SSBs which are to be utilized, e.g., as a set of NCD SSBs 606, shown by way of example as two NCD SSBs: SSB 1 utilized as a serving SSB by the UE 603, and SSB 2 utilized as a serving SSB by the UE 602. The set of NCD SSBs 606 may be a subset of the actually transmitted set of CD SSBs. That is, the set of NCD SSBs has smaller number of NCD SSBs as such a subset so that the base station 604 may save as much as power as possible under NES. The set of NCD SSBs 606 may be transmitted/provided to the UE 602/the UE 603 according to a periodicity 608 (x).

The configuration 660 shows an additional set of NCD SSBs 610 (e.g., SSB 0, SSB 3, SSB 4, SSB 5, SSB 6, and SSB 7, which are not currently utilized as serving SSBs (e.g., are non-serving SSBs). The additional set of NCD SSBs 610 may be either not transmitted by the base station 604 in a first scenario, or may be transmitted for by the base station 604 with a higher periodicity 612 (>x) (e.g., much less frequently than x) in a second scenario. According to aspects, the base station 604 may be already transmitting actual CD SSBs as part of the initial BWP (e.g., as shown for the set of CD SSBs 406 in FIG. 4), and mathematically, the relation between the set of NCD SSBs 606 (e.g., a smaller number of utilized serving NCD SSBs which are actually being transmitted at the periodicity 608) and the additional set of NCD SSBs 610, which may be either not transmitted or transmitted with a higher periodicity (e.g., the periodicity 612; e.g., much less frequently) with the set of CD SSBs (e.g., the actual set of CD SSB being transmitted as part of initial BWP) may be X \union X′=Y, where X is the set of NCD SSBs 606, X′ is the additional set of NCD SSBs 610, and Y is the set of CD SSBs.

In the configuration 670, the UE 602 may be configured to receive, and the base station 604 may be configured to transmit/provide/configure, an NCD SSB configuration 614. In the first scenario noted above, the UE 602 may be configured to receive, and the base station 604 may be configured to transmit/provide/configure, a first indication of a periodicity 616 of NCD SSBs in the set of NCD SSBs 606. That is, the base station 604 may provide the set of NCD SSBs 606 but not the additional set of NCD SSBs 610 or the periodicity 612. In the second scenario, the UE 602 may be configured to also receive, and the base station 604 may be configured to also transmit/provide/configure, a second indication of a periodicity 618 of NCD SSBs in the additional set of NCD SSBs 610. That is, the base station 604 may provide the set of NCD SSBs 606 and the periodicity 608 and the additional set of NCD SSBs 610 and the periodicity 612. In aspects, the base station 604 may provide periodicity separately for each NCD SSB in the union of the set of NCD SSBs 606 and the additional set of NCD SSBs 610 to UE 602. In some aspects, the NCD SSBs of the additional set of NCD SSBs 610 may be transmitted by the base station 604 with different periodicities based on their past history of being serving SSBs of the UE 602 in its active BWP.

To transmit/provide/configure the set of NCD SSBs 606 to a reduced capability UE (e.g., the UE 602) from the base station 604, separate ssb-PositionInBurst IE for NCD SSBs may be utilized (e.g., a burst position IE(s) 620). The base station 604, according to aspects, may also be enabled to configure multiple sets of ssb-PositionInBurst IEs for NCD SSBs via RRC signaling (e.g., more than one instance/set of the burst position IE(s) 620). The base station 604 may also be configured to dynamically inform the UE 602 regarding one of such multiple sets of the burst position IE(s) 620, e.g., for the current elements/SSBs of the set of NCD SSBs 606, using a bit/bits via DCI/MAC-CE. Accordingly, the base station 604 is enabled to inform the UE 602 regarding updated elements of set of NCD SSBs 606 dynamically with reduced overhead.

As an illustrative example, the base station 604 may support FR1 (e.g., “SUB6”) with a SCS of 30 KHz, and the base station 604 may be actually transmitting all eight CD SSBs (e.g., as shown for the set of CD SSBs 406 in FIG. 4) as part of the initial BWP of the UE 602. That is, the set of CD SSBs may be: {SSB 0, SSB 1, SSB 2, SSB 3, SSB 4, SSB 5, SSB 6, SSB 7}. In the context of aspects herein for NES for reduced capability and enhanced reduced capability UEs, and to save network energy as part of NES, the base station 604 may be configured to transmit two, rather than eight, NCD SSBs of the set of NCD SSBs as part of the non-initial BWP for the UE 602. These two NCD SSB indices may be NCD SSB 1 and NCD SSB 2, as shown in the configuration 650, which may also be serving SSBs of UE 603 and UE 602, respectively. In other words, the set of NCD SSBs 606, which includes the utilized, serving SSBs transmitted from the base station 604 at the periodicity 608, may be: {SSB 1, SSB 2}. In such an example, the base station 604 may not actually transmit other six SSBs of the additional set of NCD SSBs 610, e.g., {SSB 0, SSB 1, SSB 2, SSB 3, SSB 4, SSB 5, SSB 6, SSB 7}, as part of the set of NCD SSBs 606. According to aspects, the size of the set of NCD SSBs 606 and the size of the set of CD SSBs are not same; hence, the UE 602 cannot monitor all actually transmitted SSBs in its current active BWP. In other aspects, the SSBs of the additional set of NCD SSBs 610 may be transmitted by the base station 604 at the periodicity 612.

In cases when actually transmitted CD SSBs are outside of a current, active BWP, then the base station 604 may be enabled to configure a measurement gap, e.g., via an indication of an L1 measurement gap 626, so that the UE 602 may be configured to measure all CD SSBs from time to time for L1-RSRP reporting, e.g., according to the periodicity 612. The base station 604 may be configured to inform the UE 602 of activation/deactivation associated with the indication of an L1 measurement gap 626 via a dynamic activation/deactivation 628 of the L1 measurement gap, as described herein. In some aspects, the UE 602 may be configured to autonomously and dynamically deactivate the L1 measurement gap via a dynamic deactivation 630 in accordance with the set of NCD SSBs 606 having a same number (or greater number) of SSBs as the set of CD SSBs.

In aspects, if a signal quality of an SSB (e.g., in the set of NCD SSBs 606 and/or the additional set of NCD SSBs 610) becomes better than a serving SSB of the UE 602, the base station 604 may configure the UE 602 to add that SSB into the set of NCD SSBs 606. In some aspects, such a candidate SSB may be added after meeting a signal quality threshold, in addition or alternatively. Conversely, if a signal quality of a serving SSB (e.g., in the set of NCD SSBs 606 and/or the additional set of NCD SSBs 610) of the UE 602 becomes worse than the signal quality threshold (e.g., fails to meet the signal quality threshold), the base station 604 may configure the UE 602 to remove that SSB from the set of NCD SSBs 606. In each case, the base station 604 may configure the UE 602 with an adjustment 624 for the addition to/removal from the set of NCD SSBs 606. The UE 602 may also be configured to transmit/provide, and the base station 604 may be configured to receive, an indication 622 of an SSB meeting the signal quality threshold, e.g., for cases in which a non-serving SSB becomes better than a serving SSB for the UE 602. In other aspects, as described herein, the UE 602 may inform the base station 604 of a serving SSB that fails to meet the signal quality threshold and/or of a non-serving SSB that meets the signal quality threshold/becomes a better signal than the serving SSB via an indication of a BFD/BFR, as described herein.

For cases when the set of NCD SSBs 606 are transmitted by the base station 604 without the additional set of NCD SSBs 610, as well as for cases when both are transmitted, the UE 602 may be configured to measure all received SSBs (e.g., the set of CD SSBs) as part of the initial BWP, or may be configured to measure SSBs from the additional set of NCD SSBs 610 of the initial BWP.

Additionally, as and when the base station 604 may be able to reduce the number of NCD SSBs in the set of NCD SSBs 606 that are being transmitted more frequently than the additional set of NCD SSBs/the set of CD SSBs, the base station 604 is able to save power. Accordingly, the set of NCD SSBs 606 may comprises those NCD SSBs which are actually utilized as serving SSBs, and the base station 604 may be configured to remove any unutilized SSBs from the set of NCD SSBs 606.

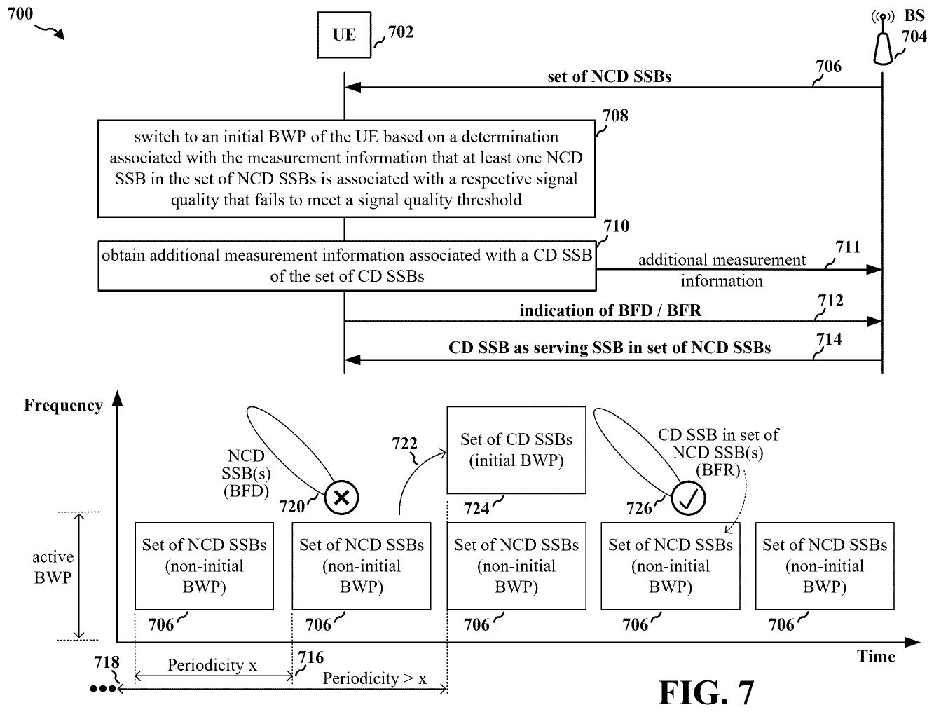

FIG. 7 is a diagram 700 illustrating an example of UE operations for NCD SSB transmissions, in various aspects. Diagram 700 may be an aspect of call flow diagram 500 in FIG. 5. Diagram 700 shows a UE 702 and a network node (e.g., a base station 704) in the context of BFD/BFR for NES for reduced capability and enhanced reduced capability UEs. The UE 702 may be a reduced capability UEs or an enhanced reduced capability UE.

The UE 702 may be configured to receive, and the base station 704 may be configured to transmit/provide, a set of NCD SSBs 706. In aspects, the set of NCD SSBs 706 may be in a non-initial/active BWP of the UE 702 and may be a subset of a set of CD SSBs 724 outside the active BWP of the UE 702. The set of NCD SSBs 706 may have a periodicity 716 (x) that is more frequent, or much more frequent, than a periodicity 718 (>x) of the set of CD SSBs 724. In some aspects, the base station 704 may be configured to not transmit/provide, an additional set of NCD SSBs for the non-initial BWP.

The UE 702 may be configured to switch (at 708) to an initial BWP of the UE 702 based on a determination associated with measurement information that at least one NCD SSB in the set of NCD SSBs 706 is associated with a respective signal quality that fails to meet a signal quality threshold (e.g., below 10% BLER, or the like). The switch (at 708) may be a BWP switch 722. As an example, the UE 702 may be configured to measure signal quality indicators of one or more SSBs, e.g., serving SSBs, of the set of NCD SSBs 706 to obtain measurement information therefor, as described herein, on which a determination of an NCD SSB meeting or failing to meet signal quality threshold may be made by the UE 702. Based on the failure to meet the signal quality threshold, the UE 702 may initiate/perform a BFD 720 for the NCD SSB(s) that failed, and subsequently perform the BWP switch 722 (at 708), e.g., autonomously, to the initial BWP of the UE 702. In some aspects, the UE 702 may perform the BWP switch 722 (at 708) if there are no other NCD SSBs in the set of NCD SSBs 706 that meet the signal quality threshold.

The UE 702 may be configured to obtain (at 710) additional measurement information 711 associated with a CD SSB of the set of CD SSBs 724 in the initial BWP of the UE 702. As similarly noted herein, the UE 702 may be configured to measure signal quality indicators of one or more SSBs of a set of CD SSBs to obtain (at 710) associated measurement information, e.g., the additional measurement information 711. In aspects, the UE 702 may determine that a CD SSB 714 of the set of CD SSBs 724 meets the signal quality threshold, and the UE 702 may be configured to initiate a BFR 726 on the CD SSB 714 of the set of CD SSBs 724 meets the signal quality threshold. The UE 702 may be configured to transmit/provide, and the base station 704 may be configured to receive, the additional measurement information 711 and/or an indication 712 of the BFD 720 and/or the BFR 726. That is, if the UE 702 finds a better SSB (e.g., SSB_i) from the set of CD SSBs 724, then UE 702 may perform the BFR 726 (e.g., via RACH) to this new SSB from the set of CD SSBs 724. For instance, the CD SSB 714 from the set of CD SSBs 724 may have better signal quality and may be set the serving SSB of the UE 702, and the base station 704 may be configured to start transmitting this new serving SSB as part of the set of NCD SSBs 706.

For instance, the UE 702 may be configured to receive, and the base station 704 may be configured to transmit/provide, subsequent to the BFR 726, the CD SSB 714 (e.g., the CD SSB of the set of CD SSBs 724 that meets the signal quality threshold) as a serving SSB and as part of the set of NCD SSBs 706 based on an associated signal quality of the CD SSB 714 meeting the signal quality threshold. The overall BFR 726 timeline of the UE 702 may be influenced by the BWP switch 722 timeline to the initial BWP.

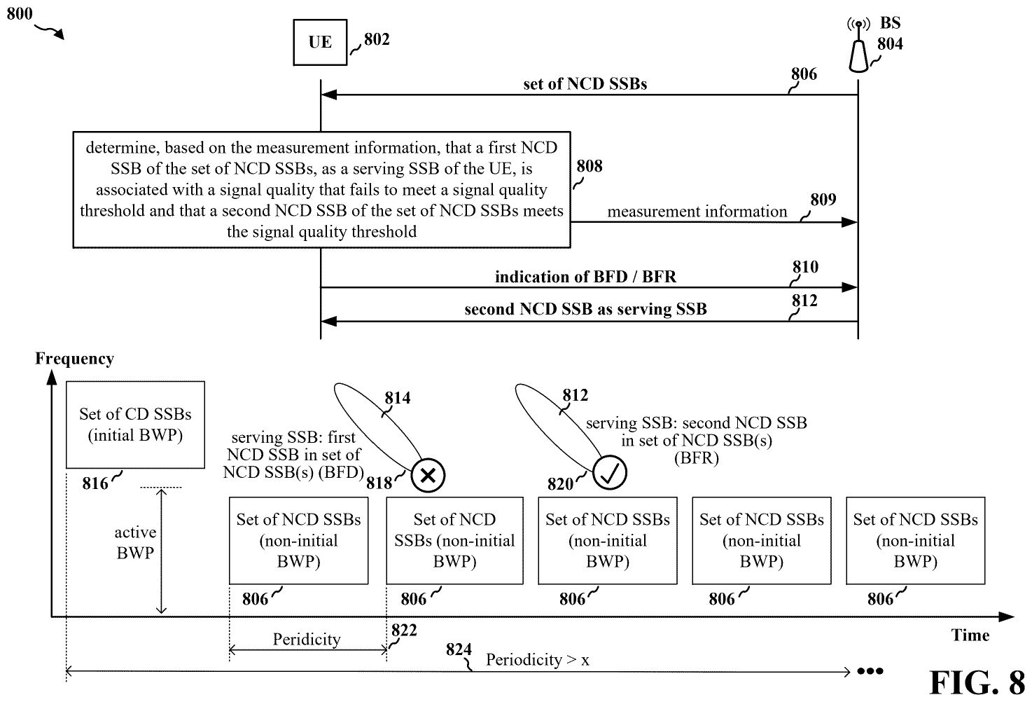

FIG. 8 is a diagram 800 illustrating an example of UE operations for NCD SSB transmissions, in various aspects. Diagram 800 may be an aspect of call flow diagram 500 in FIG. 5. Diagram 800 shows a UE 802 and a network node (e.g., a base station 804) in the context of BFD/BFR for NES for reduced capability and enhanced reduced capability UEs. The UE 802 may be a reduced capability UEs or an enhanced reduced capability UE.

The UE 802 may be configured to receive, and the base station 804 may be configured to transmit/provide, a set of NCD SSBs 806. In aspects, the set of NCD SSBs 806 may be in a non-initial/active BWP of the UE 802 and may be a subset of a set of CD SSBs 816 outside the active BWP of the UE 802. The set of NCD SSBs 806 may have a periodicity 822 (x) that is more frequent, or much more frequent, than a periodicity 824 (>x) of the set of CD SSBs 816. In some aspects, the base station 804 may be configured to, or not to, transmit/provide, an additional set of NCD SSBs for the non-initial BWP, as shown and described herein.

As described herein, the UE 802 may be configured to obtain measurement information 809 associated with the set of NCD SSBs 806. In aspects, the UE 802 may be configured to measure signal quality indicators (e.g., RSRP, RSRQ, SNR, SINR, etc., and/or another reference signal characteristic, RRM measurements, L3 cell level measurements, or other measurements described herein) of one or more SSBs (e.g., a serving SSB (a first NCD SSB 814) and/or a non-serving SSB (a second NCD SSB 812)) of the set of NCD SSBs 806 to obtain the associated measurement information. The UE 802 may be configured to determine (at 808), e.g., based on the measurement information 809 obtained at any given time instance/period, that the first NCD SSB 814 of the set of NCD SSBs 806, as a serving SSB of the UE 802, is associated with a signal quality that fails to meet a signal quality threshold and that the second NCD SSB 812 of the set of NCD SSBs 806 meets the signal quality threshold (e.g., a 10% BLER, or the like). In some aspects, additionally/alternatively, the UE 802 may be configured to determine (at 808) that the second NCD SSB 812 has a better signal quality than the first NCD SSB 814. Based on the failure to meet the signal quality threshold, and/or based on the second NCD SSB 812 having a better signal quality, the UE 802 may initiate/perform a BFD 818 for the first NCD SSB 814, and the UE 802 may be configured to initiate a BFR 820 (e.g., via RACH) on the second NCD SSB 812. The UE 802 may be configured to transmit/provide, and the base station 804 may be configured to receive, the measurement information 809 and/or an indication 810 of the BFD 818 and/or the BFR 820.

The UE 802 may be configured to receive, and the base station 804 may be configured to transmit/provide, subsequent to the BFR 820, the second NCD SSB 812 (e.g., the previously non-serving NCD SSB of the set of NCD SSBs 806 that meets the signal quality threshold) as a serving SSB of the set of NCD SSBs 806, e.g., based on an associated signal quality of the second NCD SSB 812 meeting the signal quality threshold. The overall BFR 820 timeline of the UE 802 may be influenced/determined according to the periodicity 822 by which the base station transmits the set of NCD SSBs 806.

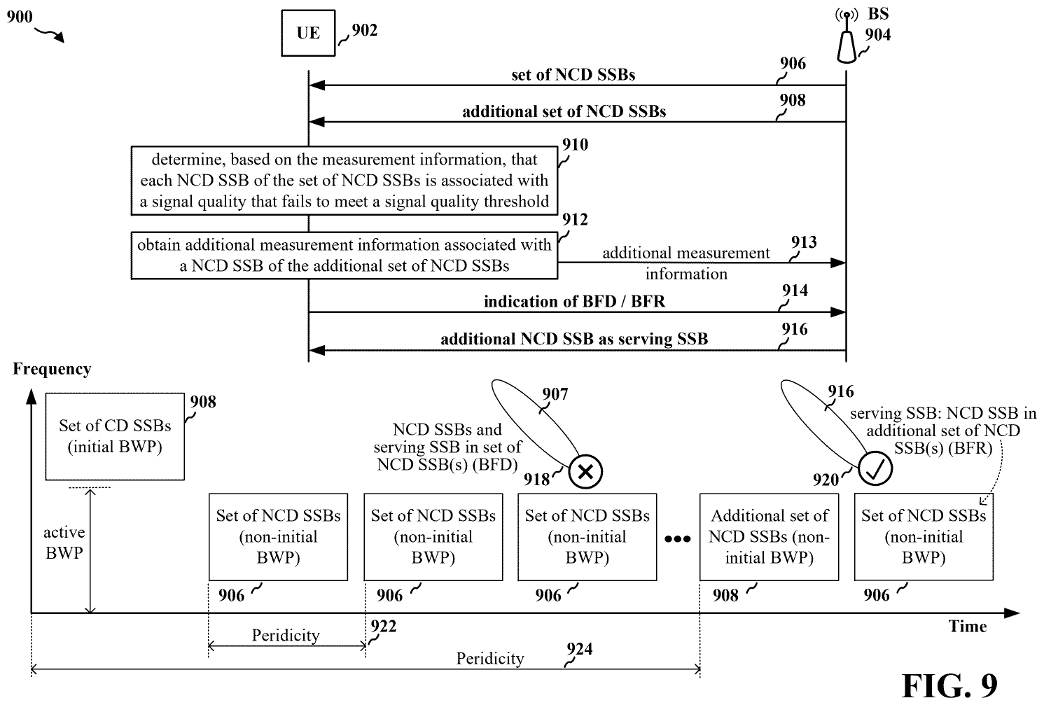

FIG. 9 is a diagram 900 illustrating an example of UE operations for NCD SSB transmissions, in various aspects. Diagram 900 may be an aspect of call flow diagram 500 in FIG. 5. Diagram 900 shows a UE 902 and a network node (e.g., a base station 904) in the context of BFD/BFR for NES for reduced capability and enhanced reduced capability UEs. The UE 902 may be a reduced capability UEs or an enhanced reduced capability UE.

The UE 902 may be configured to receive, and the base station 904 may be configured to transmit/provide, a set of NCD SSBs 906. In aspects, the set of NCD SSBs 906 may be in a non-initial/active BWP of the UE 902 and may be a subset of a set of CD SSBs 908 outside the active BWP of the UE 902. The set of NCD SSBs 906 may have a periodicity 922 (x) that is more frequent, or much more frequent, than a periodicity 924 (>x) of the set of CD SSBs 908. In some aspects, the base station 904 may be configured to, or not to, transmit/provide, an additional set of NCD SSBs 908 for the non-initial BWP of the UE 902, as shown and described herein.

As described herein, the UE 902 may be configured to obtain measurement information associated with the set of NCD SSBs 906. In aspects, the UE 902 may be configured to measure signal quality indicators (e.g., RSRP, RSRQ, SNR, SINR, etc., and/or another reference signal characteristic, RRM measurements, L3 cell level measurements, or other measurements described herein) of one or more SSBs (e.g., a serving SSB and/or a non-serving SSB) of the set of NCD SSBs 906 to obtain the associated measurement information. The UE 902 may be configured to determine (at 910), e.g., based on the measurement information obtained at any given time instance/period, that each NCD SSB 907 of the set of NCD SSBs 906, e.g., a serving SSB of the UE 902 and/or other SSBs, is associated with a signal quality that fails to meet a signal quality threshold (e.g., below a 10% BLER, or the like). For example, when the signal quality of each NCD SSB 907, including the serving SSB, in the set of NCD SSBs 906 is falling below the signal quality threshold, the UE 902 may be configured to determine if any other of each NCD SSBs 907 from the same set of NCD SSBs (e.g., the set of NCD SSBs 906) has a better signal quality or not. If the UE 902 is not able to find any other NCD SSB from same set that is better, the UE 902 may be configured to switch to the additional set of NCD SSBs 908 that are being transmitted by the base station 904 with the longer periodicity (e.g., the periodicity 924) in the current active BWP.

In aspects, based on the failure of the set of NCD SSBs 906 to meet the signal quality threshold, the UE 902 may be configured to obtain (at 912) additional measurement information 913, as described herein, associated with an additional NCD SSB 916 (and/or other NCD SSBs) of the additional set of NCD SSBs 908 (e.g., the UE 902 may be configured to measure signal quality indicators (e.g., RSRP, RSRQ, SNR, SINR, etc.) of one or more SSBs (e.g., a non-serving SSB(s)) of the additional set of NCD SSBs 908 to obtain the associated measurement information (e.g., the additional measurement information 913), and to switch the serving SSB of the UE 902 to the additional NCD SSB 916 of the additional set of NCD SSBs 908 if the additional NCD SSB 916 has sufficient signal quality and meets the signal quality threshold.

For example, based on the failure of the NCD SSBs in the set of NCD SSBs 906 to meet the signal quality threshold (e.g., in the determination (at 910) above), and/or based on the NCD SSB 916 having a better signal quality, the UE 902 may initiate/perform a BFD 918 for the serving SSB of the set of NCD SSBs 906, and the UE 902 may be configured to initiate a BFR 920 (e.g., via RACH) on the additional NCD SSB 916 of the additional set of NCD SSBs 908. The UE 902 may be configured to transmit/provide, and the base station 904 may be configured to receive, the additional measurement information 913 and/or an indication 914 of the BFD 918 and/or the BFR 920.

The UE 902 may be configured to receive, and the base station 904 may be configured to transmit/provide, subsequent to (i) the determination (at 910) that the additional NCD SSB 916 of the additional set of NCD SSBs 908 meets the signal quality threshold and (ii) the BFR 920, the additional NCD SSB 916 (e.g., a previously non-serving NCD SSB of the additional set of NCD SSBs 908 that meets the signal quality threshold) as a serving SSB of the set of NCD SSBs 906, e.g., based on an associated signal quality of the additional NCD SSB 916 meeting the signal quality threshold. Accordingly, the additional NCD SSB 916, as the serving SSB, may be transmitted by the base station 904 to the UE 902 according to the periodicity 922 for the set of NCD SSBs 906.

In aspects, a UE (such as the UE 902) may be configured to transmit/provide for a network node (such as the base station 904) an indication (e.g., the indication 622 in FIG. 6) of an SSB(s) meeting the signal quality threshold, e.g., for cases in which a non-serving SSB becomes better than a serving SSB for the UE. In other aspects the UE (e.g., the UE 902) may inform the network (e.g., the base station 904) of a serving SSB that fails to meet the signal quality threshold and/or of a non-serving SSB that meets the signal quality threshold/becomes a better signal than the serving SSB via an indication of a BFD/BFR, as described above. In such aspects, the base station 904 may be configured to transmit/provide/configure, and the UE 902 may be configured to receive, an adjustment (e.g., the adjustment 624) for the addition/removal of NCD SSBs to/from the set of NCD SSBs 906, and such an adjustment(s) may be made based on the indication of an SSB(s) meeting/failing the signal quality threshold.

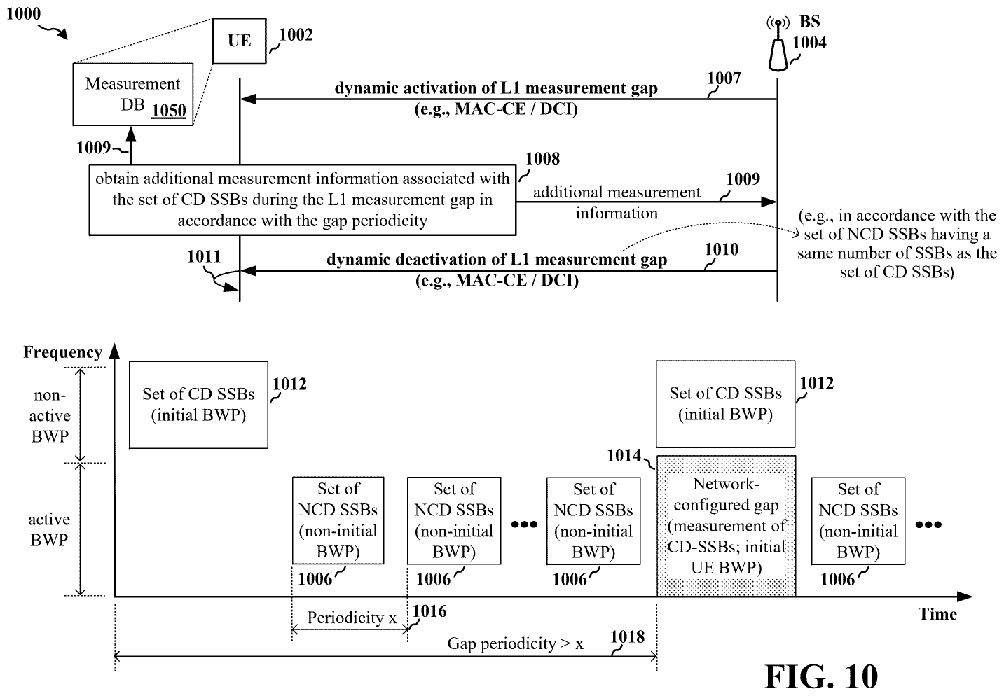

FIG. 10 is a diagram 1000 illustrating an example of UE operations for NCD SSB transmissions and measurement gaps for CD SSBs, in various aspects. Diagram 1000 may be an aspect of call flow diagram 500 in FIG. 5. Diagram 1000 shows a UE 1002 and a network node (e.g., a base station 1004) in the context of L1-measurements via an L1 measurement gap 1014 for NES for reduced capability and enhanced reduced capability UEs. The UE 1002 may be a reduced capability UEs or an enhanced reduced capability UE.

As described herein, a UE, such as the UE 1002, may be configured to receive an NCD SSB configuration (e.g., the NCD SSB configuration 506 in FIG. 5) from the network, such as the base station 1004. The UE 1002 may also be configured to receive, and the base station 1004 may be configured to transmit/provide, a set of NCD SSBs 1006. In aspects, the set of NCD SSBs 1006 may be in a non-initial/active BWP of the UE 1002 and may be a subset of a set of CD SSBs 1012 outside the active BWP of the UE 1002. The set of NCD SSBs 1006 may have a periodicity 1016 (x) that is more frequent, or much more frequent, than a periodicity (>x) of the set of CD SSBs 1012. In some aspects, the base station 1004 may be configured to, or not to, transmit/provide, an additional set of NCD SSBs for the non-initial BWP, as described herein. In the illustrated aspect for the diagram 1000, the additional set of NCD SSBs may not be provided or may be provided with a periodicity that is much higher (>>x) than the set of NCD SSBs 1006.

In aspects, the NCD SSB configuration may include a third indication of the L1 measurement gap 1014 that may be associated with SSB measurements of the set of NCD SSBs 1006. In such aspects, to receive the NCD SSB configuration, the UE 1002 may be configured to receive, and the base station 1004 may be configured to transmit/provide/configure (e.g., in accordance with the set of NCD SSBs 1006 having fewer SSBs than the set of CD SSBs 1012), a dynamic activation 1007 (e.g., the dynamic activation/deactivation 628) for the L1 measurement gap 1014. The dynamic activation 1007 for the L1 measurement gap 1014 may comprise at least one of a MAC-CE or DCI and may include a fourth indication of a gap periodicity 1018 associated with an obtainment of additional measurement information 1009 associated with the set of CD SSBs 1012. In aspects, the gap periodicity 1018 may be longer, or much longer, than the periodicity 1016 of the set of NCD SSBs 1006 to alleviate throughput impacts for the UE 1002.

In aspects, to obtain the measurement information (e.g., the measurement information 512 in FIG. 5) associated with the set of NCD SSBs 1006, the UE 1002 may be configured to obtain (at 1008) the additional measurement information 1009 associated with the set of CD SSBs 1012 during the L1 measurement gap 1014 in accordance with the gap periodicity 1018. In aspects, the UE 1002 may be configured to measure signal quality indicators (e.g., RSRP, RSRQ, SNR, SINR, etc., and/or another reference signal characteristic, RRM measurements, L1-measurements, or other measurements described herein) of one or more SSBs of the set of CD SSBs 1012 to obtain associated measurement information, e.g., the additional measurement information 1009. In aspects, L1-measurements may be utilized for BFD, BFR, RLM, beam management, and/or the like. The UE 1002 may be configured to store such L1-measurements/associated measurement information, such as L1 RSRP, as the additional measurement information 1009, in a measurement database (MDB) 1050 or other equivalent data structure/storage device. The UE 1002 may be configured to transmit, and the base station 1004 may be configured to receive, the additional measurement information 1009 that is obtained (at 1008).

The UE 1002 may determine that a CD SSB of the set of CD SSBs 1012 has a better signal quality (e.g., in terms of a measured L1 RSRP) when the additional measurement information 1009 is obtained (at 1008) by the UE 1002. In such aspects, the UE 1002 may be configured to transmit/provide, and the base station 1004 may be configured to receive, an indication (e.g., the indication 622 in FIG. 6) of the CD SSB meeting the signal quality threshold and/or being a non-serving SSB that is better than a serving SSB in terms of signal quality. In some aspects, the indication may be provided as, in conjunction with, or in lieu of the additional measurement information 1009. The base station 1004 may thus be configured to transmit/provide/configure, and the UE 1002 may be configured to receive, an adjustment (e.g., the adjustment 624) for the addition of the CD SSB to the set of NCD SSBs 1006, e.g., as the serving SSB for the UE 1002. Accordingly, the base station 1004 may be configured to dynamically inform the UE 1002 for the addition to the set of NCD SSBs 1006 (e.g., via an SSB index notification/indication).

In aspects, to receive the NCD SSB configuration, the UE 1002 may be configured to receive, and the base station 1004 may be configured to transmit/provide/configure, subsequent to the dynamic activation 1007 for the L1 measurement gap 1014, a dynamic deactivation 1010 (e.g., the dynamic activation/deactivation 628) for the L1 measurement gap 1014 in accordance with the set of NCD SSBs 1006 having a same number (or greater number) of SSBs as the set of CD SSBs 1012. In aspects, the dynamic deactivation 1010 for the L1 measurement gap 1014 may comprise at least one of the MAC-CE or the DCI. In some aspects, the UE 1002 may be configured to autonomously and dynamically deactivate the L1 measurement gap 1014 via a dynamic deactivation 1011 in accordance with the set of NCD SSBs 1006 having a same number (or greater number) of SSBs as the set of CD SSBs 1012.

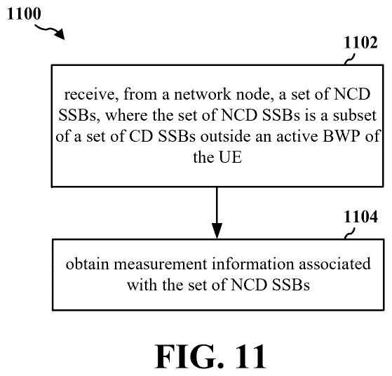

FIG. 11 is a flowchart 1100 of a method of wireless communication. The method may be performed by a UE (e.g., the UE 104, 402, 502, 602, 603, 702, 802, 902, 1002; the apparatus 1504). The method may be for NES for reduced capability and enhanced reduced capability UEs. The method may enable a reduced capability UE to receive NCD SSBs having different indices at different periodicities, to utilize BFD/BFR for NES in reduced capability cells to indicate SSB beams having improved/sufficient signal quality, and to be configured by a network for L1 measurements outside of an active BW using a measurement gap.

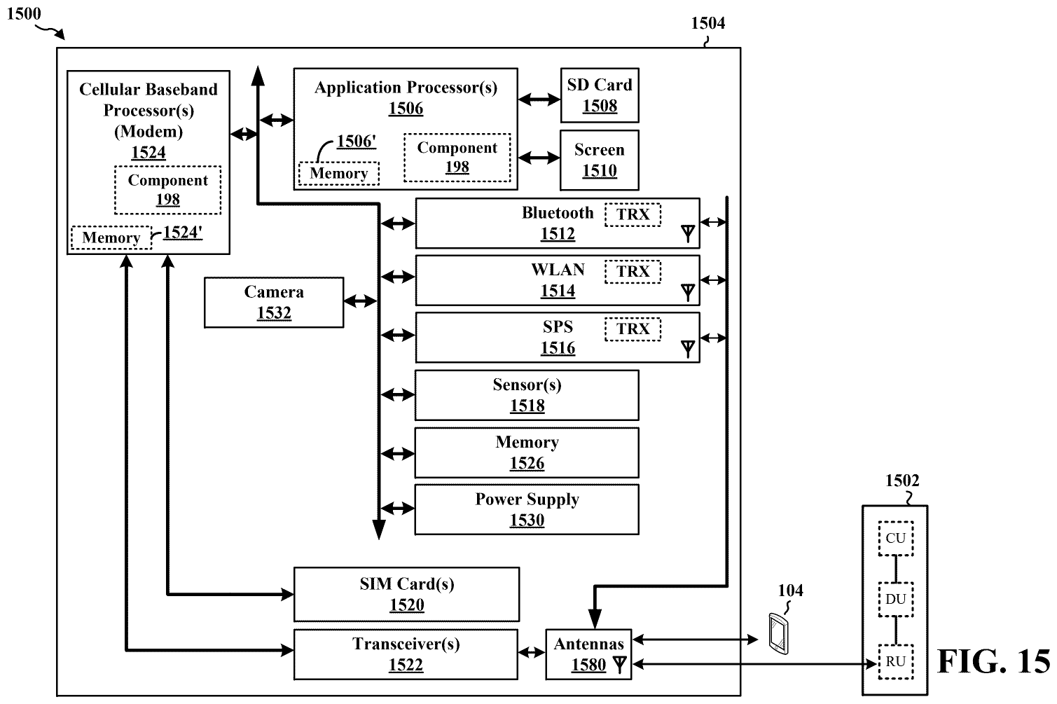

At 1102, the UE receives, from a network node, a set of NCD SSBs, where the set of NCD SSBs is a subset of a set of CD SSBs outside an active BWP of the UE. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such a set of NCD SSBs from a network node (e.g., the base station 504).

The UE 502 may be configured to receive, and the base station 504 may be configured to transmit/provide/configure, an NCD SSB configuration 506 (e.g., 614 in FIG. 6). In aspects, the NCD SSB configuration 506 (e.g., 614 in FIG. 6) may be indicative of at least one of (i) a first indication (e.g., 616 in FIG. 6) of a periodicity (e.g., 608 in FIG. 6; 716 in FIG. 7; 822 in FIG. 8; 922 in FIG. 9; 1016 in FIG. 10) associated with first NCD SSBs (e.g., one or more) in a set of NCD SSBs 508 (e.g., 606 in FIG. 6; 706 in FIG. 7; 806 in FIG. 8; 906 in FIG. 9; 1006 in FIG. 10) or (ii) a second indication (e.g., 618 in FIG. 6) of a set of periodicities (e.g., 612 in FIG. 6; 924 in FIG. 9) associated with second NCD SSBs (e.g., 812 in FIG. 8) (e.g., one or more) in an additional set of NCD SSBs (e.g., 610 in FIG. 6; 908 in FIG. 9). In some aspects, to receive the NCD SSB configuration 506 (e.g., 614 in FIG. 6), the UE 502 may be configured to receive, and the base station 504 may be configured to transmit/provide/configure, an adjustment (e.g., 624 in FIG. 6) associated with the NCD SSB configuration 506 (e.g., 614 in FIG. 6). The adjustment (e.g., 624 in FIG. 6) may comprise/include at least one of a MAC-CE or DCI. The adjustment (e.g., 624 in FIG. 6) via MAC-CE/DCI may include a set of bits indicative of at least one of (i) an additional NCD SSB (e.g., 916 in FIG. 9) for addition (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) or (ii) a current NCD SSB for removal (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10). As one example, and as noted above, the UE 502 may be configured to initiate BFDs (e.g., 712, 720 in FIG. 7; 818 in FIG. 8; 918 in FIG. 9) for NCD SSBs that fail to meet (e.g., 814 in FIG. 8; 907 in FIG. 9) a signal quality threshold (e.g., 622 in FIG. 6; at 708 in FIG. 7; at 808 in FIG. 8; at 910 in FIG. 9), and such NCD SSBs may be removed (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). Likewise, the UE 502 may be configured to initiate BFRs (e.g., 712, 726 in FIG. 7; 810, 820 in FIG. 8; 914, 920 in FIG. 9) for NCD SSBs and/or CD SSBs (e.g., 714 in FIG. 7) that meet (e.g., 622 in FIG. 6) a signal quality threshold (e.g., 622 in FIG. 6; at 708 in FIG. 7; at 808 in FIG. 8; at 910 in FIG. 9), and such NCD SSBs/CD SSBs may be added (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). For instance, to receive the adjustment (e.g., 624 in FIG. 6) associated with the NCD SSB configuration 506 (e.g., 614 in FIG. 6), the UE 502 may be configured to transmit/provide, and the base station 504 may be configured to receive, an indication of SSBs in at least one of the set of NCD SSBs 508 (e.g., 606 in FIG. 6; 706 in FIG. 7; 806 in FIG. 8; 906 in FIG. 9; 1006 in FIG. 10) or the set of CD SSBs (e.g., 724 in FIG. 7; 816 in FIG. 8; 908 in FIG. 9; 1012 in FIG. 10) that meets (e.g., 622 in FIG. 6) the signal quality threshold (e.g., 622 in FIG. 6; at 708 in FIG. 7; at 808 in FIG. 8; at 910 in FIG. 9). In such aspects, the adjustment (e.g., 624 in FIG. 6) may thus be based on the indication. In some aspects, the NCD SSB configuration 506 (e.g., 614 in FIG. 6) may include a third indication of an L1 measurement gap (e.g., 626 in FIG. 6; 1014 in FIG. 10) associated with SSB measurements of the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive, and the base station 504 may be configured to transmit/provide/configure in accordance with the set of NCD SSBs 508 (e.g., 606 in FIG. 6; 706 in FIG. 7; 806 in FIG. 8; 906 in FIG. 9; 1006 in FIG. 10) having fewer SSBs than the set of CD SSBs (e.g., 724 in FIG. 7; 816 in FIG. 8; 908 in FIG. 9; 1012 in FIG. 10), a dynamic activation (e.g., 628, 630 in FIG. 6; 1007 in FIG. 10) for the L1 measurement gap (e.g., 626 in FIG. 6; 1014 in FIG. 10). The dynamic activation (e.g., 628, 630 in FIG. 6; 1007 in FIG. 10) for the L1 measurement gap (e.g., 626 in FIG. 6; 1014 in FIG. 10) may comprise include at least one of a MAC-CE or DCI that includes a fourth indication of a gap periodicity (e.g., 626 in FIG. 6; 1018 in FIG. 10) associated with an obtainment (e.g., at 710 in FIG. 7; at 912 in FIG. 9; at 1008 in FIG. 10) of additional measurement information (e.g., 1009 in FIG. 10) associated with the set of CD SSBs (e.g., 724 in FIG. 7; 816 in FIG. 8; 908 in FIG. 9; 1012 in FIG. 10). In aspects, the gap periodicity (e.g., 626 in FIG. 6; 1018 in FIG. 10) may be longer than the periodicity (e.g., 608 in FIG. 6; 716 in FIG. 7; 822 in FIG. 8; 922 in FIG. 9; 1016 in FIG. 10) of the set of NCD SSBs (e.g., the NCD SSB periodicity (e.g., 608 in FIG. 6; 716 in FIG. 7; 822 in FIG. 8; 922 in FIG. 9; 1016 in FIG. 10) to be smaller than, or relatively small compared to, CD SSB periods (e.g., 718 in FIG. 7) and/or non-serving NCD SSB periods (e.g., 612 in FIG. 6; 924 in FIG. 9) for measurement gaps (e.g., 626 in FIG. 6; 1014 in FIG. 10), such for maintenance of RLM/BFD (e.g., 712, 720 in FIG. 7; 818 in FIG. 8; 918 in FIG. 9)/L1-RSRP quality. The UE 502, to obtain (at 510) (e.g., at 710 in FIG. 7; at 912 in FIG. 9; at 1008 in FIG. 10) the measurement information 512 (e.g., 711 in FIG. 7; 809 in FIG. 8; 913 in FIG. 9; 1009 in FIG. 10) associated with the set of NCD SSBs (e.g., 606 in FIG. 6; 706 in FIG. 7; 806 in FIG. 8; 906 in FIG. 9; 1006 in FIG. 10), may be configured to obtain (e.g., at 510) (e.g., at 710 in FIG. 7; at 912 in FIG. 9; at 1008 in FIG. 10) the additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10) during the L1 measurement gap (e.g., 626 in FIG. 6; 1014 in FIG. 10) in accordance with the gap periodicity (e.g., 626 in FIG. 6; 1018 in FIG. 10). In aspects, to receive the NCD SSB configuration 506 (e.g., 614 in FIG. 6), the UE 502 may be configured to receive, and the base station 504 may be configured to transmit/provide/configure subsequent to the dynamic activation (e.g., 628, 630 in FIG. 6; 1007 in FIG. 10) for the L1 measurement gap (e.g., 626 in FIG. 6; 1014 in FIG. 10), a dynamic deactivation (e.g., 628, 630 in FIG. 6; 1010, 1011 in FIG. 10) for the L1 measurement gap (e.g., 626 in FIG. 6; 1014 in FIG. 10) in accordance with the set of NCD SSBs 508 (e.g., 606 in FIG. 6; 706 in FIG. 7; 806 in FIG. 8; 906 in FIG. 9; 1006 in FIG. 10) having a same number of SSBs as the set of CD SSBs (e.g., or more SSBs) (e.g., 724 in FIG. 7; 816 in FIG. 8; 908 in FIG. 9; 1012 in FIG. 10). The dynamic deactivation (e.g., 628, 630 in FIG. 6; 1010, 1011 in FIG. 10) for the L1 measurement gap (e.g., 626 in FIG. 6; 1014 in FIG. 10) may comprise/include at least one of the MAC-CE or the DCI, in aspects. In some aspects, the UE 502 may be configured to autonomously and dynamically deactivate (e.g., 630 in FIG. 6; 1011 in FIG. 10) the L1 measurement gap via a dynamic deactivation (e.g., 626 in FIG. 6; 1014 in FIG. 10) in accordance with the set of NCD SSBs (e.g., 606 in FIG. 6; 706 in FIG. 7; 806 in FIG. 8; 906 in FIG. 9; 1006 in FIG. 10) having a same number (or greater number) of SSBs as the set of CD SSBs (e.g., 724 in FIG. 7; 816 in FIG. 8; 908 in FIG. 9; 1012 in FIG. 10).

The UE 502 may be configured to transmit/provide, and at least one network node (e.g., the base station 504) may be configured to receive, the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In some aspects, the base station 504 may be configured to utilize the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10) to adjust (e.g., 624 in FIG. 6) the set of NCD SSBs 508 (e.g., 606 in FIG. 6; 706 in FIG. 7; 806 in FIG. 8; 906 in FIG. 9; 1006 in FIG. 10) and/or to perform other UE/cell management functions, as described herein.

In aspects, the UE 502 may be configured to receive, and the base station 504 may be configured to transmit/provide, the set of NCD SSBs 508 (e.g., 606 in FIG. 6; 706 in FIG. 7; 806 in FIG. 8; 906 in FIG. 9; 1006 in FIG. 10). In aspects, the set of NCD SSBs 508 (e.g., 606 in FIG. 6; 706 in FIG. 7; 806 in FIG. 8; 906 in FIG. 9; 1006 in FIG. 10) may be a subset of a set of CD SSBs (e.g., 724 in FIG. 7; 816 in FIG. 8; 908 in FIG. 9; 1012 in FIG. 10) outside an active BWP of the UE 502 (e.g., as shown for the set of CD SSBs 406 in FIG. 4). As described herein, a set of CD SSBs (e.g., 724 in FIG. 7; 816 in FIG. 8; 908 in FIG. 9; 1012 in FIG. 10) may be actually transmitted by a network node (e.g., the base station 504) and may be received by a UE (e.g., the UE 502). To transmit the set of NCD SSBs, the UE 502 may be configured to receive, and the base station 504 may be configured to transmit/provide, the set of CD SSBs (e.g., 724 in FIG. 7; 816 in FIG. 8; 908 in FIG. 9; 1012 in FIG. 10) outside the active BWP of the UE 502. In aspects, to receive the set of NCD SSBs 508 (e.g., 606 in FIG. 6; 706 in FIG. 7; 806 in FIG. 8; 906 in FIG. 9; 1006 in FIG. 10), the UE 502 may be configured to receive, and the base station 504 may be configured to transmit/provide, an additional set of NCD SSBs (e.g., 610 in FIG. 6; 908 in FIG. 9) in accordance with an additional periodicity (e.g., 612 in FIG. 6; 924 in FIG. 9) that is longer than a periodicity (e.g., 608 in FIG. 6; 716 in FIG. 7; 822 in FIG. 8; 922 in FIG. 9; 1016 in FIG. 10) of the set of NCD SSBs 508 (e.g., 606 in FIG. 6; 706 in FIG. 7; 806 in FIG. 8; 906 in FIG. 9; 1006 in FIG. 10). The additional set of NCD SSBs (e.g., 610 in FIG. 6; 908 in FIG. 9) may be exclusive of the set of NCD SSBs 508 (e.g., 606 in FIG. 6; 706 in FIG. 7; 806 in FIG. 8; 906 in FIG. 9; 1006 in FIG. 10), as described herein. In some aspects, a number of first NCD SSBs in the set of NCD SSBs 508 (e.g., 606 in FIG. 6; 706 in FIG. 7; 806 in FIG. 8; 906 in FIG. 9; 1006 in FIG. 10) may be less than an additional number of second NCD SSBs (e.g., 812 in FIG. 8) in the additional set of NCD SSBs (e.g., 610 in FIG. 6; 908 in FIG. 9). In some aspects, the number of first NCD SSBs in the set of NCD SSBs 508 (e.g., 606 in FIG. 6; 706 in FIG. 7; 806 in FIG. 8; 906 in FIG. 9; 1006 in FIG. 10) and the additional number of second NCD SSBs (e.g., 812 in FIG. 8) in the additional set of NCD SSBs (e.g., 610 in FIG. 6; 908 in FIG. 9) may equal a total number of CD SSBs in the set CD SSBs (e.g., 724 in FIG. 7; 816 in FIG. 8; 908 in FIG. 9; 1012 in FIG. 10).

At 1104, the UE obtains measurement information associated with the set of NCD SSBs. As an example, the obtainment may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such measurement information associated with the set of NCD SSBs.

In aspects, the UE 502 may be configured to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In aspects, the UE 502 may be configured to measure signal quality indicators (e.g., RSRP, RSRQ, SNR, SINR, and/or another reference signal characteristic, RRM measurements, L3 cell level measurements, or other measurements described herein) of one or more SSBs of the set of NCD SSBs 508 (e.g., 606 in FIG. 6; 706 in FIG. 7; 806 in FIG. 8; 906 in FIG. 9; 1006 in FIG. 10) to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10). The UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that meets (e.g., 622 in FIG. 6) (or not) a signal quality threshold (e.g., 622 in FIG. 6; at 708 in FIG. 7; at 808 in FIG. 8; at 910 in FIG. 9) (e.g., below 10% block error rate (BLER), or the like).

In some aspects, the UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) (e.g., below 10% BLER of a hypothetical PDCCH, or the like). The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9), e.g., based on the determined signal quality threshold (e.g., 622 in FIG. 6; at 708 in FIG. 7; at 808 in FIG. 8; at 910 in FIG. 9) failure (e.g., 814 in FIG. 8; 907 in FIG. 9). The UE 502 may be configured to determine that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9), and to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the NCD SSB of the additional set of NCD SSBs (e.g., 610 in FIG. 6; 908 in FIG. 9). The UE 502 may be configured to transmit/provide, and the base station 504 may be configured to receive, the measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) first measurement information for a determination that each NCD SSB of the set of NCD SSBs 508 (e.g., 606 in FIG. 6; 706 in FIG. 7; 806 in FIG. 8; 906 in FIG. 9; 1006 in FIG. 10) is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9). The UE 502 may be configured to transmit/provide, and the base station 504 may be configured to receive, a beam failure recovery (e.g., 712, 726 in FIG. 7; 810, 820 in FIG. 8; 914, 920 in FIG. 9) signal to the network based on the additional measurement information (e.g., 711 in FIG. 7; 913 in FIG. 9; 1009 in FIG. 10) associated with the CD SSB (e.g., 714 in FIG. 7). The UE 502 may be configured to receive, and the base station 504 may be configured to transmit/provide, subsequent to a beam failure recovery (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs (e.g., 606 in FIG. 6; 706 in FIG. 7; 806 in FIG. 8; 906 in FIG. 9; 1006 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9). Thus, the UE 502 may be configured to receive, and the base station 504 may be configured to transmit/provide, subsequent to (i) a determination that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9) and (ii) a BFR (e.g., 712, 726 in FIG. 7; 810, 820 in FIG. 8; 914, 920 in FIG. 9), the NCD SSB of the additional set of NCD SSBs (e.g., 610 in FIG. 6; 908 in FIG. 9) as a serving SSB, e.g., now as part of the set of NCD SSBs 508 (e.g., 606 in FIG. 6; 706 in FIG. 7; 806 in FIG. 8; 906 in FIG. 9; 1006 in FIG. 10) after being adjusted therefor.

In some aspects, the UE 502 may be configured to switch (e.g., at 708, 722 in FIG. 7) to an initial BWP (e.g., non-default/non-active BWP for the CD SSBs (e.g., 714, 724 in FIG. 7; 816 in FIG. 8; 908 in FIG. 9; 1012 in FIG. 10)) of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). For instance, the UE 502 may be configured to determine, based on the measurement information 512 (e.g., 711 in FIG. 7; 809 in FIG. 8; 913 in FIG. 9; 1009 in FIG. 10), that an NCD SSB(s) of the set of NCD SSBs 508 (e.g., 606 in FIG. 6; 706 in FIG. 7; 806 in FIG. 8; 906 in FIG. 9; 1006 in FIG. 10) fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). Accordingly, the UE 502 may be configured to switch (e.g., at 708, 722 in FIG. 7) to the initial BWP. The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10), e.g., based on the switch (e.g., at 708, 722 in FIG. 7) to the initial BWP associated with the set of CD SSBs (e.g., 724 in FIG. 7; 816 in FIG. 8; 908 in FIG. 9; 1012 in FIG. 10). A transmission of a given CD SSB (e.g., 714 in FIG. 7) and/or of the set of CD SSBs (e.g., 724 in FIG. 7; 816 in FIG. 8; 908 in FIG. 9; 1012 in FIG. 10) may occur outside the active BWP of the UE 502. The UE 502 may be configured to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the CD SSB (e.g., 714 in FIG. 7) of the set of CD SSBs (e.g., 724 in FIG. 7; 816 in FIG. 8; 908 in FIG. 9; 1012 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9). The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) a switch (e.g., at 708, 722 in FIG. 7) to an initial BWP of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10). In aspects, a first time taken for the beam failure recovery (e.g., 712, 726 in FIG. 7; 810, 820 in FIG. 8; 914, 920 in FIG. 9) may be associated with a second time taken for the switch (e.g., at 708, 722 in FIG. 7) to the initial BWP. Thus, the UE 502 may be configured to receive, and the base station 504 may be configured to transmit/provide, subsequent to a BFR (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs 508 (e.g., 606 in FIG. 6; 706 in FIG. 7; 806 in FIG. 8; 906 in FIG. 9; 1006 in FIG. 10) after being adjusted therefor.

In some aspects, the UE 502 may be configured to determine, based on the measurement information 512 (e.g., 711 in FIG. 7; 809 in FIG. 8; 913 in FIG. 9; 1009 in FIG. 10), that a first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) (e.g., below 10% BLER, or the like) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). In aspects, such a determination may be performed in association with the non-initial/active BWP of the UE 502. The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for a first NCD SSB of the set of NCD SSBs 508 (e.g., 606 in FIG. 6; 706 in FIG. 7; 806 in FIG. 8; 906 in FIG. 9; 1006 in FIG. 10). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of a determination that the first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). The UE 502 may be configured to subsequently initiate a BFR (e.g., 712, 726 in FIG. 7; 810, 820 in FIG. 8; 914, 920 in FIG. 9) for the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10), and thus be configured to receive, and the base station 504 may be configured to transmit/provide, subsequent to the BFR (e.g., 712, 726 in FIG. 7; 810, 820 in FIG. 8; 914, 920 in FIG. 9), the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) as the serving SSB. In such aspects, the set of NCD SSBs (e.g., 606 in FIG. 6; 706 in FIG. 7; 806 in FIG. 8; 906 in FIG. 9; 1006 in FIG. 10) may include the second NCD SSB (e.g., 812 in FIG. 8). In some aspects, the set of NCD SSBs (e.g., 606 in FIG. 6; 706 in FIG. 7; 806 in FIG. 8; 906 in FIG. 9; 1006 in FIG. 10) may comprise an NCD SSB burst set in which given NCD SSBs are ordered/positioned. The NCD SSB configuration 506 (e.g., 614 in FIG. 6) may include at least one burst position IE (e.g., 620 in FIG. 6) indicative of the first NCD SSBs in the set of NCD SSBs 508 (e.g., 606 in FIG. 6; 706 in FIG. 7; 806 in FIG. 8; 906 in FIG. 9; 1006 in FIG. 10) for such an NCD SSB burst set. In some aspects, the at least one burst position IE (e.g., 620 in FIG. 6) may include a burst position IE (e.g., 620 in FIG. 6) for each of the first NCD SSBs in the set of NCD SSBs 508 (e.g., 606 in FIG. 6; 706 in FIG. 7; 806 in FIG. 8; 906 in FIG. 9; 1006 in FIG. 10) and/or for each of the second NCD SSBs (e.g., 812 in FIG. 8) in the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive the NCD SSB configuration 506 (e.g., 614 in FIG. 6) via RRC signaling.

In some aspects, to receive the NCD SSB configuration 506 (e.g., 614 in FIG. 6), the UE 502 may be configured to receive, and the base station 504 may be configured to transmit/provide/configure, an adjustment (e.g., 624 in FIG. 6) associated with the NCD SSB configuration 506 (e.g., 614 in FIG. 6). The adjustment (e.g., 624 in FIG. 6) may comprise/include at least one of a MAC-CE or DCI. The adjustment (e.g., 624 in FIG. 6) via MAC-CE/DCI may include a set of bits indicative of at least one of (i) an additional NCD SSB (e.g., 916 in FIG. 9) for addition (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) or (ii) a current NCD SSB for removal (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10). As one example, and as noted above, the UE 502 may be configured to initiate BFDs (e.g., 712, 720 in FIG. 7; 818 in FIG. 8; 918 in FIG. 9) for NCD SSBs that fail to meet (e.g., 814 in FIG. 8; 907 in FIG. 9) a signal quality threshold (e.g., 622 in FIG. 6; at 708 in FIG. 7; at 808 in FIG. 8; at 910 in FIG. 9), and such NCD SSBs may be removed (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). Likewise, the UE 502 may be configured to initiate BFRs (e.g., 712, 726 in FIG. 7; 810, 820 in FIG. 8; 914, 920 in FIG. 9) for NCD SSBs and/or CD SSBs (e.g., 714 in FIG. 7) that meet (e.g., 622 in FIG. 6) a signal quality threshold (e.g., 622 in FIG. 6; at 708 in FIG. 7; at 808 in FIG. 8; at 910 in FIG. 9), and such NCD SSBs/CD SSBs (e.g., 714 in FIG. 7) may be added (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). For instance, to receive the adjustment (e.g., 624 in FIG. 6) associated with the NCD SSB configuration 506 (e.g., 614 in FIG. 6), the UE 502 may be configured to transmit/provide, and the base station 504 may be configured to receive, an indication of SSBs in at least one of the set of NCD SSBs 508 (e.g., 606 in FIG. 6; 706 in FIG. 7; 806 in FIG. 8; 906 in FIG. 9; 1006 in FIG. 10) or the set of CD SSBs (e.g., 724 in FIG. 7; 816 in FIG. 8; 908 in FIG. 9; 1012 in FIG. 10) that meets (e.g., 622 in FIG. 6) the signal quality threshold (e.g., 622 in FIG. 6; at 708 in FIG. 7; at 808 in FIG. 8; at 910 in FIG. 9). In such aspects, the adjustment (e.g., 624 in FIG. 6) may thus be based on the indication.

In some aspects, the NCD SSB configuration 506 (e.g., 614 in FIG. 6) may include a third indication of an L1 measurement gap (e.g., 626 in FIG. 6; 1014 in FIG. 10) associated with SSB measurements (e.g., at 1008 in FIG. 10) of the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive, and the base station 504 may be configured to transmit/provide/configure in accordance with the set of NCD SSBs 508 (e.g., 606 in FIG. 6; 706 in FIG. 7; 806 in FIG. 8; 906 in FIG. 9; 1006 in FIG. 10) having fewer SSBs than the set of CD SSBs (e.g., 724 in FIG. 7; 816 in FIG. 8; 908 in FIG. 9; 1012 in FIG. 10), a dynamic activation (e.g., 628, 630 in FIG. 6; 1007 in FIG. 10) for the L1 measurement gap (e.g., 626 in FIG. 6; 1014 in FIG. 10). The dynamic activation (e.g., 628, 630 in FIG. 6; 1007 in FIG. 10) for the L1 measurement gap (e.g., 626 in FIG. 6; 1014 in FIG. 10) may comprise include at least one of a MAC-CE or DCI that includes a fourth indication of a gap periodicity (e.g., 626 in FIG. 6; 1018 in FIG. 10) associated with an obtainment (e.g., at 710 in FIG. 7; at 912 in FIG. 9; at 1008 in FIG. 10) of additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10). In aspects, the gap periodicity (e.g., 626 in FIG. 6; 1018 in FIG. 10) may be longer than the periodicity (e.g., 608 in FIG. 6; 716 in FIG. 7; 822 in FIG. 8; 922 in FIG. 9; 1016 in FIG. 10) of the set of NCD SSBs (e.g., 606 in FIG. 6; 706 in FIG. 7; 806 in FIG. 8; 906 in FIG. 9; 1006 in FIG. 10) (e.g., the NCD SSB periodicity (e.g., 608 in FIG. 6; 716 in FIG. 7; 822 in FIG. 8; 922 in FIG. 9; 1016 in FIG. 10) to be smaller than, or relatively small compared to, CD SSB periods (e.g., 718 in FIG. 7) and/or non-serving NCD SSB periods (e.g., 612, 924 in FIG. 9) for measurement gaps (e.g., 1014 in FIG. 10), such for maintenance of RLM/BFD (e.g., 712, 720 in FIG. 7; 818 in FIG. 8; 918 in FIG. 9)/L1-RSRP quality. The UE 502, to obtain (at 510) (e.g., at 710 in FIG. 7; at 912 in FIG. 9; at 1008 in FIG. 10) the measurement information 512 (e.g., 711 in FIG. 7; 809 in FIG. 8; 913 in FIG. 9; 1009 in FIG. 10) associated with the set of NCD SSBs (e.g., 606 in FIG. 6; 706 in FIG. 7; 806 in FIG. 8; 906 in FIG. 9; 1006 in FIG. 10), may be configured to obtain (e.g., at 510) (e.g., at 710 in FIG. 7; at 912 in FIG. 9; at 1008 in FIG. 10) the additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10) during the L1 measurement gap (e.g., 626 in FIG. 6; 1014 in FIG. 10) in accordance with the gap periodicity (e.g., 626 in FIG. 6; 1014 in FIG. 10). In aspects, to receive the NCD SSB configuration 506 (e.g., 614 in FIG. 6), the UE 502 may be configured to receive, and the base station 504 may be configured to transmit/provide/configure subsequent to the dynamic activation (e.g., 628, 630 in FIG. 6; 1007 in FIG. 10) for the L1 measurement gap (e.g., 626 in FIG. 6; 1014 in FIG. 10), a dynamic deactivation (e.g., 628, 630 in FIG. 6; 1010, 1011 in FIG. 10) for the L1 measurement gap (e.g., 626 in FIG. 6; 1014 in FIG. 10) in accordance with the set of NCD SSBs 508 (e.g., 606 in FIG. 6; 706 in FIG. 7; 806 in FIG. 8; 906 in FIG. 9; 1006 in FIG. 10) having a same number of SSBs as the set of CD SSBs (e.g., or more SSBs) (e.g., 724 in FIG. 7; 816 in FIG. 8; 908 in FIG. 9; 1012 in FIG. 10). The dynamic deactivation (e.g., 628, 630 in FIG. 6; 1010, 1011 in FIG. 10) for the L1 measurement gap (e.g., 626 in FIG. 6; 1014 in FIG. 10) may comprise/include at least one of the MAC-CE or the DCI, in aspects. In some aspects, the UE 502 may be configured to autonomously and dynamically deactivate (e.g., 630 in FIG. 6; 1011 in FIG. 10) the L1 measurement gap via a dynamic deactivation (e.g., 626 in FIG. 6; 1014 in FIG. 10) in accordance with the set of NCD SSBs (e.g., 606 in FIG. 6; 706 in FIG. 7; 806 in FIG. 8; 906 in FIG. 9; 1006 in FIG. 10) having a same number (or greater number) of SSBs as the set of CD SSBs (e.g., 724 in FIG. 7; 816 in FIG. 8; 908 in FIG. 9; 1012 in FIG. 10).

The UE 502 may be configured to transmit/provide, and at least one network node (e.g., the base station 504) may be configured to receive, the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In some aspects, the base station 504 may be configured to utilize the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10) to adjust (e.g., 624 in FIG. 6) the set of NCD SSBs 508 (e.g., 606 in FIG. 6; 706 in FIG. 7; 806 in FIG. 8; 906 in FIG. 9; 1006 in FIG. 10) and/or to perform other UE/cell management functions, as described herein.

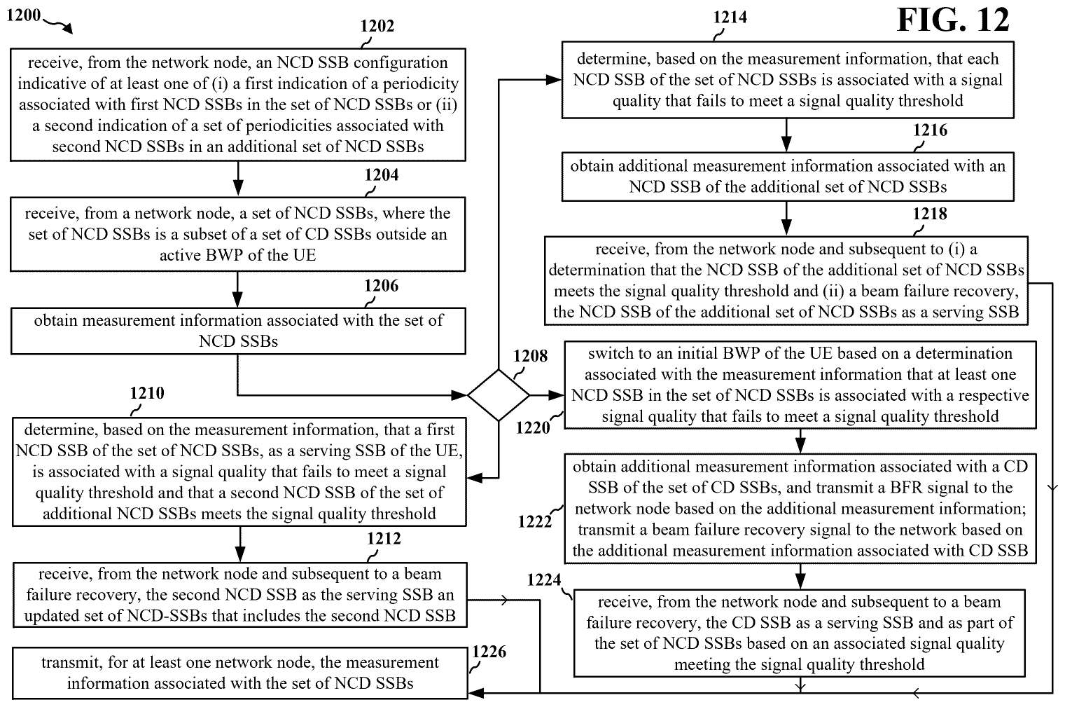

FIG. 12 is a flowchart 1200 of a method of wireless communication. The method may be performed by a UE (e.g., the UE 104, 402, 502, 602, 603, 702, 802, 902, 1002; the apparatus 1504). The method may be for NES for reduced capability and enhanced reduced capability UEs. The method may enable a reduced capability UE to receive NCD SSBs having different indices at different periodicities, to utilize BFD/BFR for NES in reduced capability cells to indicate SSB beams having improved/sufficient signal quality, and to be configured by a network for L1 measurements outside of an active BW using a measurement gap.

At 1202, the UE receives, from a network node, an NCD SSB configuration indicative of at least one of (i) a first indication of a periodicity associated with first NCD SSBs in the set of NCD SSBs or (ii) a second indication of a set of periodicities associated with second NCD SSBs in an additional set of NCD SSBs. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such an NCD SSB configuration from a network node (e.g., the base station 504).

The UE 502 may be configured to receive, and the base station 504 may be configured to transmit/provide/configure, an NCD SSB configuration 506 (e.g., 614 in FIG. 6). In aspects, the NCD SSB configuration 506 (e.g., 614 in FIG. 6) may be indicative of at least one of (i) a first indication (e.g., 616 in FIG. 6) of a periodicity (e.g., 608 in FIG. 6; 716 in FIG. 7; 822 in FIG. 8; 922 in FIG. 9; 1016 in FIG. 10) associated with first NCD SSBs (e.g., one or more) in a set of NCD SSBs 508 (e.g., 606 in FIG. 6; 706 in FIG. 7; 806 in FIG. 8; 906 in FIG. 9; 1006 in FIG. 10) or (ii) a second indication (e.g., 618 in FIG. 6) of a set of periodicities (e.g., 612 in FIG. 6; 924 in FIG. 9) associated with second NCD SSBs (e.g., 812 in FIG. 8) (e.g., one or more) in an additional set of NCD SSBs (e.g., 610 in FIG. 6; 908 in FIG. 9). In some aspects, to receive the NCD SSB configuration 506 (e.g., 614 in FIG. 6), the UE 502 may be configured to receive, and the base station 504 may be configured to transmit/provide/configure, an adjustment (e.g., 624 in FIG. 6) associated with the NCD SSB configuration 506 (e.g., 614 in FIG. 6). The adjustment (e.g., 624 in FIG. 6) may comprise/include at least one of a MAC-CE or DCI. The adjustment (e.g., 624 in FIG. 6) via MAC-CE/DCI may include a set of bits indicative of at least one of (i) an additional NCD SSB (e.g., 916 in FIG. 9) for addition (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) or (ii) a current NCD SSB for removal (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10). As one example, and as noted above, the UE 502 may be configured to initiate BFDs (e.g., 712, 720 in FIG. 7; 818 in FIG. 8; 918 in FIG. 9) for NCD SSBs that fail to meet (e.g., 814 in FIG. 8; 907 in FIG. 9) a signal quality threshold (e.g., 622 in FIG. 6; at 708 in FIG. 7; at 808 in FIG. 8; at 910 in FIG. 9), and such NCD SSBs may be removed (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). Likewise, the UE 502 may be configured to initiate BFRs (e.g., 712, 726 in FIG. 7; 810, 820 in FIG. 8; 914, 920 in FIG. 9) for NCD SSBs and/or CD SSBs (e.g., 714 in FIG. 7) that meet (e.g., 622 in FIG. 6) a signal quality threshold (e.g., 622 in FIG. 6; at 708 in FIG. 7; at 808 in FIG. 8; at 910 in FIG. 9), and such NCD SSBs/CD SSBs may be added (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). For instance, to receive the adjustment (e.g., 624 in FIG. 6) associated with the NCD SSB configuration 506 (e.g., 614 in FIG. 6), the UE 502 may be configured to transmit/provide, and the base station 504 may be configured to receive, an indication of SSBs in at least one of the set of NCD SSBs 508 (e.g., 606 in FIG. 6; 706 in FIG. 7; 806 in FIG. 8; 906 in FIG. 9; 1006 in FIG. 10) or the set of CD SSBs (e.g., 724 in FIG. 7; 816 in FIG. 8; 908 in FIG. 9; 1012 in FIG. 10) that meets (e.g., 622 in FIG. 6) the signal quality threshold (e.g., 622 in FIG. 6; at 708 in FIG. 7; at 808 in FIG. 8; at 910 in FIG. 9). In such aspects, the adjustment (e.g., 624 in FIG. 6) may thus be based on the indication. In some aspects, the NCD SSB configuration 506 (e.g., 614 in FIG. 6) may include a third indication of an L1 measurement gap (e.g., 626 in FIG. 6; 1014 in FIG. 10) associated with SSB measurements of the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive, and the base station 504 may be configured to transmit/provide/configure in accordance with the set of NCD SSBs 508 (e.g., 606 in FIG. 6; 706 in FIG. 7; 806 in FIG. 8; 906 in FIG. 9; 1006 in FIG. 10) having fewer SSBs than the set of CD SSBs (e.g., 724 in FIG. 7; 816 in FIG. 8; 908 in FIG. 9; 1012 in FIG. 10), a dynamic activation (e.g., 628, 630 in FIG. 6; 1007 in FIG. 10) for the L1 measurement gap (e.g., 626 in FIG. 6; 1014 in FIG. 10). The dynamic activation (e.g., 628, 630 in FIG. 6; 1007 in FIG. 10) for the L1 measurement gap (e.g., 626 in FIG. 6; 1014 in FIG. 10) may comprise include at least one of a MAC-CE or DCI that includes a fourth indication of a gap periodicity (e.g., 626 in FIG. 6; 1018 in FIG. 10) associated with an obtainment (e.g., at 710 in FIG. 7; at 912 in FIG. 9; at 1008 in FIG. 10) of additional measurement information (e.g., 1009 in FIG. 10) associated with the set of CD SSBs (e.g., 724 in FIG. 7; 816 in FIG. 8; 908 in FIG. 9; 1012 in FIG. 10). In aspects, the gap periodicity (e.g., 626 in FIG. 6; 1018 in FIG. 10) may be longer than the periodicity (e.g., 608 in FIG. 6; 716 in FIG. 7; 822 in FIG. 8; 922 in FIG. 9; 1016 in FIG. 10) of the set of NCD SSBs (e.g., the NCD SSB periodicity (e.g., 608 in FIG. 6; 716 in FIG. 7; 822 in FIG. 8; 922 in FIG. 9; 1016 in FIG. 10) to be smaller than, or relatively small compared to, CD SSB periods (e.g., 718 in FIG. 7) and/or non-serving NCD SSB periods (e.g., 612 in FIG. 6; 924 in FIG. 9) for measurement gaps (e.g., 626 in FIG. 6; 1014 in FIG. 10), such for maintenance of RLM/BFD (e.g., 712, 720 in FIG. 7; 818 in FIG. 8; 918 in FIG. 9)/L1-RSRP quality. The UE 502, to obtain (at 510) (e.g., at 710 in FIG. 7; at 912 in FIG. 9; at 1008 in FIG. 10) the measurement information 512 (e.g., 711 in FIG. 7; 809 in FIG. 8; 913 in FIG. 9; 1009 in FIG. 10) associated with the set of NCD SSBs (e.g., 606 in FIG. 6; 706 in FIG. 7; 806 in FIG. 8; 906 in FIG. 9; 1006 in FIG. 10), may be configured to obtain (e.g., at 510) (e.g., at 710 in FIG. 7; at 912 in FIG. 9; at 1008 in FIG. 10) the additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10) during the L1 measurement gap (e.g., 626 in FIG. 6; 1014 in FIG. 10) in accordance with the gap periodicity (e.g., 626 in FIG. 6; 1018 in FIG. 10). In aspects, to receive the NCD SSB configuration 506 (e.g., 614 in FIG. 6), the UE 502 may be configured to receive, and the base station 504 may be configured to transmit/provide/configure subsequent to the dynamic activation (e.g., 628, 630 in FIG. 6; 1007 in FIG. 10) for the L1 measurement gap (e.g., 626 in FIG. 6; 1014 in FIG. 10), a dynamic deactivation (e.g., 628, 630 in FIG. 6; 1010, 1011 in FIG. 10) for the L1 measurement gap (e.g., 626 in FIG. 6; 1014 in FIG. 10) in accordance with the set of NCD SSBs 508 (e.g., 606 in FIG. 6; 706 in FIG. 7; 806 in FIG. 8; 906 in FIG. 9; 1006 in FIG. 10) having a same number of SSBs as the set of CD SSBs (e.g., or more SSBs) (e.g., 724 in FIG. 7; 816 in FIG. 8; 908 in FIG. 9; 1012 in FIG. 10). The dynamic deactivation (e.g., 628, 630 in FIG. 6; 1010, 1011 in FIG. 10) for the L1 measurement gap (e.g., 626 in FIG. 6; 1014 in FIG. 10) may comprise/include at least one of the MAC-CE or the DCI, in aspects. In some aspects, the UE 502 may be configured to autonomously and dynamically deactivate (e.g., 630 in FIG. 6; 1011 in FIG. 10) the L1 measurement gap via a dynamic deactivation (e.g., 626 in FIG. 6; 1014 in FIG. 10) in accordance with the set of NCD SSBs (e.g., 606 in FIG. 6; 706 in FIG. 7; 806 in FIG. 8; 906 in FIG. 9; 1006 in FIG. 10) having a same number (or greater number) of SSBs as the set of CD SSBs (e.g., 724 in FIG. 7; 816 in FIG. 8; 908 in FIG. 9; 1012 in FIG. 10).

At 1204, the UE receives, from the network node, a set of NCD SSBs, where the set of NCD SSBs is a subset of a set of CD SSBs outside an active BWP of the UE. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such a set of NCD SSBs from a network node (e.g., the base station 504).

In aspects, the UE 502 may be configured to receive, and the base station 504 may be configured to transmit/provide, the set of NCD SSBs 508 (e.g., 606 in FIG. 6; 706 in FIG. 7; 806 in FIG. 8; 906 in FIG. 9; 1006 in FIG. 10). In aspects, the set of NCD SSBs 508 (e.g., 606 in FIG. 6; 706 in FIG. 7; 806 in FIG. 8; 906 in FIG. 9; 1006 in FIG. 10) may be a subset of a set of CD SSBs (e.g., 724 in FIG. 7; 816 in FIG. 8; 908 in FIG. 9; 1012 in FIG. 10) outside an active BWP of the UE 502 (e.g., as shown for the set of CD SSBs 406 in FIG. 4). As described herein, a set of CD SSBs (e.g., 724 in FIG. 7; 816 in FIG. 8; 908 in FIG. 9; 1012 in FIG. 10) may be actually transmitted by a network node (e.g., the base station 504) and may be received by a UE (e.g., the UE 502). To transmit the set of NCD SSBs, the UE 502 may be configured to receive, and the base station 504 may be configured to transmit/provide, the set of CD SSBs (e.g., 724 in FIG. 7; 816 in FIG. 8; 908 in FIG. 9; 1012 in FIG. 10) outside the active BWP of the UE 502. In aspects, to receive the set of NCD SSBs 508 (e.g., 606 in FIG. 6; 706 in FIG. 7; 806 in FIG. 8; 906 in FIG. 9; 1006 in FIG. 10), the UE 502 may be configured to receive, and the base station 504 may be configured to transmit/provide, an additional set of NCD SSBs (e.g., 610 in FIG. 6; 908 in FIG. 9) in accordance with an additional periodicity (e.g., 612 in FIG. 6; 924 in FIG. 9) that is longer than a periodicity (e.g., 608 in FIG. 6; 716 in FIG. 7; 822 in FIG. 8; 922 in FIG. 9; 1016 in FIG. 10) of the set of NCD SSBs 508 (e.g., 606 in FIG. 6; 706 in FIG. 7; 806 in FIG. 8; 906 in FIG. 9; 1006 in FIG. 10). The additional set of NCD SSBs (e.g., 610 in FIG. 6; 908 in FIG. 9) may be exclusive of the set of NCD SSBs 508 (e.g., 606 in FIG. 6; 706 in FIG. 7; 806 in FIG. 8; 906 in FIG. 9; 1006 in FIG. 10), as described herein. In some aspects, a number of first NCD SSBs in the set of NCD SSBs 508 (e.g., 606 in FIG. 6; 706 in FIG. 7; 806 in FIG. 8; 906 in FIG. 9; 1006 in FIG. 10) may be less than an additional number of second NCD SSBs (e.g., 812 in FIG. 8) in the additional set of NCD SSBs (e.g., 610 in FIG. 6; 908 in FIG. 9). In some aspects, the number of first NCD SSBs in the set of NCD SSBs 508 (e.g., 606 in FIG. 6; 706 in FIG. 7; 806 in FIG. 8; 906 in FIG. 9; 1006 in FIG. 10) and the additional number of second NCD SSBs (e.g., 812 in FIG. 8) in the additional set of NCD SSBs (e.g., 610 in FIG. 6; 908 in FIG. 9) may equal a total number of CD SSBs in the set CD SSBs (e.g., 724 in FIG. 7; 816 in FIG. 8; 908 in FIG. 9; 1012 in FIG. 10).

At 1206, the UE obtains measurement information associated with the set of NCD SSBs. As an example, the obtainment may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such measurement information associated with the set of NCD SSBs.

In aspects, the UE 502 may be configured to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In aspects, the UE 502 may be configured to measure signal quality indicators (e.g., RSRP, RSRQ, SNR, SINR, and/or another reference signal characteristic, RRM measurements, L3 cell level measurements, or other measurements described herein) of one or more SSBs of the set of NCD SSBs 508 (e.g., 606 in FIG. 6; 706 in FIG. 7; 806 in FIG. 8; 906 in FIG. 9; 1006 in FIG. 10) to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10). The UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that meets (e.g., 622 in FIG. 6) (or not) a signal quality threshold (e.g., 622 in FIG. 6; at 708 in FIG. 7; at 808 in FIG. 8; at 910 in FIG. 9) (e.g., below 10% block error rate (BLER), or the like).

At 1208, the flowchart 1200 may continue based on determinations associated with measurement information (MO). When a determination based on measurement information indicates that a first NCD SSB, as a serving SSB, of a set of NCD SSBs fails to meet a signal quality threshold and a second NCD SSB of the set is available, the flowchart 1200 may continue to 1210. When a determination based on measurement information indicates that each NCD SSB of a set of NCD SSBs fails to meet a signal quality threshold, the flowchart 1200 may continue to 1214. When a determination based on measurement information indicates that a NCD SSB(s) of a set of NCD SSBs fails to meet a signal quality threshold, the flowchart 1200 may continue to 1220.

At 1210, the UE determines, based on the measurement information, that a first NCD SSB of the set of NCD SSBs, as a serving SSB of the UE, is associated with a signal quality that fails to meet a signal quality threshold and that a second NCD SSB of the set of NCD SSBs meets the signal quality threshold. As an example, the determination may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 determining such a serving NCD SSB failure.

In some aspects, the UE 502 may be configured to determine, based on the measurement information 512 (e.g., 711 in FIG. 7; 809 in FIG. 8; 913 in FIG. 9; 1009 in FIG. 10), that a first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) (e.g., below 10% BLER, or the like) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). In aspects, such a determination may be performed in association with the non-initial/active BWP of the UE 502. The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for a first NCD SSB of the set of NCD SSBs 508 (e.g., 606 in FIG. 6; 706 in FIG. 7; 806 in FIG. 8; 906 in FIG. 9; 1006 in FIG. 10). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of a determination that the first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9).

At 1212, the UE receives, from the network node and subsequent to a beam failure recovery, the second NCD SSB as the serving SSB. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such a second NCD SSB as the serving SSB from a network node (e.g., the base station 504).

The UE 502 may be configured to subsequently initiate a BFR (e.g., 712, 726 in FIG. 7; 810, 820 in FIG. 8; 914, 920 in FIG. 9) for the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10), and thus be configured to receive, and the base station 504 may be configured to transmit/provide, subsequent to the BFR (e.g., 712, 726 in FIG. 7; 810, 820 in FIG. 8; 914, 920 in FIG. 9), the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) as the serving SSB. In such aspects, the set of NCD SSBs (e.g., 606 in FIG. 6; 706 in FIG. 7; 806 in FIG. 8; 906 in FIG. 9; 1006 in FIG. 10) may include the second NCD SSB (e.g., 812 in FIG. 8). In some aspects, the set of NCD SSBs (e.g., 606 in FIG. 6; 706 in FIG. 7; 806 in FIG. 8; 906 in FIG. 9; 1006 in FIG. 10) may comprise an NCD SSB burst set in which given NCD SSBs are ordered/positioned. The NCD SSB configuration 506 (e.g., 614 in FIG. 6) may include at least one burst position IE (e.g., 620 in FIG. 6) indicative of the first NCD SSBs in the set of NCD SSBs 508 (e.g., 606 in FIG. 6; 706 in FIG. 7; 806 in FIG. 8; 906 in FIG. 9; 1006 in FIG. 10) for such an NCD SSB burst set. In some aspects, the at least one burst position IE (e.g., 620 in FIG. 6) may include a burst position IE (e.g., 620 in FIG. 6) for each of the first NCD SSBs in the set of NCD SSBs 508 (e.g., 606 in FIG. 6; 706 in FIG. 7; 806 in FIG. 8; 906 in FIG. 9; 1006 in FIG. 10) and/or for each of the second NCD SSBs (e.g., 812 in FIG. 8) in the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive the NCD SSB configuration 506 (e.g., 614 in FIG. 6) via RRC signaling.

At 1214, the UE determines, based on the measurement information, that each NCD SSB of the set of NCD SSBs is associated with a signal quality that fails to meet a signal quality threshold. As an example, the determination may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 determining such a failure for each NCD SSB.

In some aspects, the UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) (e.g., below 10% BLER of a hypothetical PDCCH, or the like).

At 1216, the UE obtains measurement information associated with an NCD SSB of the additional set of NCD SSBs. As an example, the obtainment may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such measurement information associated with the additional set of NCD SSBs.

In some aspects, the UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) (e.g., below 10% BLER of a hypothetical PDCCH, or the like). The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9), e.g., based on the determined signal quality threshold (e.g., 622 in FIG. 6; at 708 in FIG. 7; at 808 in FIG. 8; at 910 in FIG. 9) failure (e.g., 814 in FIG. 8; 907 in FIG. 9). The UE 502 may be configured to determine that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9), and to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the NCD SSB of the additional set of NCD SSBs (e.g., 610 in FIG. 6; 908 in FIG. 9). The UE 502 may be configured to transmit/provide, and the base station 504 may be configured to receive, the measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) first measurement information for a determination that each NCD SSB of the set of NCD SSBs 508 (e.g., 606 in FIG. 6; 706 in FIG. 7; 806 in FIG. 8; 906 in FIG. 9; 1006 in FIG. 10) is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9). The UE 502 may be configured to transmit/provide, and the base station 504 may be configured to receive, a beam failure recovery (e.g., 712, 726 in FIG. 7; 810, 820 in FIG. 8; 914, 920 in FIG. 9) signal to the network based on the additional measurement information (e.g., 711 in FIG. 7; 913 in FIG. 9; 1009 in FIG. 10) associated with the CD SSB (e.g., 714 in FIG. 7). The UE 502 may be configured to receive, and the base station 504 may be configured to transmit/provide, subsequent to a beam failure recovery (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs (e.g., 606 in FIG. 6; 706 in FIG. 7; 806 in FIG. 8; 906 in FIG. 9; 1006 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9).

At 1218, the UE receives, from the network node and subsequent to (i) a determination that the NCD SSB of the additional set of NCD SSBs meets the signal quality threshold and (ii) a beam failure recovery, the NCD SSB of the additional set of NCD SSBs as a serving SSB. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such an NCD SSB of the additional set of NCD SSBs as a serving SSB from a network node (e.g., the base station 504).

Thus, the UE 502 may be configured to receive, and the base station 504 may be configured to transmit/provide, subsequent to (i) a determination that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9) and (ii) a BFR (e.g., 712, 726 in FIG. 7; 810, 820 in FIG. 8; 914, 920 in FIG. 9), the NCD SSB of the additional set of NCD SSBs (e.g., 610 in FIG. 6; 908 in FIG. 9) as a serving SSB, e.g., now as part of the set of NCD SSBs 508 (e.g., 606 in FIG. 6; 706 in FIG. 7; 806 in FIG. 8; 906 in FIG. 9; 1006 in FIG. 10) after being adjusted therefor.

At 1220, the UE switches to an initial BWP of the UE based on a determination associated with the measurement information that at least one NCD SSB in the set of NCD SSBs is associated with a respective signal quality that fails to meet a signal quality threshold. As an example, the switch may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 switching to such initial BWP.

In some aspects, the UE 502 may be configured to switch (e.g., at 708, 722 in FIG. 7) to an initial BWP (e.g., non-default/non-active BWP for the CD SSBs (e.g., 714, 724 in FIG. 7; 816 in FIG. 8; 908 in FIG. 9; 1012 in FIG. 10)) of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). For instance, the UE 502 may be configured to determine, based on the measurement information 512 (e.g., 711 in FIG. 7; 809 in FIG. 8; 913 in FIG. 9; 1009 in FIG. 10), that an NCD SSB(s) of the set of NCD SSBs 508 (e.g., 606 in FIG. 6; 706 in FIG. 7; 806 in FIG. 8; 906 in FIG. 9; 1006 in FIG. 10) fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). Accordingly, the UE 502 may be configured to switch (e.g., at 708, 722 in FIG. 7) to the initial BWP.

At 1222, the UE obtains additional measurement information associated with a CD SSB of the set of CD SSBs and/or transmits a beam failure recovery signal to the network based on the additional measurement information associated with the CD SSB. As an example, the obtainment/transmission may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such additional measurement information associated with a CD SSB and/or transmitting such beam failure recovery signal to a network node (e.g., the base station 504).

The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10), e.g., based on the switch (e.g., at 708, 722 in FIG. 7) to the initial BWP associated with the set of CD SSBs (e.g., 724 in FIG. 7; 816 in FIG. 8; 908 in FIG. 9; 1012 in FIG. 10). A transmission of a given CD SSB (e.g., 714 in FIG. 7) and/or of the set of CD SSBs (e.g., 724 in FIG. 7; 816 in FIG. 8; 908 in FIG. 9; 1012 in FIG. 10) may occur outside the active BWP of the UE 502. The UE 502 may be configured to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the CD SSB (e.g., 714 in FIG. 7) of the set of CD SSBs (e.g., 724 in FIG. 7; 816 in FIG. 8; 908 in FIG. 9; 1012 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9).

At 1224, the UE receives, from the network node and subsequent to a beam failure recovery, the CD SSB as a serving SSB and as part of the set of NCD SSBs based on an associated signal quality meeting the signal quality threshold. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such a CD SSB as a serving SSB from a network node (e.g., the base station 504).

Thus, the UE 502 may be configured to receive, and the base station 504 may be configured to transmit/provide, subsequent to a BFR (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs 508 (e.g., 606 in FIG. 6; 706 in FIG. 7; 806 in FIG. 8; 906 in FIG. 9; 1006 in FIG. 10) after being adjusted therefor. In aspects, a first time taken for the beam failure recovery (e.g., 712, 726 in FIG. 7; 810, 820 in FIG. 8; 914, 920 in FIG. 9) may be associated with a second time taken for the switch (e.g., at 708, 722 in FIG. 7) to the initial BWP.

At 1226, the UE transmits, for at least one network node, the measurement information associated with the set of NCD SSBs. As an example, the transmission may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 transmitting such measurement information for a network node (e.g., the base station 504).

The UE 502 may be configured to transmit/provide, and at least one network node (e.g., the base station 504) may be configured to receive, the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In some aspects, the base station 504 may be configured to utilize the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10) to adjust (e.g., 624 in FIG. 6) the set of NCD SSBs 508 (e.g., 606 in FIG. 6; 706 in FIG. 7; 806 in FIG. 8; 906 in FIG. 9; 1006 in FIG. 10) and/or to perform other UE/cell management functions, as described herein.

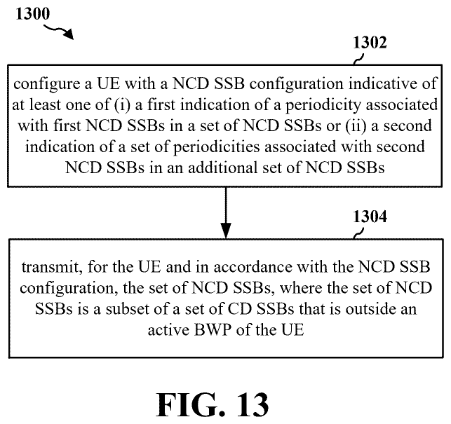

FIG. 13 is a flowchart 1300 of a method of wireless communication. The method may be performed by a base station (e.g., the base station 102, 504, 604, 704, 804, 904, 1004; the network entity 1502, 1602). The method may be for NES for reduced capability and enhanced reduced capability UEs. The method may enable a reduced capability UE to receive NCD SSBs having different indices at different periodicities, to utilize BFD/BFR for NES in reduced capability cells to indicate SSB beams having improved/sufficient signal quality, and to be configured by a network for L1 measurements outside of an active BW using a measurement gap.

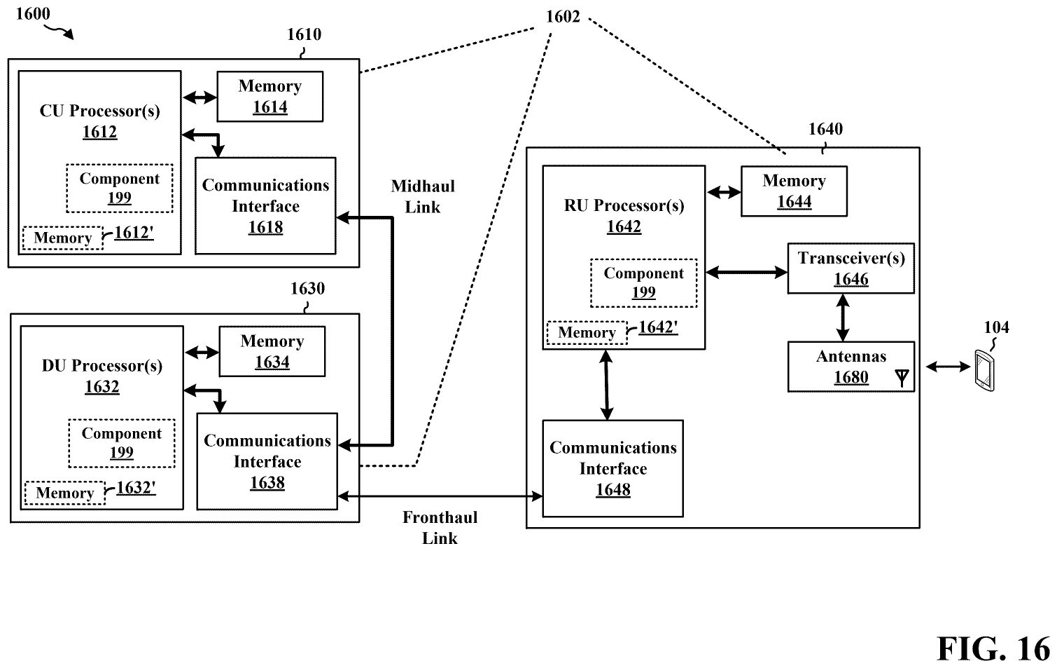

At 1302, the network node configures a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. As an example, the configuration may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) configuring a UE (e.g., the UE 502) with such a NCD SSB configuration.

The UE 502 may be configured to receive, and the base station 504 may be configured to transmit/provide/configure, an NCD SSB configuration 506 (e.g., 614 in FIG. 6). In aspects, the NCD SSB configuration 506 (e.g., 614 in FIG. 6) may be indicative of at least one of (i) a first indication (e.g., 616 in FIG. 6) of a periodicity (e.g., 608 in FIG. 6; 716 in FIG. 7; 822 in FIG. 8; 922 in FIG. 9; 1016 in FIG. 10) associated with first NCD SSBs (e.g., one or more) in a set of NCD SSBs 508 (e.g., 606 in FIG. 6; 706 in FIG. 7; 806 in FIG. 8; 906 in FIG. 9; 1006 in FIG. 10) or (ii) a second indication (e.g., 618 in FIG. 6) of a set of periodicities (e.g., 612 in FIG. 6; 924 in FIG. 9) associated with second NCD SSBs (e.g., 812 in FIG. 8) (e.g., one or more) in an additional set of NCD SSBs (e.g., 610 in FIG. 6; 908 in FIG. 9). In some aspects, to receive the NCD SSB configuration 506 (e.g., 614 in FIG. 6), the UE 502 may be configured to receive, and the base station 504 may be configured to transmit/provide/configure, an adjustment (e.g., 624 in FIG. 6) associated with the NCD SSB configuration 506 (e.g., 614 in FIG. 6). The adjustment (e.g., 624 in FIG. 6) may comprise/include at least one of a MAC-CE or DCI. The adjustment (e.g., 624 in FIG. 6) via MAC-CE/DCI may include a set of bits indicative of at least one of (i) an additional NCD SSB (e.g., 916 in FIG. 9) for addition (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) or (ii) a current NCD SSB for removal (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10). As one example, and as noted above, the UE 502 may be configured to initiate BFDs (e.g., 712, 720 in FIG. 7; 818 in FIG. 8; 918 in FIG. 9) for NCD SSBs that fail to meet (e.g., 814 in FIG. 8; 907 in FIG. 9) a signal quality threshold (e.g., 622 in FIG. 6; at 708 in FIG. 7; at 808 in FIG. 8; at 910 in FIG. 9), and such NCD SSBs may be removed (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). Likewise, the UE 502 may be configured to initiate BFRs (e.g., 712, 726 in FIG. 7; 810, 820 in FIG. 8; 914, 920 in FIG. 9) for NCD SSBs and/or CD SSBs (e.g., 714 in FIG. 7) that meet (e.g., 622 in FIG. 6) a signal quality threshold (e.g., 622 in FIG. 6; at 708 in FIG. 7; at 808 in FIG. 8; at 910 in FIG. 9), and such NCD SSBs/CD SSBs may be added (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). For instance, to receive the adjustment (e.g., 624 in FIG. 6) associated with the NCD SSB configuration 506 (e.g., 614 in FIG. 6), the UE 502 may be configured to transmit/provide, and the base station 504 may be configured to receive, an indication of SSBs in at least one of the set of NCD SSBs 508 (e.g., 606 in FIG. 6; 706 in FIG. 7; 806 in FIG. 8; 906 in FIG. 9; 1006 in FIG. 10) or the set of CD SSBs (e.g., 724 in FIG. 7; 816 in FIG. 8; 908 in FIG. 9; 1012 in FIG. 10) that meets (e.g., 622 in FIG. 6) the signal quality threshold (e.g., 622 in FIG. 6; at 708 in FIG. 7; at 808 in FIG. 8; at 910 in FIG. 9). In such aspects, the adjustment (e.g., 624 in FIG. 6) may thus be based on the indication. In some aspects, the NCD SSB configuration 506 (e.g., 614 in FIG. 6) may include a third indication of an L1 measurement gap (e.g., 626 in FIG. 6; 1014 in FIG. 10) associated with SSB measurements of the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive, and the base station 504 may be configured to transmit/provide/configure in accordance with the set of NCD SSBs 508 (e.g., 606 in FIG. 6; 706 in FIG. 7; 806 in FIG. 8; 906 in FIG. 9; 1006 in FIG. 10) having fewer SSBs than the set of CD SSBs (e.g., 724 in FIG. 7; 816 in FIG. 8; 908 in FIG. 9; 1012 in FIG. 10), a dynamic activation (e.g., 628, 630 in FIG. 6; 1007 in FIG. 10) for the L1 measurement gap (e.g., 626 in FIG. 6; 1014 in FIG. 10). The dynamic activation (e.g., 628, 630 in FIG. 6; 1007 in FIG. 10) for the L1 measurement gap (e.g., 626 in FIG. 6; 1014 in FIG. 10) may comprise include at least one of a MAC-CE or DCI that includes a fourth indication of a gap periodicity (e.g., 626 in FIG. 6; 1018 in FIG. 10) associated with an obtainment (e.g., at 710 in FIG. 7; at 912 in FIG. 9; at 1008 in FIG. 10) of additional measurement information (e.g., 1009 in FIG. 10) associated with the set of CD SSBs (e.g., 724 in FIG. 7; 816 in FIG. 8; 908 in FIG. 9; 1012 in FIG. 10). In aspects, the gap periodicity (e.g., 626 in FIG. 6; 1018 in FIG. 10) may be longer than the periodicity (e.g., 608 in FIG. 6; 716 in FIG. 7; 822 in FIG. 8; 922 in FIG. 9; 1016 in FIG. 10) of the set of NCD SSBs (e.g., the NCD SSB periodicity (e.g., 608 in FIG. 6; 716 in FIG. 7; 822 in FIG. 8; 922 in FIG. 9; 1016 in FIG. 10) to be smaller than, or relatively small compared to, CD SSB periods (e.g., 718 in FIG. 7) and/or non-serving NCD SSB periods (e.g., 612 in FIG. 6; 924 in FIG. 9) for measurement gaps (e.g., 626 in FIG. 6; 1014 in FIG. 10), such for maintenance of RLM/BFD (e.g., 712, 720 in FIG. 7; 818 in FIG. 8; 918 in FIG. 9)/L1-RSRP quality. The UE 502, to obtain (at 510) (e.g., at 710 in FIG. 7; at 912 in FIG. 9; at 1008 in FIG. 10) the measurement information 512 (e.g., 711 in FIG. 7; 809 in FIG. 8; 913 in FIG. 9; 1009 in FIG. 10) associated with the set of NCD SSBs (e.g., 606 in FIG. 6; 706 in FIG. 7; 806 in FIG. 8; 906 in FIG. 9; 1006 in FIG. 10), may be configured to obtain (e.g., at 510) (e.g., at 710 in FIG. 7; at 912 in FIG. 9; at 1008 in FIG. 10) the additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10) during the L1 measurement gap (e.g., 626 in FIG. 6; 1014 in FIG. 10) in accordance with the gap periodicity (e.g., 626 in FIG. 6; 1018 in FIG. 10). In aspects, to receive the NCD SSB configuration 506 (e.g., 614 in FIG. 6), the UE 502 may be configured to receive, and the base station 504 may be configured to transmit/provide/configure subsequent to the dynamic activation (e.g., 628, 630 in FIG. 6; 1007 in FIG. 10) for the L1 measurement gap (e.g., 626 in FIG. 6; 1014 in FIG. 10), a dynamic deactivation (e.g., 628, 630 in FIG. 6; 1010, 1011 in FIG. 10) for the L1 measurement gap (e.g., 626 in FIG. 6; 1014 in FIG. 10) in accordance with the set of NCD SSBs 508 (e.g., 606 in FIG. 6; 706 in FIG. 7; 806 in FIG. 8; 906 in FIG. 9; 1006 in FIG. 10) having a same number of SSBs as the set of CD SSBs (e.g., or more SSBs) (e.g., 724 in FIG. 7; 816 in FIG. 8; 908 in FIG. 9; 1012 in FIG. 10). The dynamic deactivation (e.g., 628, 630 in FIG. 6; 1010, 1011 in FIG. 10) for the L1 measurement gap (e.g., 626 in FIG. 6; 1014 in FIG. 10) may comprise/include at least one of the MAC-CE or the DCI, in aspects. In some aspects, the UE 502 may be configured to autonomously and dynamically deactivate (e.g., 630 in FIG. 6; 1011 in FIG. 10) the L1 measurement gap via a dynamic deactivation (e.g., 626 in FIG. 6; 1014 in FIG. 10) in accordance with the set of NCD SSBs (e.g., 606 in FIG. 6; 706 in FIG. 7; 806 in FIG. 8; 906 in FIG. 9; 1006 in FIG. 10) having a same number (or greater number) of SSBs as the set of CD SSBs (e.g., 724 in FIG. 7; 816 in FIG. 8; 908 in FIG. 9; 1012 in FIG. 10). The UE 502 may be configured to transmit/provide, and at least one network node (e.g., the base station 504) may be configured to receive, the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In some aspects, the base station 504 may be configured to utilize the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10) to adjust (e.g., 624 in FIG. 6) the set of NCD SSBs 508 (e.g., 606 in FIG. 6; 706 in FIG. 7; 806 in FIG. 8; 906 in FIG. 9; 1006 in FIG. 10) and/or to perform other UE/cell management functions, as described herein.

At 1304, the network node transmits, for the UE and in accordance with the NCD SSB configuration, the set of NCD SSBs, where the set of NCD SSBs is a subset of a set of CD SSBs that is outside an active BWP of the UE. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a set of NCD SSBs to a UE (e.g., the UE 502).

In aspects, the UE 502 may be configured to receive, and the base station 504 may be configured to transmit/provide, the set of NCD SSBs 508 (e.g., 606 in FIG. 6; 706 in FIG. 7; 806 in FIG. 8; 906 in FIG. 9; 1006 in FIG. 10). In aspects, the set of NCD SSBs 508 (e.g., 606 in FIG. 6; 706 in FIG. 7; 806 in FIG. 8; 906 in FIG. 9; 1006 in FIG. 10) may be a subset of a set of CD SSBs (e.g., 724 in FIG. 7; 816 in FIG. 8; 908 in FIG. 9; 1012 in FIG. 10) outside an active BWP of the UE 502 (e.g., as shown for the set of CD SSBs 406 in FIG. 4). As described herein, a set of CD SSBs (e.g., 724 in FIG. 7; 816 in FIG. 8; 908 in FIG. 9; 1012 in FIG. 10) may be actually transmitted by a network node (e.g., the base station 504) and may be received by a UE (e.g., the UE 502). To transmit the set of NCD SSBs, the UE 502 may be configured to receive, and the base station 504 may be configured to transmit/provide, the set of CD SSBs (e.g., 724 in FIG. 7; 816 in FIG. 8; 908 in FIG. 9; 1012 in FIG. 10) outside the active BWP of the UE 502. In aspects, to receive the set of NCD SSBs 508 (e.g., 606 in FIG. 6; 706 in FIG. 7; 806 in FIG. 8; 906 in FIG. 9; 1006 in FIG. 10), the UE 502 may be configured to receive, and the base station 504 may be configured to transmit/provide, an additional set of NCD SSBs (e.g., 610 in FIG. 6; 908 in FIG. 9) in accordance with an additional periodicity (e.g., 612 in FIG. 6; 924 in FIG. 9) that is longer than a periodicity (e.g., 608 in FIG. 6; 716 in FIG. 7; 822 in FIG. 8; 922 in FIG. 9; 1016 in FIG. 10) of the set of NCD SSBs 508 (e.g., 606 in FIG. 6; 706 in FIG. 7; 806 in FIG. 8; 906 in FIG. 9; 1006 in FIG. 10). The additional set of NCD SSBs (e.g., 610 in FIG. 6; 908 in FIG. 9) may be exclusive of the set of NCD SSBs 508 (e.g., 606 in FIG. 6; 706 in FIG. 7; 806 in FIG. 8; 906 in FIG. 9; 1006 in FIG. 10), as described herein. In some aspects, a number of first NCD SSBs in the set of NCD SSBs 508 (e.g., 606 in FIG. 6; 706 in FIG. 7; 806 in FIG. 8; 906 in FIG. 9; 1006 in FIG. 10) may be less than an additional number of second NCD SSBs (e.g., 812 in FIG. 8) in the additional set of NCD SSBs (e.g., 610 in FIG. 6; 908 in FIG. 9). In some aspects, the number of first NCD SSBs in the set of NCD SSBs 508 (e.g., 606 in FIG. 6; 706 in FIG. 7; 806 in FIG. 8; 906 in FIG. 9; 1006 in FIG. 10) and the additional number of second NCD SSBs (e.g., 812 in FIG. 8) in the additional set of NCD SSBs (e.g., 610 in FIG. 6; 908 in FIG. 9) may equal a total number of CD SSBs in the set CD SSBs (e.g., 724 in FIG. 7; 816 in FIG. 8; 908 in FIG. 9; 1012 in FIG. 10).

At 1104, the UE obtains measurement information associated with the set of NCD SSBs. As an example, the obtainment may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such measurement information associated with the set of NCD SSBs.

In aspects, the UE 502 may be configured to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In aspects, the UE 502 may be configured to measure signal quality indicators (e.g., RSRP, RSRQ, SNR, SINR, and/or another reference signal characteristic, RRM measurements, L3 cell level measurements, or other measurements described herein) of one or more SSBs of the set of NCD SSBs 508 (e.g., 606 in FIG. 6; 706 in FIG. 7; 806 in FIG. 8; 906 in FIG. 9; 1006 in FIG. 10) to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10). The UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that meets (e.g., 622 in FIG. 6) (or not) a signal quality threshold (e.g., 622 in FIG. 6; at 708 in FIG. 7; at 808 in FIG. 8; at 910 in FIG. 9) (e.g., below 10% block error rate (BLER), or the like).

In some aspects, the UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) (e.g., below 10% BLER of a hypothetical PDCCH, or the like). The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9), e.g., based on the determined signal quality threshold (e.g., 622 in FIG. 6; at 708 in FIG. 7; at 808 in FIG. 8; at 910 in FIG. 9) failure (e.g., 814 in FIG. 8; 907 in FIG. 9). The UE 502 may be configured to determine that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9), and to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the NCD SSB of the additional set of NCD SSBs (e.g., 610 in FIG. 6; 908 in FIG. 9). The UE 502 may be configured to transmit/provide, and the base station 504 may be configured to receive, the measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) first measurement information for a determination that each NCD SSB of the set of NCD SSBs 508 (e.g., 606 in FIG. 6; 706 in FIG. 7; 806 in FIG. 8; 906 in FIG. 9; 1006 in FIG. 10) is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9). The UE 502 may be configured to transmit/provide, and the base station 504 may be configured to receive, a beam failure recovery (e.g., 712, 726 in FIG. 7; 810, 820 in FIG. 8; 914, 920 in FIG. 9) signal to the network based on the additional measurement information (e.g., 711 in FIG. 7; 913 in FIG. 9; 1009 in FIG. 10) associated with the CD SSB (e.g., 714 in FIG. 7). The UE 502 may be configured to receive, and the base station 504 may be configured to transmit/provide, subsequent to a beam failure recovery (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs (e.g., 606 in FIG. 6; 706 in FIG. 7; 806 in FIG. 8; 906 in FIG. 9; 1006 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9). Thus, the UE 502 may be configured to receive, and the base station 504 may be configured to transmit/provide, subsequent to (i) a determination that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9) and (ii) a BFR (e.g., 712, 726 in FIG. 7; 810, 820 in FIG. 8; 914, 920 in FIG. 9), the NCD SSB of the additional set of NCD SSBs (e.g., 610 in FIG. 6; 908 in FIG. 9) as a serving SSB, e.g., now as part of the set of NCD SSBs 508 (e.g., 606 in FIG. 6; 706 in FIG. 7; 806 in FIG. 8; 906 in FIG. 9; 1006 in FIG. 10) after being adjusted therefor.

In some aspects, the UE 502 may be configured to switch (e.g., at 708, 722 in FIG. 7) to an initial BWP (e.g., non-default/non-active BWP for the CD SSBs (e.g., 714, 724 in FIG. 7; 816 in FIG. 8; 908 in FIG. 9; 1012 in FIG. 10)) of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). For instance, the UE 502 may be configured to determine, based on the measurement information 512 (e.g., 711 in FIG. 7; 809 in FIG. 8; 913 in FIG. 9; 1009 in FIG. 10), that an NCD SSB(s) of the set of NCD SSBs 508 (e.g., 606 in FIG. 6; 706 in FIG. 7; 806 in FIG. 8; 906 in FIG. 9; 1006 in FIG. 10) fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). Accordingly, the UE 502 may be configured to switch (e.g., at 708, 722 in FIG. 7) to the initial BWP. The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10), e.g., based on the switch (e.g., at 708, 722 in FIG. 7) to the initial BWP associated with the set of CD SSBs (e.g., 724 in FIG. 7; 816 in FIG. 8; 908 in FIG. 9; 1012 in FIG. 10). A transmission of a given CD SSB (e.g., 714 in FIG. 7) and/or of the set of CD SSBs (e.g., 724 in FIG. 7; 816 in FIG. 8; 908 in FIG. 9; 1012 in FIG. 10) may occur outside the active BWP of the UE 502. The UE 502 may be configured to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the CD SSB (e.g., 714 in FIG. 7) of the set of CD SSBs (e.g., 724 in FIG. 7; 816 in FIG. 8; 908 in FIG. 9; 1012 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9). The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) a switch (e.g., at 708, 722 in FIG. 7) to an initial BWP of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10). In aspects, a first time taken for the beam failure recovery (e.g., 712, 726 in FIG. 7; 810, 820 in FIG. 8; 914, 920 in FIG. 9) may be associated with a second time taken for the switch (e.g., at 708, 722 in FIG. 7) to the initial BWP. Thus, the UE 502 may be configured to receive, and the base station 504 may be configured to transmit/provide, subsequent to a BFR (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs 508 (e.g., 606 in FIG. 6; 706 in FIG. 7; 806 in FIG. 8; 906 in FIG. 9; 1006 in FIG. 10) after being adjusted therefor.

In some aspects, the UE 502 may be configured to determine, based on the measurement information 512 (e.g., 711 in FIG. 7; 809 in FIG. 8; 913 in FIG. 9; 1009 in FIG. 10), that a first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) (e.g., below 10% BLER, or the like) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). In aspects, such a determination may be performed in association with the non-initial/active BWP of the UE 502. The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for a first NCD SSB of the set of NCD SSBs 508 (e.g., 606 in FIG. 6; 706 in FIG. 7; 806 in FIG. 8; 906 in FIG. 9; 1006 in FIG. 10). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of a determination that the first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). The UE 502 may be configured to subsequently initiate a BFR (e.g., 712, 726 in FIG. 7; 810, 820 in FIG. 8; 914, 920 in FIG. 9) for the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10), and thus be configured to receive, and the base station 504 may be configured to transmit/provide, subsequent to the BFR (e.g., 712, 726 in FIG. 7; 810, 820 in FIG. 8; 914, 920 in FIG. 9), the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) as the serving SSB. In such aspects, the set of NCD SSBs (e.g., 606 in FIG. 6; 706 in FIG. 7; 806 in FIG. 8; 906 in FIG. 9; 1006 in FIG. 10) may include the second NCD SSB (e.g., 812 in FIG. 8). In some aspects, the set of NCD SSBs (e.g., 606 in FIG. 6; 706 in FIG. 7; 806 in FIG. 8; 906 in FIG. 9; 1006 in FIG. 10) may comprise an NCD SSB burst set in which given NCD SSBs are ordered/positioned. The NCD SSB configuration 506 (e.g., 614 in FIG. 6) may include at least one burst position IE (e.g., 620 in FIG. 6) indicative of the first NCD SSBs in the set of NCD SSBs 508 (e.g., 606 in FIG. 6; 706 in FIG. 7; 806 in FIG. 8; 906 in FIG. 9; 1006 in FIG. 10) for such an NCD SSB burst set. In some aspects, the at least one burst position IE (e.g., 620 in FIG. 6) may include a burst position IE (e.g., 620 in FIG. 6) for each of the first NCD SSBs in the set of NCD SSBs 508 (e.g., 606 in FIG. 6; 706 in FIG. 7; 806 in FIG. 8; 906 in FIG. 9; 1006 in FIG. 10) and/or for each of the second NCD SSBs (e.g., 812 in FIG. 8) in the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive the NCD SSB configuration 506 (e.g., 614 in FIG. 6) via RRC signaling.

In some aspects, to receive the NCD SSB configuration 506 (e.g., 614 in FIG. 6), the UE 502 may be configured to receive, and the base station 504 may be configured to transmit/provide/configure, an adjustment (e.g., 624 in FIG. 6) associated with the NCD SSB configuration 506 (e.g., 614 in FIG. 6). The adjustment (e.g., 624 in FIG. 6) may comprise/include at least one of a MAC-CE or DCI. The adjustment (e.g., 624 in FIG. 6) via MAC-CE/DCI may include a set of bits indicative of at least one of (i) an additional NCD SSB (e.g., 916 in FIG. 9) for addition (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) or (ii) a current NCD SSB for removal (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10). As one example, and as noted above, the UE 502 may be configured to initiate BFDs (e.g., 712, 720 in FIG. 7; 818 in FIG. 8; 918 in FIG. 9) for NCD SSBs that fail to meet (e.g., 814 in FIG. 8; 907 in FIG. 9) a signal quality threshold (e.g., 622 in FIG. 6; at 708 in FIG. 7; at 808 in FIG. 8; at 910 in FIG. 9), and such NCD SSBs may be removed (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). Likewise, the UE 502 may be configured to initiate BFRs (e.g., 712, 726 in FIG. 7; 810, 820 in FIG. 8; 914, 920 in FIG. 9) for NCD SSBs and/or CD SSBs (e.g., 714 in FIG. 7) that meet (e.g., 622 in FIG. 6) a signal quality threshold (e.g., 622 in FIG. 6; at 708 in FIG. 7; at 808 in FIG. 8; at 910 in FIG. 9), and such NCD SSBs/CD SSBs (e.g., 714 in FIG. 7) may be added (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). For instance, to receive the adjustment (e.g., 624 in FIG. 6) associated with the NCD SSB configuration 506 (e.g., 614 in FIG. 6), the UE 502 may be configured to transmit/provide, and the base station 504 may be configured to receive, an indication of SSBs in at least one of the set of NCD SSBs 508 (e.g., 606 in FIG. 6; 706 in FIG. 7; 806 in FIG. 8; 906 in FIG. 9; 1006 in FIG. 10) or the set of CD SSBs (e.g., 724 in FIG. 7; 816 in FIG. 8; 908 in FIG. 9; 1012 in FIG. 10) that meets (e.g., 622 in FIG. 6) the signal quality threshold (e.g., 622 in FIG. 6; at 708 in FIG. 7; at 808 in FIG. 8; at 910 in FIG. 9). In such aspects, the adjustment (e.g., 624 in FIG. 6) may thus be based on the indication.

In some aspects, the NCD SSB configuration 506 (e.g., 614 in FIG. 6) may include a third indication of an L1 measurement gap (e.g., 626 in FIG. 6; 1014 in FIG. 10) associated with SSB measurements (e.g., at 1008 in FIG. 10) of the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive, and the base station 504 may be configured to transmit/provide/configure in accordance with the set of NCD SSBs 508 (e.g., 606 in FIG. 6; 706 in FIG. 7; 806 in FIG. 8; 906 in FIG. 9; 1006 in FIG. 10) having fewer SSBs than the set of CD SSBs (e.g., 724 in FIG. 7; 816 in FIG. 8; 908 in FIG. 9; 1012 in FIG. 10), a dynamic activation (e.g., 628, 630 in FIG. 6; 1007 in FIG. 10) for the L1 measurement gap (e.g., 626 in FIG. 6; 1014 in FIG. 10). The dynamic activation (e.g., 628, 630 in FIG. 6; 1007 in FIG. 10) for the L1 measurement gap (e.g., 626 in FIG. 6; 1014 in FIG. 10) may comprise include at least one of a MAC-CE or DCI that includes a fourth indication of a gap periodicity (e.g., 626 in FIG. 6; 1018 in FIG. 10) associated with an obtainment (e.g., at 710 in FIG. 7; at 912 in FIG. 9; at 1008 in FIG. 10) of additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10). In aspects, the gap periodicity (e.g., 626 in FIG. 6; 1018 in FIG. 10) may be longer than the periodicity (e.g., 608 in FIG. 6; 716 in FIG. 7; 822 in FIG. 8; 922 in FIG. 9; 1016 in FIG. 10) of the set of NCD SSBs (e.g., 606 in FIG. 6; 706 in FIG. 7; 806 in FIG. 8; 906 in FIG. 9; 1006 in FIG. 10) (e.g., the NCD SSB periodicity (e.g., 608 in FIG. 6; 716 in FIG. 7; 822 in FIG. 8; 922 in FIG. 9; 1016 in FIG. 10) to be smaller than, or relatively small compared to, CD SSB periods (e.g., 718 in FIG. 7) and/or non-serving NCD SSB periods (e.g., 612, 924 in FIG. 9) for measurement gaps (e.g., 1014 in FIG. 10), such for maintenance of RLM/BFD (e.g., 712, 720 in FIG. 7; 818 in FIG. 8; 918 in FIG. 9)/L1-RSRP quality. The UE 502, to obtain (at 510) (e.g., at 710 in FIG. 7; at 912 in FIG. 9; at 1008 in FIG. 10) the measurement information 512 (e.g., 711 in FIG. 7; 809 in FIG. 8; 913 in FIG. 9; 1009 in FIG. 10) associated with the set of NCD SSBs (e.g., 606 in FIG. 6; 706 in FIG. 7; 806 in FIG. 8; 906 in FIG. 9; 1006 in FIG. 10), may be configured to obtain (e.g., at 510) (e.g., at 710 in FIG. 7; at 912 in FIG. 9; at 1008 in FIG. 10) the additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10) during the L1 measurement gap (e.g., 626 in FIG. 6; 1014 in FIG. 10) in accordance with the gap periodicity (e.g., 626 in FIG. 6; 1014 in FIG. 10). In aspects, to receive the NCD SSB configuration 506 (e.g., 614 in FIG. 6), the UE 502 may be configured to receive, and the base station 504 may be configured to transmit/provide/configure subsequent to the dynamic activation (e.g., 628, 630 in FIG. 6; 1007 in FIG. 10) for the L1 measurement gap (e.g., 626 in FIG. 6; 1014 in FIG. 10), a dynamic deactivation (e.g., 628, 630 in FIG. 6; 1010, 1011 in FIG. 10) for the L1 measurement gap (e.g., 626 in FIG. 6; 1014 in FIG. 10) in accordance with the set of NCD SSBs 508 (e.g., 606 in FIG. 6; 706 in FIG. 7; 806 in FIG. 8; 906 in FIG. 9; 1006 in FIG. 10) having a same number of SSBs as the set of CD SSBs (e.g., or more SSBs) (e.g., 724 in FIG. 7; 816 in FIG. 8; 908 in FIG. 9; 1012 in FIG. 10). The dynamic deactivation (e.g., 628, 630 in FIG. 6; 1010, 1011 in FIG. 10) for the L1 measurement gap (e.g., 626 in FIG. 6; 1014 in FIG. 10) may comprise/include at least one of the MAC-CE or the DCI, in aspects. In some aspects, the UE 502 may be configured to autonomously and dynamically deactivate (e.g., 630 in FIG. 6; 1011 in FIG. 10) the L1 measurement gap via a dynamic deactivation (e.g., 626 in FIG. 6; 1014 in FIG. 10) in accordance with the set of NCD SSBs (e.g., 606 in FIG. 6; 706 in FIG. 7; 806 in FIG. 8; 906 in FIG. 9; 1006 in FIG. 10) having a same number (or greater number) of SSBs as the set of CD SSBs (e.g., 724 in FIG. 7; 816 in FIG. 8; 908 in FIG. 9; 1012 in FIG. 10).

The UE 502 may be configured to transmit/provide, and at least one network node (e.g., the base station 504) may be configured to receive, the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In some aspects, the base station 504 may be configured to utilize the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10) to adjust (e.g., 624 in FIG. 6) the set of NCD SSBs 508 (e.g., 606 in FIG. 6; 706 in FIG. 7; 806 in FIG. 8; 906 in FIG. 9; 1006 in FIG. 10) and/or to perform other UE/cell management functions, as described herein.

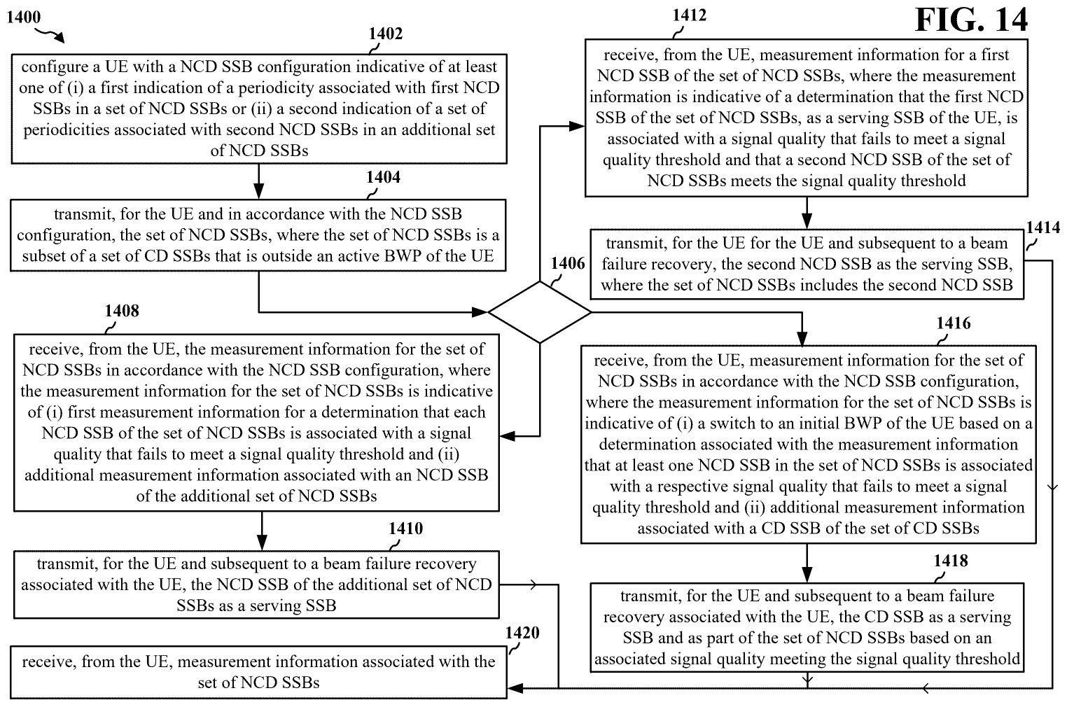

FIG. 14 is a flowchart 1400 of a method of wireless communication. The method may be performed by a base station (e.g., the base station 102, 504, 604, 704, 804, 904, 1004; the network entity 1502, 1602). The method may be for NES for reduced capability and enhanced reduced capability UEs. The method may enable a reduced capability UE to receive NCD SSBs having different indices at different periodicities, to utilize BFD/BFR for NES in reduced capability cells to indicate SSB beams having improved/sufficient signal quality, and to be configured by a network for L1 measurements outside of an active BW using a measurement gap.

At 1402, the network node configures a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. As an example, the configuration may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) configuring a UE (e.g., the UE 502) with such a NCD SSB configuration.

The UE 502 may be configured to receive, and the base station 504 may be configured to transmit/provide/configure, an NCD SSB configuration 506 (e.g., 614 in FIG. 6). In aspects, the NCD SSB configuration 506 (e.g., 614 in FIG. 6) may be indicative of at least one of (i) a first indication (e.g., 616 in FIG. 6) of a periodicity (e.g., 608 in FIG. 6; 716 in FIG. 7; 822 in FIG. 8; 922 in FIG. 9; 1016 in FIG. 10) associated with first NCD SSBs (e.g., one or more) in a set of NCD SSBs 508 (e.g., 606 in FIG. 6; 706 in FIG. 7; 806 in FIG. 8; 906 in FIG. 9; 1006 in FIG. 10) or (ii) a second indication (e.g., 618 in FIG. 6) of a set of periodicities (e.g., 612 in FIG. 6; 924 in FIG. 9) associated with second NCD SSBs (e.g., 812 in FIG. 8) (e.g., one or more) in an additional set of NCD SSBs (e.g., 610 in FIG. 6; 908 in FIG. 9). In some aspects, to receive the NCD SSB configuration 506 (e.g., 614 in FIG. 6), the UE 502 may be configured to receive, and the base station 504 may be configured to transmit/provide/configure, an adjustment (e.g., 624 in FIG. 6) associated with the NCD SSB configuration 506 (e.g., 614 in FIG. 6). The adjustment (e.g., 624 in FIG. 6) may comprise/include at least one of a MAC-CE or DCI. The adjustment (e.g., 624 in FIG. 6) via MAC-CE/DCI may include a set of bits indicative of at least one of (i) an additional NCD SSB (e.g., 916 in FIG. 9) for addition (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) or (ii) a current NCD SSB for removal (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10). As one example, and as noted above, the UE 502 may be configured to initiate BFDs (e.g., 712, 720 in FIG. 7; 818 in FIG. 8; 918 in FIG. 9) for NCD SSBs that fail to meet (e.g., 814 in FIG. 8; 907 in FIG. 9) a signal quality threshold (e.g., 622 in FIG. 6; at 708 in FIG. 7; at 808 in FIG. 8; at 910 in FIG. 9), and such NCD SSBs may be removed (e.g., 624 in FIG. 6) from the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). Likewise, the UE 502 may be configured to initiate BFRs (e.g., 712, 726 in FIG. 7; 810, 820 in FIG. 8; 914, 920 in FIG. 9) for NCD SSBs and/or CD SSBs (e.g., 714 in FIG. 7) that meet (e.g., 622 in FIG. 6) a signal quality threshold (e.g., 622 in FIG. 6; at 708 in FIG. 7; at 808 in FIG. 8; at 910 in FIG. 9), and such NCD SSBs/CD SSBs may be added (e.g., 624 in FIG. 6) to the set of NCD SSBs 508 (e.g., 606 in FIG. 6; 706 in FIG. 7; 806 in FIG. 8; 906 in FIG. 9; 1006 in FIG. 10) via the adjustment (e.g., 624 in FIG. 6) associated with the NCD SSB configuration 506 (e.g., 614 in FIG. 6). For instance, to receive the adjustment (e.g., 624 in FIG. 6) associated with the NCD SSB configuration 506 (e.g., 614 in FIG. 6), the UE 502 may be configured to transmit/provide, and the base station 504 may be configured to receive, an indication of SSBs in at least one of the set of NCD SSBs 508 (e.g., 606 in FIG. 6; 706 in FIG. 7; 806 in FIG. 8; 906 in FIG. 9; 1006 in FIG. 10) or the set of CD SSBs (e.g., 724 in FIG. 7; 816 in FIG. 8; 908 in FIG. 9; 1012 in FIG. 10) that meets (e.g., 622 in FIG. 6) the signal quality threshold (e.g., 622 in FIG. 6; at 708 in FIG. 7; at 808 in FIG. 8; at 910 in FIG. 9). In such aspects, the adjustment (e.g., 624 in FIG. 6) may thus be based on the indication. In some aspects, the NCD SSB configuration 506 (e.g., 614 in FIG. 6) may include a third indication of an L1 measurement gap (e.g., 626 in FIG. 6; 1014 in FIG. 10) associated with SSB measurements of the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive, and the base station 504 may be configured to transmit/provide/configure in accordance with the set of NCD SSBs 508 (e.g., 606 in FIG. 6; 706 in FIG. 7; 806 in FIG. 8; 906 in FIG. 9; 1006 in FIG. 10) having fewer SSBs than the set of CD SSBs (e.g., 724 in FIG. 7; 816 in FIG. 8; 908 in FIG. 9; 1012 in FIG. 10), a dynamic activation (e.g., 628, 630 in FIG. 6; 1007 in FIG. 10) for the L1 measurement gap (e.g., 626 in FIG. 6; 1014 in FIG. 10). The dynamic activation (e.g., 628, 630 in FIG. 6; 1007 in FIG. 10) for the L1 measurement gap (e.g., 626 in FIG. 6; 1014 in FIG. 10) may comprise include at least one of a MAC-CE or DCI that includes a fourth indication of a gap periodicity (e.g., 626 in FIG. 6; 1018 in FIG. 10) associated with an obtainment (e.g., at 710 in FIG. 7; at 912 in FIG. 9; at 1008 in FIG. 10) of additional measurement information (e.g., 1009 in FIG. 10) associated with the set of CD SSBs (e.g., 724 in FIG. 7; 816 in FIG. 8; 908 in FIG. 9; 1012 in FIG. 10). In aspects, the gap periodicity (e.g., 626 in FIG. 6; 1018 in FIG. 10) may be longer than the periodicity (e.g., 608 in FIG. 6; 716 in FIG. 7; 822 in FIG. 8; 922 in FIG. 9; 1016 in FIG. 10) of the set of NCD SSBs (e.g., the NCD SSB periodicity (e.g., 608 in FIG. 6; 716 in FIG. 7; 822 in FIG. 8; 922 in FIG. 9; 1016 in FIG. 10) to be smaller than, or relatively small compared to, CD SSB periods (e.g., 718 in FIG. 7) and/or non-serving NCD SSB periods (e.g., 612 in FIG. 6; 924 in FIG. 9) for measurement gaps (e.g., 626 in FIG. 6; 1014 in FIG. 10), such for maintenance of RLM/BFD (e.g., 712, 720 in FIG. 7; 818 in FIG. 8; 918 in FIG. 9)/L1-RSRP quality. The UE 502, to obtain (at 510) (e.g., at 710 in FIG. 7; at 912 in FIG. 9; at 1008 in FIG. 10) the measurement information 512 (e.g., 711 in FIG. 7; 809 in FIG. 8; 913 in FIG. 9; 1009 in FIG. 10) associated with the set of NCD SSBs (e.g., 606 in FIG. 6; 706 in FIG. 7; 806 in FIG. 8; 906 in FIG. 9; 1006 in FIG. 10), may be configured to obtain (e.g., at 510) (e.g., at 710 in FIG. 7; at 912 in FIG. 9; at 1008 in FIG. 10) the additional measurement information (e.g., 711 in FIG. 7; 913 in FIG. 9; 1009 in FIG. 10) associated with the set of CD SSBs (e.g., 724 in FIG. 7; 816 in FIG. 8; 908 in FIG. 9; 1012 in FIG. 10) during the L1 measurement gap (e.g., 626 in FIG. 6; 1014 in FIG. 10) in accordance with the gap periodicity (e.g., 626 in FIG. 6; 1018 in FIG. 10). In aspects, to receive the NCD SSB configuration 506 (e.g., 614 in FIG. 6), the UE 502 may be configured to receive, and the base station 504 may be configured to transmit/provide/configure subsequent to the dynamic activation (e.g., 628, 630 in FIG. 6; 1007 in FIG. 10) for the L1 measurement gap (e.g., 626 in FIG. 6; 1014 in FIG. 10), a dynamic deactivation (e.g., 628, 630 in FIG. 6; 1010, 1011 in FIG. 10) for the L1 measurement gap (e.g., 626 in FIG. 6; 1014 in FIG. 10) in accordance with the set of NCD SSBs 508 (e.g., 606 in FIG. 6; 706 in FIG. 7; 806 in FIG. 8; 906 in FIG. 9; 1006 in FIG. 10) having a same number of SSBs as the set of CD SSBs (e.g., or more SSBs) (e.g., 724 in FIG. 7; 816 in FIG. 8; 908 in FIG. 9; 1012 in FIG. 10). The dynamic deactivation (e.g., 628, 630 in FIG. 6; 1010, 1011 in FIG. 10) for the L1 measurement gap (e.g., 626 in FIG. 6; 1014 in FIG. 10) may comprise/include at least one of the MAC-CE or the DCI, in aspects. In some aspects, the UE 502 may be configured to autonomously and dynamically deactivate (e.g., 630 in FIG. 6; 1011 in FIG. 10) the L1 measurement gap via a dynamic deactivation (e.g., 626 in FIG. 6; 1014 in FIG. 10) in accordance with the set of NCD SSBs (e.g., 606 in FIG. 6; 706 in FIG. 7; 806 in FIG. 8; 906 in FIG. 9; 1006 in FIG. 10) having a same number (or greater number) of SSBs as the set of CD SSBs (e.g., 724 in FIG. 7; 816 in FIG. 8; 908 in FIG. 9; 1012 in FIG. 10). The UE 502 may be configured to transmit/provide, and at least one network node (e.g., the base station 504) may be configured to receive, the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In some aspects, the base station 504 may be configured to utilize the measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10) to adjust (e.g., 624 in FIG. 6) the set of NCD SSBs 508 (e.g., 606 in FIG. 6; 706 in FIG. 7; 806 in FIG. 8; 906 in FIG. 9; 1006 in FIG. 10) and/or to perform other UE/cell management functions, as described herein.

At 1404, the network node transmits, for the UE and in accordance with the NCD SSB configuration, the set of NCD SSBs, where the set of NCD SSBs is a subset of a set of CD SSBs that is outside an active BWP of the UE. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a set of NCD SSBs to a UE (e.g., the UE 502).

In aspects, the UE 502 may be configured to receive, and the base station 504 may be configured to transmit/provide, the set of NCD SSBs 508 (e.g., 606 in FIG. 6; 706 in FIG. 7; 806 in FIG. 8; 906 in FIG. 9; 1006 in FIG. 10). In aspects, the set of NCD SSBs 508 (e.g., 606 in FIG. 6; 706 in FIG. 7; 806 in FIG. 8; 906 in FIG. 9; 1006 in FIG. 10) may be a subset of a set of CD SSBs (e.g., 724 in FIG. 7; 816 in FIG. 8; 908 in FIG. 9; 1012 in FIG. 10) outside an active BWP of the UE 502 (e.g., as shown for the set of CD SSBs 406 in FIG. 4). As described herein, a set of CD SSBs (e.g., 724 in FIG. 7; 816 in FIG. 8; 908 in FIG. 9; 1012 in FIG. 10) may be actually transmitted by a network node (e.g., the base station 504) and may be received by a UE (e.g., the UE 502). To transmit the set of NCD SSBs, the UE 502 may be configured to receive, and the base station 504 may be configured to transmit/provide, the set of CD SSBs (e.g., 724 in FIG. 7; 816 in FIG. 8; 908 in FIG. 9; 1012 in FIG. 10) outside the active BWP of the UE 502. In aspects, to receive the set of NCD SSBs 508 (e.g., 606 in FIG. 6; 706 in FIG. 7; 806 in FIG. 8; 906 in FIG. 9; 1006 in FIG. 10), the UE 502 may be configured to receive, and the base station 504 may be configured to transmit/provide, an additional set of NCD SSBs (e.g., 610 in FIG. 6; 908 in FIG. 9) in accordance with an additional periodicity (e.g., 612 in FIG. 6; 924 in FIG. 9) that is longer than a periodicity (e.g., 608 in FIG. 6; 716 in FIG. 7; 822 in FIG. 8; 922 in FIG. 9; 1016 in FIG. 10) of the set of NCD SSBs 508 (e.g., 606 in FIG. 6; 706 in FIG. 7; 806 in FIG. 8; 906 in FIG. 9; 1006 in FIG. 10). The additional set of NCD SSBs (e.g., 610 in FIG. 6; 908 in FIG. 9) may be exclusive of the set of NCD SSBs 508 (e.g., 606 in FIG. 6; 706 in FIG. 7; 806 in FIG. 8; 906 in FIG. 9; 1006 in FIG. 10), as described herein. In some aspects, a number of first NCD SSBs in the set of NCD SSBs 508 (e.g., 606 in FIG. 6; 706 in FIG. 7; 806 in FIG. 8; 906 in FIG. 9; 1006 in FIG. 10) may be less than an additional number of second NCD SSBs (e.g., 812 in FIG. 8) in the additional set of NCD SSBs (e.g., 610 in FIG. 6; 908 in FIG. 9). In some aspects, the number of first NCD SSBs in the set of NCD SSBs 508 (e.g., 606 in FIG. 6; 706 in FIG. 7; 806 in FIG. 8; 906 in FIG. 9; 1006 in FIG. 10) and the additional number of second NCD SSBs (e.g., 812 in FIG. 8) in the additional set of NCD SSBs (e.g., 610 in FIG. 6; 908 in FIG. 9) may equal a total number of CD SSBs in the set CD SSBs (e.g., 724 in FIG. 7; 816 in FIG. 8; 908 in FIG. 9; 1012 in FIG. 10).

At 1406, the flowchart 1400 may continue based on determinations associated with measurement information. When a determination based on measurement information indicates that a first NCD SSB, as a serving SSB, of a set of NCD SSBs fails to meet a signal quality threshold and a second NCD SSB of the set is available, the flowchart 1400 may continue to 1410. When a determination based on measurement information indicates that each NCD SSB of a set of NCD SSBs fails to meet a signal quality threshold, the flowchart 1400 may continue to 1414. When a determination based on measurement information indicates that a NCD SSB(s) of a set of NCD SSBs fails to meet a signal quality threshold, the flowchart 1400 may continue to 1420.

At 1408, the network node receives, from the UE, the measurement information for the set of NCD SSBs in accordance with the NCD SSB configuration, where the measurement information for the set of NCD SSBs is indicative of (i) first measurement information for a determination that each NCD SSB of the set of NCD SSBs is associated with a signal quality that fails to meet a signal quality threshold and (ii) additional measurement information associated with an NCD SSB of the additional set of NCD SSBs. As an example, the reception may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) receiving such measurement information from a UE (e.g., the UE 502).

In aspects, the UE 502 may be configured to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10) associated with the set of NCD SSBs 508 (e.g., 606 in FIG. 6; 706 in FIG. 7; 806 in FIG. 8; 906 in FIG. 9; 1006 in FIG. 10). In aspects, the UE 502 may be configured to measure signal quality indicators (e.g., RSRP, RSRQ, SNR, SINR, and/or another reference signal characteristic, RRM measurements, L3 cell level measurements, or other measurements described herein) of one or more SSBs of the set of NCD SSBs 508 (e.g., 606 in FIG. 6; 706 in FIG. 7; 806 in FIG. 8; 906 in FIG. 9; 1006 in FIG. 10) to obtain (at 510) (e.g., at 710 in FIG. 7; at 912 in FIG. 9; at 1008 in FIG. 10) measurement information 512 (e.g., 711 in FIG. 7; 809 in FIG. 8; 913 in FIG. 9; 1009 in FIG. 10). The UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that meets (e.g., 622 in FIG. 6) (or not) a signal quality threshold (e.g., 622 in FIG. 6; at 708 in FIG. 7; at 808 in FIG. 8; at 910 in FIG. 9) (e.g., below 10% block error rate (BLER), or the like).

In some aspects, the UE 502 may be configured to determine, e.g., based on the measurement information 512 (e.g., 711 in FIG. 7; 809 in FIG. 8; 913 in FIG. 9; 1009 in FIG. 10) obtained (at 510) (e.g., at 710 in FIG. 7; at 912 in FIG. 9; at 1008 in FIG. 10), that each NCD SSB of the set of NCD SSBs 508 (e.g., 606 in FIG. 6; 706 in FIG. 7; 806 in FIG. 8; 906 in FIG. 9; 1006 in FIG. 10) may be associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) (e.g., below 10% BLER of a hypothetical PDCCH, or the like). The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9), e.g., based on the determined signal quality threshold (e.g., 622 in FIG. 6; at 708 in FIG. 7; at 808 in FIG. 8; at 910 in FIG. 9) failure (e.g., 814 in FIG. 8; 907 in FIG. 9). The UE 502 may be configured to determine that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9), and to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the NCD SSB of the additional set of NCD SSBs (e.g., 610 in FIG. 6; 908 in FIG. 9). The UE 502 may be configured to transmit/provide, and the base station 504 may be configured to receive, the measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) first measurement information for a determination that each NCD SSB of the set of NCD SSBs 508 (e.g., 606 in FIG. 6; 706 in FIG. 7; 806 in FIG. 8; 906 in FIG. 9; 1006 in FIG. 10) is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with an NCD SSB of the additional set of NCD SSBs (e.g., 610 in FIG. 6; 908 in FIG. 9). The UE 502 may be configured to transmit/provide, and the base station 504 may be configured to receive, a beam failure recovery (e.g., 712, 726 in FIG. 7; 810, 820 in FIG. 8; 914, 920 in FIG. 9) signal to the network based on the additional measurement information (e.g., 711 in FIG. 7; 913 in FIG. 9; 1009 in FIG. 10) associated with the CD SSB (e.g., 714 in FIG. 7). The UE 502 may be configured to receive, and the base station 504 may be configured to transmit/provide, subsequent to a beam failure recovery (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs (e.g., 606 in FIG. 6; 706 in FIG. 7; 806 in FIG. 8; 906 in FIG. 9; 1006 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9).

At 1410, the network node transmits, for the UE and subsequent to a beam failure recovery associated with the UE, the NCD SSB of the additional set of NCD SSBs as a serving SSB. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a NCD SSB to a UE (e.g., the UE 502).

Thus, the UE 502 may be configured to receive, and the base station 504 may be configured to transmit/provide, subsequent to (i) a determination that the NCD SSB of the additional set of NCD SSBs (e.g., 610 in FIG. 6; 908 in FIG. 9) meets (e.g., 622 in FIG. 6) the signal quality threshold (e.g., 622 in FIG. 6; at 708 in FIG. 7; at 808 in FIG. 8; at 910 in FIG. 9) and (ii) a BFR (e.g., 712, 726 in FIG. 7; 810, 820 in FIG. 8; 914, 920 in FIG. 9), the NCD SSB of the additional set of NCD SSBs (e.g., 610 in FIG. 6; 908 in FIG. 9) as a serving SSB, e.g., now as part of the set of NCD SSBs 508 (e.g., 606 in FIG. 6; 706 in FIG. 7; 806 in FIG. 8; 906 in FIG. 9; 1006 in FIG. 10) after being adjusted therefor.

At 1412, the network node receives, from the UE, measurement information for a first NCD SSB of the set of NCD SSBs, where the measurement information is indicative of a determination that the first NCD SSB of the set of NCD SSBs, as a serving SSB of the UE, is associated with a signal quality that fails to meet a signal quality threshold and that a second NCD SSB of the set of NCD SSBs meets the signal quality threshold. As an example, the reception may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) receiving such measurement information from a UE (e.g., the UE 502).

In some aspects, the UE 502 may be configured to determine, based on the measurement information 512 (e.g., 711 in FIG. 7; 809 in FIG. 8; 913 in FIG. 9; 1009 in FIG. 10), that a first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) (e.g., below 10% BLER, or the like) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). In aspects, such a determination may be performed in association with the non-initial/active BWP of the UE 502. The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for a first NCD SSB of the set of NCD SSBs 508 (e.g., 606 in FIG. 6; 706 in FIG. 7; 806 in FIG. 8; 906 in FIG. 9; 1006 in FIG. 10). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of a determination that the first NCD SSB of the set of NCD SSBs 508 (e.g., 606 in FIG. 6; 706 in FIG. 7; 806 in FIG. 8; 906 in FIG. 9; 1006 in FIG. 10), as a serving SSB of the UE 502, is associated with a signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and that a second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) meets (e.g., 622 in FIG. 6) the signal quality threshold (e.g., 622 in FIG. 6; at 708 in FIG. 7; at 808 in FIG. 8; at 910 in FIG. 9). The UE 502 may be configured to subsequently initiate a BFR (e.g., 712, 726 in FIG. 7; 810, 820 in FIG. 8; 914, 920 in FIG. 9) for the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10), and thus be configured to receive, and the base station 504 may be configured to transmit/provide, subsequent to the BFR (e.g., 712, 726 in FIG. 7; 810, 820 in FIG. 8; 914, 920 in FIG. 9), the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) as the serving SSB. In such aspects, the set of NCD SSBs (e.g., 606 in FIG. 6; 706 in FIG. 7; 806 in FIG. 8; 906 in FIG. 9; 1006 in FIG. 10) may include the second NCD SSB (e.g., 812 in FIG. 8).

At 1414, the network node transmits, for the UE and subsequent to a beam failure recovery associated with the UE, the NCD SSB of the additional set of NCD SSBs as a serving SSB, where the set of NCD SSBs includes the second NCD SSB. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a NCD SSB to a UE (e.g., the UE 502).

The UE 502 may be configured to subsequently initiate a BFR (e.g., 712, 726 in FIG. 7; 810, 820 in FIG. 8; 914, 920 in FIG. 9) for the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10), and thus be configured to receive, and the base station 504 may be configured to transmit/provide, subsequent to the BFR (e.g., 712, 726 in FIG. 7; 810, 820 in FIG. 8; 914, 920 in FIG. 9), the second NCD SSB (e.g., 812 in FIG. 8) of the set of NCD SSBs 508 (e.g., 606 in FIG. 6; 706 in FIG. 7; 806 in FIG. 8; 906 in FIG. 9; 1006 in FIG. 10) as the serving SSB. In such aspects, the set of NCD SSBs (e.g., 606 in FIG. 6; 706 in FIG. 7; 806 in FIG. 8; 906 in FIG. 9; 1006 in FIG. 10) may include the second NCD SSB (e.g., 812 in FIG. 8). In some aspects, the set of NCD SSBs (e.g., 606 in FIG. 6; 706 in FIG. 7; 806 in FIG. 8; 906 in FIG. 9; 1006 in FIG. 10) may comprise an NCD SSB burst set in which given NCD SSBs are ordered/positioned. The NCD SSB configuration 506 (e.g., 614 in FIG. 6) may include at least one burst position IE (e.g., 620 in FIG. 6) indicative of the first NCD SSBs in the set of NCD SSBs 508 (e.g., 606 in FIG. 6; 706 in FIG. 7; 806 in FIG. 8; 906 in FIG. 9; 1006 in FIG. 10) for such an NCD SSB burst set. In some aspects, the at least one burst position IE (e.g., 620 in FIG. 6) may include a burst position IE (e.g., 620 in FIG. 6) for each of the first NCD SSBs in the set of NCD SSBs 508 (e.g., 606 in FIG. 6; 706 in FIG. 7; 806 in FIG. 8; 906 in FIG. 9; 1006 in FIG. 10) and/or for each of the second NCD SSBs (e.g., 812 in FIG. 8) in the set of NCD SSBs 508 (e.g., 606 in FIG. 6; 706 in FIG. 7; 806 in FIG. 8; 906 in FIG. 9; 1006 in FIG. 10). In such aspects, to receive the NCD SSB configuration 506 (e.g., 614 in FIG. 6), the UE 502 may be configured to receive the NCD SSB configuration 506 (e.g., 614 in FIG. 6) via RRC signaling.

At 1416, the network node receives, from the UE, measurement information for the set of NCD SSBs in accordance with the NCD SSB configuration, where the measurement information for the set of NCD SSBs is indicative of (i) a switch to an initial BWP of the UE based on a determination associated with the measurement information that at least one NCD SSB in the set of NCD SSBs is associated with a respective signal quality that fails to meet a signal quality threshold and (ii) additional measurement information associated with a CD SSB of the set of CD SSBs. As an example, the reception may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) receiving such measurement information from a UE (e.g., the UE 502).

In some aspects, the UE 502 may be configured to switch (e.g., at 708, 722 in FIG. 7) to an initial BWP (e.g., non-default/non-active BWP for the CD SSBs (e.g., 714, 724 in FIG. 7; 816 in FIG. 8; 908 in FIG. 9; 1012 in FIG. 10)) of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). For instance, the UE 502 may be configured to determine, based on the measurement information 512 (e.g., 711 in FIG. 7; 809 in FIG. 8; 913 in FIG. 9; 1009 in FIG. 10), that an NCD SSB(s) of the set of NCD SSBs 508 (e.g., 606 in FIG. 6; 706 in FIG. 7; 806 in FIG. 8; 906 in FIG. 9; 1006 in FIG. 10) fails to meet (e.g., 814 in FIG. 8; 907 in FIG. 9) the signal quality threshold (e.g., 622 in FIG. 6; at 708 in FIG. 7; at 808 in FIG. 8; at 910 in FIG. 9). Accordingly, the UE 502 may be configured to switch (e.g., at 708, 722 in FIG. 7) to the initial BWP. The UE 502 may be configured to obtain (e.g., at 710 in FIG. 7; at 912 in FIG. 9; at 1008 in FIG. 10) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10), e.g., based on the switch (e.g., at 708, 722 in FIG. 7) to the initial BWP associated with the set of CD SSBs (e.g., 724 in FIG. 7; 816 in FIG. 8; 908 in FIG. 9; 1012 in FIG. 10). A transmission of a given CD SSB (e.g., 714 in FIG. 7) and/or of the set of CD SSBs (e.g., 724 in FIG. 7; 816 in FIG. 8; 908 in FIG. 9; 1012 in FIG. 10) may occur outside the active BWP of the UE 502. The UE 502 may be configured to subsequently initiate a BFD (e.g., 712, 720 in FIG. 7; 818 in FIG. 8; 918 in FIG. 9) for the NCD SSB(s) that fail to meet (e.g., 814 in FIG. 8; 907 in FIG. 9) the signal quality threshold (e.g., 622 in FIG. 6; at 708 in FIG. 7; at 808 in FIG. 8; at 910 in FIG. 9) and a BFR (e.g., 712, 726 in FIG. 7; 810, 820 in FIG. 8; 914, 920 in FIG. 9) for the CD SSB (e.g., 714 in FIG. 7) of the set of CD SSBs (e.g., 724 in FIG. 7; 816 in FIG. 8; 908 in FIG. 9; 1012 in FIG. 10) based on an associated signal quality meeting (e.g., 622 in FIG. 6) the signal quality threshold (e.g., 622 in FIG. 6; at 708 in FIG. 7; at 808 in FIG. 8; at 910 in FIG. 9). The UE 502 may be configured to transmit/provide, and the base station 504 may be configured to receive, measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) in accordance with the NCD SSB configuration 506 (e.g., 614 in FIG. 6). The measurement information 512 (e.g., 711 in FIG. 7; 809 in FIG. 8; 913 in FIG. 9; 1009 in FIG. 10) for the set of NCD SSBs 508 (e.g., 606 in FIG. 6; 706 in FIG. 7; 806 in FIG. 8; 906 in FIG. 9; 1006 in FIG. 10) may be indicative of (i) a switch (e.g., at 708, 722 in FIG. 7) to an initial BWP of the UE 502 based on a determination associated with the measurement information 512 (e.g., 711 in FIG. 7; 809 in FIG. 8; 913 in FIG. 9; 1009 in FIG. 10) that at least one NCD SSB in the set of NCD SSBs 508 (e.g., 606 in FIG. 6; 706 in FIG. 7; 806 in FIG. 8; 906 in FIG. 9; 1006 in FIG. 10) is associated with a respective signal quality that fails to meet (e.g., 814 in FIG. 8; 907 in FIG. 9) a signal quality threshold (e.g., 622 in FIG. 6; at 708 in FIG. 7; at 808 in FIG. 8; at 910 in FIG. 9) and (ii) additional measurement information (e.g., 711 in FIG. 7; 913 in FIG. 9; 1009 in FIG. 10) associated with a CD SSB (e.g., 714 in FIG. 7) of the set of CD SSBs (e.g., 724 in FIG. 7; 816 in FIG. 8; 908 in FIG. 9; 1012 in FIG. 10).

At 1418, the network node transmits, for the UE and subsequent to a beam failure recovery associated with the UE, the CD SSB as a serving SSB and as part of the set of NCD SSBs based on an associated signal quality meeting the signal quality threshold. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a CD SSB to a UE (e.g., the UE 502).

Thus, the UE 502 may be configured to receive, and the base station 504 may be configured to transmit/provide, subsequent to a BFR (e.g., 712, 726 in FIG. 7; 810, 820 in FIG. 8; 914, 920 in FIG. 9), the CD SSB (e.g., 714 in FIG. 7) as a serving SSB and as part of the set of NCD SSBs 508 (e.g., 606 in FIG. 6; 706 in FIG. 7; 806 in FIG. 8; 906 in FIG. 9; 1006 in FIG. 10) after being adjusted therefor. In aspects, a first time taken for the beam failure recovery (e.g., 712, 726 in FIG. 7; 810, 820 in FIG. 8; 914, 920 in FIG. 9) may be associated with a second time taken for the switch (e.g., at 708, 722 in FIG. 7) to the initial BWP.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to receive, from a network node, a set of NCD SSBs, where the set of NCD SSBs is a subset of a set of CD SSBs outside an active BWP of the UE. The component 198 may be configured to obtain measurement information associated with the set of NCD SSBs. The component 198 may be configured to determine, based on the measurement information, that each NCD SSB of the set of NCD SSBs is associated with a signal quality that fails to meet a signal quality threshold. The component 198 may be configured to obtain additional measurement information associated with an NCD SSB of the additional set of NCD SSBs. The component 198 may be configured to receive, from the network node and subsequent to (i) a determination that the NCD SSB of the additional set of NCD SSBs meets the signal quality threshold and (ii) a beam failure recovery, the NCD SSB of the additional set of NCD SSBs as a serving SSB. The component 198 may be configured to determine, based on the measurement information, that a first NCD SSB of the set of NCD SSBs, as a serving SSB of the UE, is associated with a signal quality that fails to meet a signal quality threshold and that a second NCD SSB of the set of NCD SSBs meets the signal quality threshold. The component 198 may be configured to receive, from the network node and subsequent to a beam failure recovery, the second NCD SSB as the serving SSB. The component 198 may be configured to switch to an initial BWP of the UE based on a determination associated with the measurement information that at least one NCD SSB in the set of NCD SSBs is associated with a respective signal quality that fails to meet a signal quality threshold. The component 198 may be configured to obtain additional measurement information associated with a CD SSB of the set of CD SSBs. The component 198 may be configured to transmit a beam failure recovery signal to the network based on the additional measurement information associated with CD-SSB. The component 198 may be configured to receive, from the network node and subsequent to a beam failure recovery, the CD SSB as a serving SSB and as part of the set of NCD SSBs based on an associated signal quality meeting the signal quality threshold. The component 198 may be configured to receive, from the network node, an NCD SSB configuration indicative of at least one of (i) a first indication of a periodicity associated with first NCD SSBs in the set of NCD SSBs or (ii) a second indication of a set of periodicities associated with second NCD SSBs in an additional set of NCD SSBs. The component 198 may be configured to transmit, for at least one network node, the measurement information associated with the set of NCD SSBs. The component 198 may be further configured to perform any of the aspects described in connection with the flowcharts in any of FIGS. 11, 12, 13, 14 and/or any of the aspects performed by a UE (e.g., a reduced capability/enhanced reduced capability UE) for any of FIGS. 4-10. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for receiving, from a network node, a set of NCD SSBs, where the set of NCD SSBs is a subset of a set of CD SSBs outside an active BWP of the UE. In one configuration, the apparatus 1504, and in particular the cellular baseband processor(s) 1524 and/or the application processor(s) 1506, may include means for obtaining measurement information associated with the set of NCD SSBs. In one configuration, the apparatus 1504, and in particular the cellular baseband processor(s) 1524 and/or the application processor(s) 1506, may include means for determining, based on the measurement information, that each NCD SSB of the set of NCD SSBs is associated with a signal quality that fails to meet a signal quality threshold. In one configuration, the apparatus 1504, and in particular the cellular baseband processor(s) 1524 and/or the application processor(s) 1506, may include means for obtaining additional measurement information associated with an NCD SSB of the additional set of NCD SSBs. In one configuration, the apparatus 1504, and in particular the cellular baseband processor(s) 1524 and/or the application processor(s) 1506, may include means for receiving, from the network node and subsequent to (i) a determination that the NCD SSB of the additional set of NCD SSBs meets the signal quality threshold and (ii) a beam failure recovery, the NCD SSB of the additional set of NCD SSBs as a serving SSB. In one configuration, the apparatus 1504, and in particular the cellular baseband processor(s) 1524 and/or the application processor(s) 1506, may include means for determining, based on the measurement information, that a first NCD SSB of the set of NCD SSBs, as a serving SSB of the UE, is associated with a signal quality that fails to meet a signal quality threshold and that a second NCD SSB of the set of NCD SSBs meets the signal quality threshold. In one configuration, the apparatus 1504, and in particular the cellular baseband processor(s) 1524 and/or the application processor(s) 1506, may include means for receiving, from the network node and subsequent to a beam failure recovery, the second NCD SSB as the serving SSB. In one configuration, the apparatus 1504, and in particular the cellular baseband processor(s) 1524 and/or the application processor(s) 1506, may include means for switching to an initial BWP of the UE based on a determination associated with the measurement information that at least one NCD SSB in the set of NCD SSBs is associated with a respective signal quality that fails to meet a signal quality threshold. In one configuration, the apparatus 1504, and in particular the cellular baseband processor(s) 1524 and/or the application processor(s) 1506, may include means for obtaining additional measurement information associated with a CD SSB of the set of CD SSBs. In one configuration, the apparatus 1504, and in particular the cellular baseband processor(s) 1524 and/or the application processor(s) 1506, may include means for transmitting a beam failure recovery signal to the network based on the additional measurement information associated with CD-SSB. In one configuration, the apparatus 1504, and in particular the cellular baseband processor(s) 1524 and/or the application processor(s) 1506, may include means for receiving, from the network node and subsequent to a beam failure recovery, the CD SSB as a serving SSB and as part of the set of NCD SSBs based on an associated signal quality meeting the signal quality threshold. In one configuration, the apparatus 1504, and in particular the cellular baseband processor(s) 1524 and/or the application processor(s) 1506, may include means for receiving, from the network node, an NCD SSB configuration indicative of at least one of (i) a first indication of a periodicity associated with first NCD SSBs in the set of NCD SSBs or (ii) a second indication of a set of periodicities associated with second NCD SSBs in an additional set of NCD SSBs. In one configuration, the apparatus 1504, and in particular the cellular baseband processor(s) 1524 and/or the application processor(s) 1506, may include means for transmitting, for at least one network node, the measurement information associated with the set of NCD SSBs. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. The component 199 may be configured to transmit, for the UE and in accordance with the NCD SSB configuration, the set of NCD SSBs, where the set of NCD SSBs is a subset of a set of CD SSBs that is outside an active BWP of the UE. The component 199 may be configured, where the NCD SSB configuration is associated with measurement information for the set of NCD SSBs, to receive, from the UE, the measurement information for the set of NCD SSBs in accordance with the NCD SSB configuration, where the measurement information for the set of NCD SSBs is indicative of (i) first measurement information for a determination that each NCD SSB of the set of NCD SSBs is associated with a signal quality that fails to meet a signal quality threshold and (ii) additional measurement information associated with an NCD SSB of the additional set of NCD SSBs. The component 199 may be configured, where the NCD SSB configuration is associated with measurement information for the set of NCD SSBs, to transmit, for the UE and subsequent to a beam failure recovery associated with the UE, the NCD SSB of the additional set of NCD SSBs as a serving SSB. The component 199 may be configured to receive, from the UE, measurement information for the set of NCD SSBs in accordance with the NCD SSB configuration, where the measurement information for the set of NCD SSBs is indicative of (i) a switch to an initial BWP of the UE based on a determination associated with the measurement information that at least one NCD SSB in the set of NCD SSBs is associated with a respective signal quality that fails to meet a signal quality threshold and (ii) additional measurement information associated with a CD SSB of the set of CD SSBs. The component 199 may be configured to transmit, for the UE and subsequent to a beam failure recovery associated with the UE, the CD SSB as a serving SSB and as part of the set of NCD SSBs based on an associated signal quality meeting the signal quality threshold. The component 199 may be configured to receive, from the UE, measurement information for a first NCD SSB of the set of NCD SSBs, where the measurement information is indicative of a determination that the first NCD SSB of the set of NCD SSBs, as a serving SSB of the UE, is associated with a signal quality that fails to meet a signal quality threshold and that a second NCD SSB of the set of NCD SSBs meets the signal quality threshold. The component 199 may be configured to transmit, for the UE and subsequent to a beam failure recovery, the second NCD SSB as the serving SSB, where the set of NCD SSBs includes the second NCD SSB. The component 199 may be configured to receive, from the UE, measurement information associated with the set of NCD SSBs. The component 199 may be further configured to perform any of the aspects described in connection with the flowcharts in any of FIGS. 11, 12, 13, 14 and/or any of the aspects performed by a network node (e.g., a base station, a gNB, a network entity, etc.) for any of FIGS. 4-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for configuring a UE with a NCD SSB configuration indicative of at least one of (i) a first indication of a periodicity associated with first NCD SSBs in a set of NCD SSBs or (ii) a second indication of a set of periodicities associated with second NCD SSBs in an additional set of NCD SSBs. In one configuration, the network entity 1602 may include means for transmitting, for the UE and in accordance with the NCD SSB configuration, the set of NCD SSBs, where the set of NCD SSBs is a subset of a set of CD SSBs that is outside an active BWP of the UE. In one configuration, the network entity 1602 may include means, where the NCD SSB configuration is associated with measurement information for the set of NCD SSBs, for receiving, from the UE, the measurement information for the set of NCD SSBs in accordance with the NCD SSB configuration, where the measurement information for the set of NCD SSBs is indicative of (i) first measurement information for a determination that each NCD SSB of the set of NCD SSBs is associated with a signal quality that fails to meet a signal quality threshold and (ii) additional measurement information associated with an NCD SSB of the additional set of NCD SSBs. In one configuration, the network entity 1602 may include means, where the NCD SSB configuration is associated with measurement information for the set of NCD SSBs, for transmitting, for the UE and subsequent to a beam failure recovery associated with the UE, the NCD SSB of the additional set of NCD SSBs as a serving SSB. In one configuration, the network entity 1602 may include means for receiving, from the UE, measurement information for the set of NCD SSBs in accordance with the NCD SSB configuration, where the measurement information for the set of NCD SSBs is indicative of (i) a switch to an initial BWP of the UE based on a determination associated with the measurement information that at least one NCD SSB in the set of NCD SSBs is associated with a respective signal quality that fails to meet a signal quality threshold and (ii) additional measurement information associated with a CD SSB of the set of CD SSBs. In one configuration, the network entity 1602 may include means for transmitting, for the UE and subsequent to a beam failure recovery associated with the UE, the CD SSB as a serving SSB and as part of the set of NCD SSBs based on an associated signal quality meeting the signal quality threshold. In one configuration, the network entity 1602 may include means for receiving, from the UE, measurement information for a first NCD SSB of the set of NCD SSBs, where the measurement information is indicative of a determination that the first NCD SSB of the set of NCD SSBs, as a serving SSB of the UE, is associated with a signal quality that fails to meet a signal quality threshold and that a second NCD SSB of the set of NCD SSBs meets the signal quality threshold. In one configuration, the network entity 1602 may include means for transmitting, for the UE and subsequent to a beam failure recovery, the second NCD SSB as the serving SSB, where the set of NCD SSBs includes the second NCD SSB. In one configuration, the network entity 1602 may include means for receiving, from the UE, measurement information associated with the set of NCD SSBs. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

A UE may be a reduced capability UE or an enhanced reduced capability UE (reduced capability UEs, generally), and such UEs may operate according to reduced power consumption configurations and may have maximum bandwidth support that is less than other types of UEs (e.g., 20 MHz). the network may configure NCD SSBs and CD SSBs) in different time domain occasions for considerations for maximum transmit power during SSB transmissions, and the network transmits CD SSBs as part of the initial BWP for a reduced capability UE. In some cases, reduced capability UEs may operate in a narrow and specific non-initial BWP as indicated by the network after connection establishment. To avoid load balancing-related issues, the network may not configure an initial BWP as the default BWP, and the default, non-initial BWP may contain NCD SSBs. Thus, NCD SSBs may be transmitted as part of an active BWP, and CD SSBs may be transmitted outside of the active BWP. As the default non-initial BWP may be the active BWP for some reduced capability UEs in a cell, if a reduced capability UE in connected mode has a NCD SSB in an active BWP, then UE may use the NCD SSB for following: RLM, BFD, BFR, serving cell measurements, a QCL source, and RO selection. However, current SSB configurations for reduced capability UEs lack configurations for scenarios in which a serving SSB Tx beam of a UE will be part of a NCD SSB set being transmitted from network, and in which CD SSBs are not part of the active UE BWP. The NCD SSB of an active BWP may be used for beam management purposes, and issues may arise in the context of NES for reduced capability UEs/cell with respect to BFD/BFR and layer 3 (L3) measurement gaps. For instance, in the context of a reduced capability PCell network, the network may consume unnecessary power to transmit NCD SSBs in the same set of directions as CD SSBs. This additional power consumption may become significant when NCD SSB is based on TDM in association with CD SSBs, and NCD SSB periodicity may also be an issue for maintaining RLM/BFD/L1-RSRP quality. Current solutions include transmission of NCD SSB in unnecessary/unutilized directions (e.g., where no UE of an active BWP is located) and may prohibit the network from entering a deeper sleep mode. Thus, NES is impacted in reduced capability networks. For instance, activation of a sleep mode for the network may depend on the allowed time to sleep because deeper sleep mode has a longer transition time, when the network monitors RACH occasions several subframes after a NCD SSB burst set, the transmission of unnecessary/unutilized NCD SSBs at the end of a NCD SSB burst set may force the network to go to micro sleep, instead of light sleep, in the region between the NCD SSB transmission and RACH occasion reception, which impacts NES.

Aspects herein for NES for reduced capability and enhanced reduced capability UEs improve NES operations at such UEs and serving networks. Aspects provide for a UE to increase NES by utilizing different periodicities for different sets of SSBs or not transmitting certain sets of SSBs to a reduced capability UE. Aspects enable switching of a serving SSB to another SSB beam while maintaining NES by utilizing BFD/BFR at a reduced capability UE in association with signal quality of SSBs with less frequent periodicity. Aspects enable measurement and obtainment of the quality of SSBs in terms of RSRP, by way of example, from CD SSBs by configuring a measurement gap in a non-initial BWP for serving SSBs at a reduced capability UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving, from a network node, a set of non-cell-defining (NCD) synchronization signal blocks (SSBs), wherein the set of NCD SSBs is a subset of a set of cell-defining (CD) SSBs outside an active bandwidth part (BWP) of the UE; and obtaining measurement information associated with the set of NCD SSBs.

Aspect 2 is the method of aspect 1, wherein receiving the set of NCD SSBs includes: receiving, from the network node, an additional set of NCD SSBs in accordance with an additional periodicity that is longer than a periodicity of the set of NCD SSBs, wherein the additional set of NCD SSBs is exclusive of the set of NCD SSBs.

Aspect 3 is the method of aspect 2, wherein a number of first NCD SSBs in the set of NCD SSBs is less than an additional number of second NCD SSBs in the additional set of NCD SSBs; or wherein the number of first NCD SSBs in the set of NCD SSBs and the additional number of second NCD SSBs in the additional set of NCD SSBs equals a total number of CD SSBs in the set CD SSBs.

Aspect 4 is the method of any of aspect 2, further comprising: determining, based on the measurement information, that each NCD SSB of the set of NCD SSBs is associated with a signal quality that fails to meet a signal quality threshold; obtaining additional measurement information associated with an NCD SSB of the additional set of NCD SSBs; and receiving, from the network node and subsequent to (i) a determination that the NCD SSB of the additional set of NCD SSBs meets the signal quality threshold and (ii) a beam failure recovery, the NCD SSB of the additional set of NCD SSBs as a serving SSB.

Aspect 5 is the method of aspect 2, further comprising: determining, based on the measurement information, that a first NCD SSB of the set of NCD SSBs, as a serving SSB of the UE, is associated with a signal quality that fails to meet a signal quality threshold and that a second NCD SSB of the additional set of NCD SSBs meets the signal quality threshold; and receiving, from the network node and subsequent to a beam failure recovery, the second NCD SSB as the serving SSB and an updated set of NCD SSBs that includes the second NCD SSB.

Aspect 6 is the method of aspect 1, further comprising: switching to an initial BWP of the UE based on a determination associated with the measurement information that at least one NCD SSB in the set of NCD SSBs is associated with a respective signal quality that fails to meet a signal quality threshold; obtaining additional measurement information associated with a CD SSB of the set of CD SSBs; and transmitting a beam failure recovery signal to the network based on the additional measurement information associated with CD-SSB.

Aspect 7 is the method of aspect 6, further comprising: receiving, from the network node and subsequent to a beam failure recovery, the CD SSB as a serving SSB and as part of the set of NCD SSBs based on an associated signal quality meeting the signal quality threshold.

Aspect 8 is the method of aspect 7, wherein a first time taken for the beam failure recovery is associated with a second time taken for the switch to the initial BWP.

Aspect 9 is the method of any of aspects 1 to 8, further comprising: receiving, from the network node, an NCD SSB configuration indicative of at least one of (i) a first indication of a periodicity associated with first NCD SSBs in the set of NCD SSBs or (ii) a second indication of a set of periodicities associated with second NCD SSBs in an additional set of NCD SSBs.

Aspect 10 is the method of aspect 9, wherein the NCD SSB configuration includes at least one burst position information element (IE) indicative of the first NCD SSBs in the set of NCD SSBs.

Aspect 11 is the method of aspect 10, wherein the at least one burst position IE includes a burst position IE for each of the first NCD SSBs in the set of NCD SSBs and each of the second NCD SSBs in the set of NCD SSBs; wherein receiving the NCD SSB configuration includes at least one of: receiving the NCD SSB configuration via radio resource control (RRC) signaling; or receiving, from the network node, an adjustment associated with the NCD SSB configuration, wherein the adjustment comprises at least one of a medium access control (MAC) control element (MAC-CE) or downlink control information (DCI) including a set of bits indicative of at least one of (i) an additional NCD SSB for addition to the set of NCD SSBs or (ii) a current NCD SSB for removal from the set of NCD SSBs.

Aspect 12 is the method of aspect 11, wherein receiving the adjustment associated with the NCD SSB configuration includes: transmitting, to the network node, an indication of SSBs in at least one of the set of NCD SSBs or the set of CD SSBs that meets a signal quality threshold, wherein the adjustment is based on the indication.

Aspect 13 is the method of aspect 9, wherein the NCD SSB configuration includes a third indication of a layer 1 (L1) measurement gap associated with SSB measurements of the set of NCD SSBs; wherein receiving the NCD SSB configuration includes: receiving, from the network node and in accordance with the set of NCD SSBs having fewer SSBs than the set of CD SSBs, a dynamic activation for the L1 measurement gap, wherein the dynamic activation for the L1 measurement gap comprises at least one of a medium access control (MAC) control element (MAC-CE) or downlink control information (DCI) including a fourth indication of a gap periodicity associated with an obtainment of additional measurement information associated with the additional set of NCD SSBs, wherein the gap periodicity is longer than the periodicity of the set of NCD SSBs; wherein obtaining the measurement information associated with the set of NCD SSBs includes: obtaining the additional measurement information associated with the additional set of NCD SSBs during the L1 measurement gap in accordance with the gap periodicity.

Aspect 14 is the method of aspect 13, wherein receiving the NCD SSB configuration includes: receiving, from the network node and subsequent to the dynamic activation for the L1 measurement gap, a deactivation for the L1 measurement gap in accordance with the set of NCD SSBs having a same number of SSBs as the set of CD SSBs, wherein the deactivation for the L1 measurement gap comprises at least one of the MAC-CE or the DCI.

Aspect 15 is the method of any of aspects 1 to 14, further comprising: transmitting, for at least one network node, the measurement information associated with the set of NCD SSBs; or wherein a transmission of the set of CD SSBs is outside the active BWP of the UE for a reception at the UE; or wherein the UE is a reduced capability UE or an enhanced reduced capability UE.

Aspect 16 is a method of wireless communication at a network node, comprising: configuring a user equipment (UE) with a non-cell-defining (NCD) synchronization signal block (SSB) configuration indicative of at least one of (i) a first indication of a periodicity associated with first NCD SSBs in a set of NCD SSBs or (ii) a second indication of a set of periodicities associated with second NCD SSBs in an additional set of NCD SSBs; and transmitting, for the UE and in accordance with the NCD SSB configuration, the set of NCD SSBs, wherein the set of NCD SSBs is a subset of a set of cell-defining (CD) SSBs that is outside an active bandwidth part (BWP) of the UE.

Aspect 17 is the method of aspect 16, wherein transmitting the set of NCD SSBs includes: transmitting, for the UE, the additional set of NCD SSBs in accordance with an additional periodicity that is longer than the periodicity of the set of NCD SSBs, wherein the additional set of NCD SSBs is exclusive of the set of NCD SSBs.

Aspect 18 is the method of aspect 17, wherein a number of first NCD SSBs in the set of NCD SSBs is less than an additional number of second NCD SSBs in the additional set of NCD SSBs; or wherein the number of first NCD SSBs in the set of NCD SSBs and the additional number of second NCD SSBs in the additional set of NCD SSBs equals a total number of CD SSBs in the set CD SSBs.

Aspect 19 is the method of aspect 17, wherein the NCD SSB configuration is associated with measurement information for the set of NCD SSBs; wherein the method further comprises: receiving, from the UE, the measurement information for the set of NCD SSBs in accordance with the NCD SSB configuration, wherein the measurement information for the set of NCD SSBs is indicative of (i) first measurement information for a determination that each NCD SSB of the set of NCD SSBs is associated with a signal quality that fails to meet a signal quality threshold and (ii) additional measurement information associated with an NCD SSB of the additional set of NCD SSBs; and transmitting, for the UE and subsequent to a beam failure recovery associated with the UE, the NCD SSB of the additional set of NCD SSBs as a serving SSB.

Aspect 20 is the method of any of aspects 16 to 19, further comprising: receiving, from the UE, measurement information for the set of NCD SSBs in accordance with the NCD SSB configuration, wherein the measurement information for the set of NCD SSBs is indicative of (i) a switch to an initial BWP of the UE based on a determination associated with the measurement information that at least one NCD SSB in the set of NCD SSBs is associated with a respective signal quality that fails to meet a signal quality threshold and (ii) additional measurement information associated with a CD SSB of the set of CD SSBs; and transmitting, for the UE and subsequent to a beam failure recovery associated with the UE, the CD SSB as a serving SSB and as part of the set of NCD SSBs based on an associated signal quality meeting the signal quality threshold.

Aspect 21 is the method of any of aspects 16 to 19, further comprising: receiving, from the UE, measurement information for a first NCD SSB of the set of NCD SSBs, wherein the measurement information is indicative of a determination that the first NCD SSB of the set of NCD SSBs, as a serving SSB of the UE, is associated with a signal quality that fails to meet a signal quality threshold and that a second NCD SSB of the additional set of NCD SSBs meets the signal quality threshold; and transmitting, for the UE and subsequent to a beam failure recovery, the second NCD SSB as the serving SSB, wherein the set of NCD SSBs includes the second NCD SSB.

Aspect 22 is the method of any of aspects 16 to 21, wherein the NCD SSB configuration includes at least one burst position information element (IE) indicative of the first NCD SSBs in the set of NCD SSBs.

Aspect 23 is the method of aspect 22, wherein the at least one burst position IE includes a burst position IE for each of the first NCD SSBs in the set of NCD SSBs and each of the second NCD SSBs in the set of NCD SSBs; wherein transmitting the NCD SSB configuration includes transmitting the NCD SSB configuration via radio resource control (RRC) signaling.

Aspect 24 is the method of aspect 23, wherein transmitting the NCD SSB configuration includes: transmitting, for the UE, an adjustment associated with the NCD SSB configuration, wherein the adjustment comprises at least one of a medium access control (MAC) control element (MAC-CE) or downlink control information (DCI) including a set of bits indicative of a at least one of (i) an additional NCD SSB for addition to the set of NCD SSBs or (ii) a current NCD SSB for removal from the set of NCD SSBs.

Aspect 25 is the method of aspect 24, wherein transmitting the adjustment associated with the NCD SSB configuration includes: receiving, from the UE, an indication of SSBs in at least one of the set of NCD SSBs or the set of CD SSBs that meets a signal quality threshold, wherein the adjustment is based on the indication.

Aspect 26 is the method of any of aspects 16 to 25, wherein the NCD SSB configuration includes a third indication of a layer 1 (L1) measurement gap associated with SSB measurements of the set of NCD SSBs; wherein transmitting the NCD SSB configuration includes: transmitting, for the UE and in accordance with the set of NCD SSBs having fewer SSBs than the set of CD SSBs, a dynamic activation for the L1 measurement gap, wherein the dynamic activation for the L1 measurement gap comprises at least one of a medium access control (MAC) control element (MAC-CE) or downlink control information (DCI) including a fourth indication of a gap periodicity associated with obtainment of additional measurement information associated with the additional set of NCD SSBs, wherein the gap periodicity is longer than the periodicity of the set of NCD SSBs; and receiving the additional measurement information associated with the additional set of NCD SSBs during the L1 measurement gap in accordance with the gap periodicity.

Aspect 27 is the method of aspect 26, wherein receiving the NCD SSB configuration includes: transmitting, for the UE and subsequent to the dynamic activation for the L1 measurement gap, a deactivation for the L1 measurement gap in accordance with the set of NCD SSBs having a same number of SSBs as the set of CD SSBs, wherein the deactivation for the L1 measurement gap comprises at least one of the MAC-CE or the DCI.

Aspect 28 is the method of any of aspects 16 to 27, further comprising: receiving, from the UE, measurement information associated with the set of NCD SSBs; or wherein transmitting the set of NCD SSBs includes transmitting the set of CD SSBs outside the active BWP of the UE.

Aspect 29 is an apparatus for wireless communication at a user equipment (UE), comprising: at least one memory; and at least one processor coupled to the at least one memory, the at least one processor, individually or in any combination, is configured to perform the method of any of aspects 1 to 15.

Aspect 30 is an apparatus for wireless communication at a user equipment (UE), comprising means for performing each step in the method of any of aspects 1 to 15.

Aspect 31 is the apparatus of any of aspects 29 to 30, further comprising a transceiver configured to receive or to transmit in association with the method of any of aspects 1 to 15.

Aspect 32 is a computer-readable medium (e.g., a non-transitory computer-readable medium) storing computer executable code at a user equipment (UE), the code when executed by at least one processor causes the at least one processor to perform the method of any of aspects 1 to 15.

Aspect 33 is an apparatus for wireless communication at a network node, comprising: at least one memory; and at least one processor coupled to the at least one memory, the at least one processor, individually or in any combination, is configured to perform the method of any of aspects 16 to 28.

Aspect 34 is an apparatus for wireless communication at a network node, comprising means for performing each step in the method of any of aspects 16 to 28.

Aspect 35 is the apparatus of any of aspects 33 to 34, further comprising a transceiver configured to receive or to transmit in association with the method of any of aspects 16 to 28.

Aspect 36 is a computer-readable medium (e.g., a non-transitory computer-readable medium) storing computer executable code at a network node, the code when executed by at least one processor causes the at least one processor to perform the method of any of aspects 16 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
receive, from a network node, a set of non-cell-defining (NCD) synchronization signal blocks (SSBs), wherein the set of NCD SSBs is a subset of a set of cell-defining (CD) SSBs outside an active bandwidth part (BWP) of the UE; and
obtain measurement information associated with the set of NCD SSBs.

2. The apparatus of claim 1, wherein to receive the set of NCD SSBs, the at least one processor, individually or in any combination, is configured to:
receive, from the network node, an additional set of NCD SSBs in accordance with an additional periodicity that is longer than a periodicity of the set of NCD SSBs, wherein the additional set of NCD SSBs is exclusive of the set of NCD SSBs.

3. The apparatus of claim 2, wherein a number of first NCD SSBs in the set of NCD SSBs is less than an additional number of second NCD SSBs in the additional set of NCD SSBs; or
wherein the number of first NCD SSBs in the set of NCD SSBs and the additional number of second NCD SSBs in the additional set of NCD SSBs equals a total number of CD SSBs in the set CD SSBs.

4. The apparatus of claim 2, wherein the at least one processor, individually or in any combination, is further configured to:
determine, based on the measurement information, that each NCD SSB of the set of NCD SSBs is associated with a signal quality that fails to meet a signal quality threshold;
obtain additional measurement information associated with an NCD SSB of the additional set of NCD SSBs; and
receive, from the network node and subsequent to (i) a determination that the NCD SSB of the additional set of NCD SSBs meets the signal quality threshold and (ii) a beam failure recovery, the NCD SSB of the additional set of NCD SSBs as a serving SSB.

5. The apparatus of claim 2, wherein the at least one processor, individually or in any combination, is further configured to:
determine, based on the measurement information, that a first NCD SSB of the set of NCD SSBs, as a serving SSB of the UE, is associated with a signal quality that fails to meet a signal quality threshold and that a second NCD SSB of the additional set of NCD SSBs meets the signal quality threshold; and
receive, from the network node and subsequent to a beam failure recovery, the second NCD SSB as the serving SSB and an updated set of NCD SSBs that includes the second NCD SSB.

6. The apparatus of claim 1, wherein the at least one processor, individually or in any combination, is further configured to:
switch to an initial BWP of the UE based on a determination associated with the measurement information that at least one NCD SSB in the set of NCD SSBs is associated with a respective signal quality that fails to meet a signal quality threshold;
obtain additional measurement information associated with a CD SSB of the set of CD SSBs; and
transmit a beam failure recovery signal to the network based on the additional measurement information associated with the CD SSB.

7. The apparatus of claim 6, wherein the at least one processor, individually or in any combination, is further configured to:
receive, from the network node and subsequent to a beam failure recovery, the CD SSB as a serving SSB and as part of the set of NCD SSBs based on an associated signal quality meeting the signal quality threshold.

8. The apparatus of claim 7, wherein a first time taken for the beam failure recovery is associated with a second time taken for the switch to the initial BWP.

9. The apparatus of claim 1, wherein the at least one processor, individually or in any combination, is further configured to:
receive, from the network node, an NCD SSB configuration indicative of at least one of (i) a first indication of a periodicity associated with first NCD SSBs in the set of NCD SSBs or (ii) a second indication of a set of periodicities associated with second NCD SSBs in an additional set of NCD SSBs.

10. The apparatus of claim 9, wherein the NCD SSB configuration includes at least one burst position information element (IE) indicative of the first NCD SSBs in the set of NCD SSBs.

11. The apparatus of claim 10, wherein the at least one burst position IE includes a burst position IE for each of the first NCD SSBs in the set of NCD SSBs and each of the second NCD SSBs in the set of NCD SSBs;
wherein to receive the NCD SSB configuration, the at least one processor, individually or in any combination, is configured to receive at least one of:
the NCD SSB configuration via radio resource control (RRC) signaling; or
an adjustment, from the network node, associated with the NCD SSB configuration, wherein the adjustment comprises at least one of a medium access control (MAC) control element (MAC-CE) or downlink control information (DCI) including a set of bits indicative of at least one of (i) an additional NCD SSB for addition to the set of NCD SSBs or (ii) a current NCD SSB for removal from the set of NCD SSBs.

12. The apparatus of claim 11, wherein to receive the adjustment associated with the NCD SSB configuration, the at least one processor, individually or in any combination, is configured to:
transmit, to the network node, an indication of SSBs in at least one of the set of NCD SSBs or the set of CD SSBs that meets a signal quality threshold, wherein the adjustment is based on the indication.

13. The apparatus of claim 7, wherein the NCD SSB configuration includes a third indication of a layer 1 (L1) measurement gap associated with SSB measurements of the set of NCD SSBs;
wherein to receive the NCD SSB configuration, the at least one processor, individually or in any combination, is configured to:
receive, from the network node and in accordance with the set of NCD SSBs having fewer SSBs than the set of CD SSBs, a dynamic activation for the L1 measurement gap, wherein the dynamic activation for the L1 measurement gap comprises at least one of a medium access control (MAC) control element (MAC-CE) or downlink control information (DCI) including a fourth indication of a gap periodicity associated with an obtainment of additional measurement information associated with the set of CD SSBs, wherein the gap periodicity is longer than the periodicity of the set of NCD SSBs;
wherein to obtain the measurement information associated with the set of NCD SSBs, the at least one processor, individually or in any combination, is configured to:
obtain the additional measurement information associated with the set of CD SSBs during the L1 measurement gap in accordance with the gap periodicity.

14. The apparatus of claim 13, wherein to receive the NCD SSB configuration, the at least one processor, individually or in any combination, is configured to:
receive, from the network node and subsequent to the dynamic activation for the L1 measurement gap, a dynamic deactivation for the L1 measurement gap in accordance with the set of NCD SSBs having a same number of SSBs as the set of CD SSBs, wherein the dynamic deactivation for the L1 measurement gap comprises at least one of the MAC-CE or the DCI.

15. The apparatus of claim 1, further comprising at least one transceiver coupled to the at least one processor, wherein the at least one processor, individually or in any combination, is configured to:
transmit, for at least one network node, the measurement information associated with the set of NCD SSBs; or
wherein a transmission of the set of CD SSBs is outside the active BWP of the UE for a reception at the UE; or
wherein the UE is a reduced capability UE or an enhanced reduced capability UE.

16. An apparatus for wireless communication at a network node, comprising:
at least one memory; and
at least one processor coupled to the at least one memory and, based at least in part on information stored in the at least one memory, the at least one processor, individually or in any combination, is configured to:
configure a user equipment (UE) with a non-cell-defining (NCD) synchronization signal block (SSB) configuration indicative of at least one of (i) a first indication of a periodicity associated with first NCD SSBs in a set of NCD SSBs or (ii) a second indication of a set of periodicities associated with second NCD SSBs in an additional set of NCD SSBs; and
transmit, for the UE and in accordance with the NCD SSB configuration, the set of NCD SSBs, wherein the set of NCD SSBs is a subset of a set of cell-defining (CD) SSBs that is outside an active bandwidth part (BWP) of the UE.

17. The apparatus of claim 16, wherein to transmit the set of NCD SSBs, the at least one processor, individually or in any combination, is configured to:
transmit, for the UE, the additional set of NCD SSBs in accordance with an additional periodicity that is longer than the periodicity of the set of NCD SSBs, wherein the additional set of NCD SSBs is exclusive of the set of NCD SSBs.

18. The apparatus of claim 17, wherein a number of first NCD SSBs in the set of NCD SSBs is less than an additional number of second NCD SSBs in the additional set of NCD SSBs; or
wherein the number of first NCD SSBs in the set of NCD SSBs and the additional number of second NCD SSBs in the additional set of NCD SSBs equals a total number of CD SSBs in the set CD SSBs.

19. The apparatus of claim 17, wherein the NCD SSB configuration is associated with measurement information for the set of NCD SSBs;
wherein the at least one processor, individually or in any combination, is further configured to:
receive, from the UE, the measurement information for the set of NCD SSBs in accordance with the NCD SSB configuration, wherein the measurement information for the set of NCD SSBs is indicative of (i) first measurement information for a determination that each NCD SSB of the set of NCD SSBs is associated with a signal quality that fails to meet a signal quality threshold and (ii) additional measurement information associated with an NCD SSB of the additional set of NCD SSBs; and
transmit, for the UE and subsequent to a beam failure recovery associated with the UE, the NCD SSB of the additional set of NCD SSBs as a serving SSB.

20. The apparatus of claim 16, wherein the at least one processor, individually or in any combination, is further configured to:
receive, from the UE, measurement information for the set of NCD SSBs in accordance with the NCD SSB configuration, wherein the measurement information for the set of NCD SSBs is indicative of (i) a switch to an initial BWP of the UE based on a determination associated with the measurement information that at least one NCD SSB in the set of NCD SSBs is associated with a respective signal quality that fails to meet a signal quality threshold and (ii) additional measurement information associated with a CD SSB of the set of CD SSBs; and
transmit, for the UE and subsequent to a beam failure recovery associated with the UE, the CD SSB as a serving SSB and as part of the set of NCD SSBs based on an associated signal quality meeting the signal quality threshold.

21. The apparatus of claim 16, wherein the at least one processor, individually or in any combination, is further configured to:
receive, from the UE, measurement information for a first NCD SSB of the set of NCD SSBs, wherein the measurement information is indicative of a determination that the first NCD SSB of the set of NCD SSBs, as a serving SSB of the UE, is associated with a signal quality that fails to meet a signal quality threshold and that a second NCD SSB of the additional set of NCD SSBs meets the signal quality threshold; and
transmit, for the UE and subsequent to a beam failure recovery, the second NCD SSB as the serving SSB, wherein the set of NCD SSBs includes the second NCD SSB.

22. The apparatus of claim 16, wherein the NCD SSB configuration includes at least one burst position information element (IE) indicative of the first NCD SSBs in the set of NCD SSBs.

23. The apparatus of claim 22, wherein the at least one burst position IE includes a burst position IE for each of the first NCD SSBs in the set of NCD SSBs and each of the second NCD SSBs in the set of NCD SSBs;
wherein to transmit the NCD SSB configuration, the at least one processor, individually or in any combination, is configured to transmit the NCD SSB configuration via radio resource control (RRC) signaling.

24. The apparatus of claim 23, wherein to transmit the NCD SSB configuration, the at least one processor, individually or in any combination, is configured to:
transmitting, for the UE, an adjustment associated with the NCD SSB configuration, wherein the adjustment comprises at least one of a medium access control (MAC) control element (MAC-CE) or downlink control information (DCI) including a set of bits indicative of a at least one of (i) an additional NCD SSB for addition to the set of NCD SSBs or (ii) a current NCD SSB for removal from the set of NCD SSBs.

25. The apparatus of claim 24, wherein to transmit the adjustment associated with the NCD SSB configuration, the at least one processor, individually or in any combination, is configured to:
receive, from the UE, an indication of SSBs in at least one of the set of NCD SSBs or the set of CD SSBs that meets a signal quality threshold, wherein the adjustment is based on the indication.

26. The apparatus of claim 16, wherein the NCD SSB configuration includes a third indication of a layer 1 (L1) measurement gap associated with SSB measurements of the set of NCD SSBs;
wherein to transmit the NCD SSB configuration, the at least one processor, individually or in any combination, is configured to:
transmit, for the UE and in accordance with the set of NCD SSBs having fewer SSBs than the set of CD SSBs, a dynamic activation for the L1 measurement gap, wherein the dynamic activation for the L1 measurement gap comprises at least one of a medium access control (MAC) control element (MAC-CE) or downlink control information (DCI) including a fourth indication of a gap periodicity associated with obtainment of additional measurement information associated with the set of CD SSBs, wherein the gap periodicity is longer than the periodicity of the set of NCD SSBs; and
receive the additional measurement information associated with the set of CD SSBs during the L1 measurement gap in accordance with the gap periodicity.

27. The apparatus of claim 26, wherein to transmit the NCD SSB configuration, the at least one processor, individually or in any combination, is configured to:
transmit, for the UE and subsequent to the dynamic activation for the L1 measurement gap, a dynamic deactivation for the L1 measurement gap in accordance with the set of NCD SSBs having a same number of SSBs as the set of CD SSBs, wherein the dynamic deactivation for the L1 measurement gap comprises at least one of the MAC-CE or the DCI.

28. The apparatus of claim 16, further comprising at least one transceiver coupled to the at least one processor, wherein the at least one processor, individually or in any combination, is configured to:
receive, from the UE and via the at least one transceiver, measurement information associated with the set of NCD SSBs; or
wherein to transmit the set of NCD SSBs, the at least one processor is configured to:
transmit, via the at least one transceiver, the set of CD SSBs outside the active BWP of the UE.

29. A method of wireless communication at a user equipment (UE), comprising:
receiving, from a network node, a set of non-cell-defining (NCD) synchronization signal blocks (SSBs), wherein the set of NCD SSBs is a subset of a set of cell-defining (CD) SSBs outside an active bandwidth part (BWP) of the UE; and
obtaining measurement information associated with the set of NCD SSBs.

30. A method of wireless communication at a network node, comprising:
configuring a user equipment (UE) with a non-cell-defining (NCD) synchronization signal block (SSB) configuration indicative of at least one of (i) a first indication of a periodicity associated with first NCD SSBs in a set of NCD SSBs or (ii) a second indication of a set of periodicities associated with second NCD SSBs in an additional set of NCD SSBs; and
transmitting, for the UE and in accordance with the NCD SSB configuration, the set of NCD SSBs, wherein the set of NCD SSBs is a subset of a set of cell-defining (CD) SSBs that is outside an active bandwidth part (BWP) of the UE.
